(19) United States
(12) Patent Application Publication
(10) Pub. No.: US 2005/0033669 A1
(43) Pub. Date: Feb. 10, 2005

(54) Philanthropy management system and methods of use and doing business

(76) Inventors: Troy D. Stremler, Colorado Springs, CO (US); Daniel V. Barnett, Englewood, CO (US); Jonathan M. Henshaw, Denver, CO (US); Donald W. Faul, Castle Rock, CO (US); Roger Swaving, Colorado Springs, CO (US); Richard Martin, Castle Rock, CO (US)

Correspondence Address: Robert C. Ryan;Nath & Associates, PLLC, 6th Floor, 1030 15th Street NW, Washington, DC, 20005, US

(21) Appl. No.: 10/873,995

(22) Filed: Jun. 21, 2004

Related U.S. Application Data
(60) Provisional application No. 60/480,190, filed on Jun. 20, 2003.

(51) Int. Cl. G06F 17/60

(52) U.S. Cl. 705/30

(57) ABSTRACT

An automated system and method for philanthropists to gain access to projects and organizations of interest and, if desired, for projects and organizations to gain access to philanthropists or philanthropic or other funding. The system is remotely accessible so that donor, organization and project managers or team members, and others can gain access to the system from disparate locations, such as through an intranet or the Internet. The system provides tools for organizations to manage information about themselves and projects with which they are connected or in which they are interested. It also provides tools for donor users to manage information about themselves and entities in which they have donated or that they are monitoring, and tools to find an associate themselves with those and other entities. The system provides security features and provides a topology that limits outside access to underlying system data and data facilities. The system is also structured to allow limited access to the public in general in order to promote the system and its use. The system facilitates methods of use that can provide methods of revenue generation for access to or use of the system or methods of use of the system.

### CROSS REFERENCE TO RELATED APPLICATIONS

This application claims priority through, and hereby expressly incorporates by reference, the common applicant's prior U.S. patent application Ser. No. 10/290,556, filed Nov. 8, 2002, entitled PHILANTHROPY MANAGEMENT SYSTEM AND METHODS OF USE AND DOING BUSINESS, which claims priority through and expressly incorporates by reference the common applicant's prior U.S. provisional patent application Ser. No. 60/345,361, filed Nov. 8, 2001, entitled PHILANTHROPY DONATION MANAGEMENT APPARATUS, SYSTEM, AND METHODS OF USE AND DOING BUSINESS. This application also claims priority through, and hereby expressly incorporates by reference, the applicants' prior U.S. provisional patent application Ser. No. 60/480,190, filed Jun. 20, 2003, entitled PHILANTHROPY MANAGEMENT SYSTEM AND METHODS OF USE AND DOING BUSINESS.

### FIELD OF THE INVENTION

The present invention relates to apparatus, systems, and methods for providing access to and managing philanthropic donations, resources, and projects.

### BACKGROUND

Philanthropy has been essential to advancement of society and betterment of the human condition for hundreds of years. Many of the very finest educational, health care, and religious institutions and activities have, long been the direct result of philanthropic donations and activities. The resulting institutions, services, and products not only often fulfill substantial voids that have not been, and often cannot be met, by government, but also expand the range of options and competitive alternatives to institutions, services, and products provided by the government and non private activities and entities. The net result is not only a more efficient allocation of resources in the market and society as a whole, but also substantial increases in the quality of societal morals, education, human interaction, spiritual accomplishment, and life all across society.

As the industrial and other economies have evolved over the past one hundred years and more, individuals and institutions in them have developed enormous amounts of capital that they often seek to allocate and donate toward philanthropic donations and other activities. The effort involved, however, in actually making and managing donations on behalf of philanthropists or philanthropic institutions owning or controlling the capital is often a sizable, costly, and time consuming challenge.

Typically, those individuals or entities with particularly large funds or other resources for philanthropic activities set up their own foundations to identify charitable projects and manage their philanthropic donations. Each foundation then typically conducts investigations into the large number of potential recipients, such as charities, educational institutions, and religious entities, to determine those who will receive donations from the foundation. The foundation often also conducts its own oversight and management depending on the nature of the donation and the level of interest of the donors in ensuring proper use of the donated funds. Typically, each philanthropic foundation must itself conduct these types of activities, and set up attendant customized management and accounting systems and functions, at substantial expense to the philanthropic foundations and those who fund them. This substantial effort and expense can delay and consume resources that would otherwise be available for actual philanthropic or other uses. It also reduces the ability of potential donors to learn of all the potential philanthropic projects in which the donors might be interested in funding.

For those individuals or entities seeking to engage in philanthropic activities without use of a foundation, the challenges are often even greater. In the applicants' view, this problem greatly reduces both the quantity and the quality of philanthropic activities.

Nevertheless, the amount of funds available for philanthropic use has been growing rapidly over the past few decades in particular. The applicants have recognized these problems and their likely adverse consequences for those who would engage in philanthropic activities as well as for those who would benefit from them.

### BRIEF SUMMARY OF ASPECTS OF THE INVENTION

The applicants have invented apparatus, systems, and methods for managing and/or assessing philanthropic activities having a variety of different aspects. In one aspect, the invention preferably provides a system and method for managing or reporting the status and needs of one or more charitable or philanthropic projects and, most preferably, portfolios of such projects.

The system preferably provides access to information about potential projects and organizations seeking charitable funding. Most preferably, the system also provides searching capability for searching potential projects and organizations and reporting those that meet the search criteria.

In another aspect, the system provides an online marketplace for expanding philanthropic activity and transactions. In one such embodiment, the system may provide either charitable organization or project information for potential donors and access to potential donors by such organizations or projects. The system preferably provides management tools for the organizations and donors that use the system, increasing the usefulness of the systems while increasing potential donors' access to organization and project information and organization and project access to potential donors.

In another aspect, the invention may preferably provide a system for assessing or qualifying philanthropic projects and organizations according to one or more criteria. Most preferably, the qualified projects and organizations are then searchable or otherwise accessible to users through other management and/or reporting functions in the system. The qualified projects and organizations are preferably also accessible through the managing and reporting system.

Most preferably, the system provides philanthropic fund qualification, transfer, deposit, and/or reporting functionality.

In another aspect, the invention may preferably provide a system that makes philanthropic project management, reporting, and/or assessment activities more efficient, thorough, economical, and/or widely available to users.

Most preferably, the system is readily and widely available to philanthropic donors, managers, and consultants by remote access, including through the Internet or private or virtual private networks or combinations thereof.

In a particularly preferred embodiment, one or more aspects of the invented system or method can provide revenue generation for an entity for providing access to or use of the one or more aspects. In this fashion, a business (or method) may most preferably help fund the development, deployment, and/or use of or access to the one or more aspects.

Most preferably, such a business (and method) can not only possibly expand philanthropic activities but also provide additional incentives and opportunities to further improve and expand philanthropic activities and projects in the future.

In other aspects, the system may provide yet additional features such as:
customized or private labeled versions of sites or portions of sites, in which the organization my control the visual appearance a limit project access to users on the site or site portion;
allowing the organization user the ability to keep project information private until the user releases the project information to generalized access on the system;
dynamic resizing of graphics, such as project images, for desired display and integration with other elements;
multiple databases while rendering them secure and generally not directly accessible by users on the system;
organizational hierarchy with relative ease of use, flexibility, and upgradeability;
unit generalization supporting flexible use of the unit to represent organizations, projects, groups, or other entities or activities;
unit-based security, providing ease of use, maintenance, and revision, and consistency of application throughout the system;
automatic prompting of users to update project information;
robust organization and project management and reporting tools;
marketing tools, such as by (i) providing system, organization, or project marketing information screens to those who may seek access to the system or portions of the system without adequate security clearance, or (ii) allowing a user to send organization or project information to others, including others outside the system;
donor goal setting and reporting;
transaction processing that separates the donor's funding election from the organization's receipt of funding, which allows for donor anonymity as well as other intervening activities that may be desired for operational or legal reasons;
reporting of projects in a category hierarchy, rendering searching for desired projects easier and quicker;
flexible metric generation and reporting, with the ability to roll-up and compute totals from sub-metrics;
tracking of user policy acceptance, along with automatic prompting of user to agree to any new policy.
providing accessibility features such as large fonts, low bandwidth transmission, and special color schemes;
enhanced user login security features, including encrypted passwords and lock-out for unsuccessful login;
multiple user profiles or personalities so that the user may control how they appear when using the system; and
unit reporting for any unit in the system.

It should be noted that many features of the present disclosure can have applicability in systems or methods outside of philanthropic activities.

It can thus be seen that there are many aspects of the present invention, including many other additional or alternative features that will become apparent as this specification proceeds. It is therefore understood that the scope of the invention is to be determined by the claims as issued and not by whether the claimed subject matter solves any particular problem or all of them, provides any particular features or all of them, or meets any particular objective or group of objectives set forth in the Background or Brief Summary above.

### BRIEF DESCRIPTION OF THE DRAWINGS

The preferred embodiments of the present system and methods are shown and described in connection with the attached drawings in which:

FIG. 1 is the main page for accessing the preferred system over networks, such as intranets or the Internet;

FIG. 2 is a schematic showing how the present system performs data binding;

FIG. 3 is a schematic showing how the present system performs data storage and access;

FIG. 4 is a schematic showing how the present system performs user credentialing and implements a credential use and credential checking process;

FIG. 5 is a schematic of the system's physical architecture for providing remote access to the system and system information via a network such as the Internet;

FIG. 6 is a schematic showing remote donor accessing of the system and donor information via a networks such as the Internet;

FIG. 7 is a schematic showing remote user accessing of the system to procure a system report via a networks such as the Internet;

FIG. 8 is a schematic showing remote user accessing of the system to procure multimedia content via a network such as the Internet;

FIG. 9 is a depiction of utilization of the system's hierarchical unit architecture to build a hierarchical representation of an organization, such as a business unit, in the system;

FIG. 10 is a schematic showing how the system provides permissioning of users based on roles defined for the user;

FIG. 11 is schematic showing the system's user security system and how it works with the permissioning system of FIG. 10;

FIG. 12 is a schematic showing permission inheritance in the hierarchical unit architecture of the preferred system;

FIG. 13 is a Carina system page showing how a user may modify accessibility options;

FIG. 14 is a Carina system page showing how an organization user may observe organization financial statistics;

FIG. 15 is a Carina system populated with system policies and a user feedback link;

FIG. 16 is a Carina system portion showing the most recent user journal entry and a link to add a new entry;

FIG. 17 is a Carina system page showing the most recently updated media for a project and a link to the media;

FIG. 18 is a Carina system page showing a user's recent projects and providing information about them;

FIG. 19 is a Carina system page showing the status of project information entry and a link to change the status;

FIG. 20 is Carina system page providing a link to make a project publicly accessible to users generally on the system;

FIG. 21 is a Carina system page providing user log-in information and a sign out link;

FIG. 22 is a Carina system page showing providing information about the current organization;

FIG. 23 is a Carina system page providing information about an organizations process update status;

FIG. 24 is a Carina system page showing information about a group within an organization;

FIG. 25 is a Carina system page for creation of a new group;

FIG. 26 is a Carina system page for editing group information;

FIG. 27 is Carina system page showing information about an organization;

FIG. 28 is a Carina system page for entering information for an organization;

FIG. 29 is a Carina system page for editing organization information;

FIG. 30 is a Carina system page listing organization users and allowing resetting of their passwords;

FIG. 31 is a Carina system page for managing roles of users in an organization;

FIG. 32 is a Carina system page listing access levels for a user in an organization or unit;

FIG. 33 is a Carina system page providing access to information areas for an organization;

FIG. 34 is a Carina system page providing access to contact information for the organization;

FIG. 35 is a Carina system page providing a listing of information about an organization's user's (team members);

FIG. 36 is a Carina system page providing information about a particular user within the organization;

FIG. 37 is a Carina system page providing summary information about an organization;

FIG. 38 is a Carina system page for creating a project;

FIG. 39 is a Carina system page for entering description information about a project;

FIG. 40 is a Carina system page for entering identification information about a project;

FIG. 41 is a Carina system page for entering financial information for a project;

FIG. 42 is a Carina system page displaying summary project information and providing links to other sources of project information;

FIG. 43 is a Carina system page for entering matching grant information for a project;

FIG. 44 is a Carina system page for toggling the private or public visibility of the project;

FIG. 45 is a Carina system page for entering project timeline information;

FIG. 46 is a Carina system page for editing project timeline tasks;

FIG. 47 is a Carina system page for entering project categorization;

FIG. 48 is a Carina system page listing journal entries for a project;

FIG. 49 is a Carina system page for editing or adding journal entries;

FIG. 50 is a Carina system page for viewing a journal entry;

FIG. 51 is a Carina system page for listing and adding project media;

FIG. 52 is a Carina system page for editing and making a project document public;

FIG. 53 is a Carina system page for editing and making a project image public;

FIG. 54 is a Carina system page for uploading and making project media public;

FIG. 55 is a Carina system page for reviewing and printing organization contacts;

FIG. 56 is a Carina system page displaying project information;

FIG. 57 is a Carina system page reporting financial information;

FIG. 58 is a Carina system page showing one reporting format for unit metric information;

FIG. 59 is a Carina system page showing a second reporting format for unit metric information;

FIG. 60 is a Carina system page showing roll-up financial information for projects under the current unit;

FIG. 61 is a Carina system page showing a timeline report for current unit projects;

FIG. 62 is a Carina system page for setting update policies for current organization projects;

FIG. 63 is a Carina system page for reviewing addresses for a unit;

FIG. 64 is a Carina system page for adding an address for a unit;

FIG. 65 is a Carina system page for editing an address for a unit;

FIG. 66 is a Carina system page for managing metrics for the current unit;

FIG. 67 is a Carina system page for updating a metric for the current unit;

FIG. 68 is a Carina system page for creating a metric for the current unit;

FIG. 69 is a Carina system page for editing a current metric;

FIG. 70 is a Carina system page for editing a milestone goal for a metric;

FIG. 71 is a Carina system page for entering goals for sub-units of the current unit;

FIG. 72 is a Carina system page for entering information for a milestone for the current metric;

FIG. 73 is a Carina system page that lists periods for the current metric;

FIG. 74 is a Carina system page that allows editing of periods for the current metric;

FIG. 75 is a Carina system page providing a list of current team members (users) for the current unit;

FIG. 76 is a Carina system page for entry of the role for a user in the current unit;

FIG. 77 is a Carina system page for reviewing and adding users in the current unit;

FIG. 78 is a Carina system page for adding a temporary user to the current unit;

FIG. 79 is a Carina system page for reviewing and editing a user's role in the current unit;

FIG. 80 is a Carina system page for accessing sub-units of the current unit;

FIG. 81 is a Carina system page for moving one node or sub-unit to another node location in the hierarchy;

FIG. 82 is a Vela system page for logging in a user;

FIG. 83 is a Vela system page showing promotional information to a user that does not have access to features the user has attempted to review;

FIG. 84 is a Vela system page allowing a user to modifying accessibility options;

FIG. 85 is a Vela system page allowing a user to edit the user's account settings;

FIG. 86 is a Vela system page providing a list funded projects, related activity, and other projects of interest;

FIG. 87 is a Vela system page providing user security and policy information and user feedback capability;

FIG. 88 is a Vela system page reporting the user's funded transactions and access to review of the user's pending transactions;

FIG. 89 is a Vela system page providing project searching;

FIG. 90 is a Vela system page inviting a user to procure a user account;

FIG. 91 is a Vela system page reporting a user's login status;

FIG. 92 is a Vela system page reporting the projects funded by the user;

FIG. 93 is a Vela system page for inviting a third party to review and fund a project;

FIG. 94 is a Vela system page providing summary information of the user's financial account information and projects funded or of interest;

FIG. 95 is a Vela system page reporting the user's project watch list and providing a link to a project funding tool and a link to remove a project from the watch list;

FIG. 96 is a Vela system page reporting transaction details for the user's funding transaction;

FIG. 97 is a Vela system page listing the user's transactions;

FIG. 98 is a Vela system page allowing the user to create a project funding asset type;

FIG. 99 is a Vela system page allowing a user to create a checking account type of funding asset;

FIG. 100 is a Vela system page allowing a user to edit asset information for the user;

FIG. 101 is a Vela system page listing and linking to the user's assets;

FIG. 102 is a Vela system page for performing a check transfer funding of a project;

FIG. 103 is a Vela system page confirming a transaction for addition to the user's fund cart;

FIG. 104 is a Vela system page reporting a successful funding transaction;

FIG. 105 is a Vela system page listing transactions for confirmation by the user;

FIG. 106 is a Vela system page asking the user to further confirm a funding transaction by re-entering log-in information;

FIG. 107 is a Vela system page for reviewing and modifying the user's fund cart;

FIG. 108 is a Vela system page that provides organization addresses to a user;

FIG. 109 is a Vela system page that provides organization identification information to a user;

FIG. 110 is a Vela system page listing an organization's projects for a user;

FIG. 111 is a Vela system page listing organizations and other information for a user;

FIG. 112 is a Vela system page reporting a project journal entry;

FIG. 113 is a Vela system page listing project journal entries;

FIG. 114 is a Vela system page allowing a user to preview and access a project document;

FIG. 115 is a Vela system page allowing a user to view a project image;

FIG. 116 is a Vela system page providing a list of project media available to the user;

FIG. 117 is a Vela system page providing report information about a project;

FIG. 118 is a Vela system page providing descriptive information about a project;

FIG. 119 is a Vela system page providing project financial information;

FIG. 120 is a Vela system page providing a summary of information about a project;

FIG. 121 is a Vela system page for a user to request addition of an organization or project to the system;

FIG. 122 is a Puppis system page for a user to establish an account in the system;

FIG. 123 is a Puppis system page for a user to log in to the system;

FIG. 124 is a Puppis system page for a user to edit the user's account information;

FIG. 125 is a Puppis system page for a user to procure a new password;

FIG. 126 is a Puppis system page for a user to re-set the user's password;

FIG. 127 is a Puppis system page for a user to set user accessibility options;

FIG. 128 is a Puppis system page for a user to establish the user's profile;

FIG. 129 is a Puppis system page for a user to edit user profile information;

FIG. 130 is a Pyxis system page showing administrative tools available to the company;

FIG. 131 is a Pyxis system page showing log in status of the current user;

FIG. 132 is a Pyxis system page showing company transaction activity information;

FIG. 133 is a Pyxis system page providing a summary company report;

FIG. 134 is a Pyxis system page listing the organizations in the system;

FIG. 135 is Pyxis system page for adding an organization to the system;

FIG. 136 is a Pyxis system page reporting organization status;

FIG. 137 is a Pyxis system page reporting users for a given organization;

FIG. 138 is a Pyxis system page reporting the status of pending system transactions;

FIG. 139 is a Pyxis system page listing transactions in the system;

FIG. 140 is a Pyxis system page for reporting and editing system income transactions;

FIG. 141 is a Pyxis system page for managing the availability of income transactions;

FIG. 142 is a Pyxis system page providing transaction processing information;

FIG. 143 is a Pyxis system page providing additional transaction processing information;

FIG. 144 is a Pyxis system page reporting transaction disbursement.

FIG. 145 is a schematic diagram of an embodiment of a donor management system that may be used to link a plurality of donors with a plurality of charitable organizations, each of which may be undertaking one or more projects.

It is to be understood that the term “page” as utilized in this Brief Description includes a “page portion” for providing the described feature.

### DETAILED DESCRIPTION OF THE PREFERRED EMBODIMENTS

The preferred embodiments are disclosed in the context of the following system specification and explanation of the methods of use and operation.

Method Overview

In certain embodiments, the present invention provides methods and systems for allowing a plurality of donors to view information regarding a plurality of charitable organizations and to make a donation to the charitable organizations. Donors may be individuals, businesses, philanthropic organizations, or wealth managers. Charitable organization, as used herein, includes, without limitation, nonprofit organizations, religious organizations, aid organizations, health organizations, environmental groups, and other philanthropic causes. Examples of charitable organizations include the United Way, the Sierra Club, Campus Crusade for Christ, the World Health Organization, and the Salvation Army.

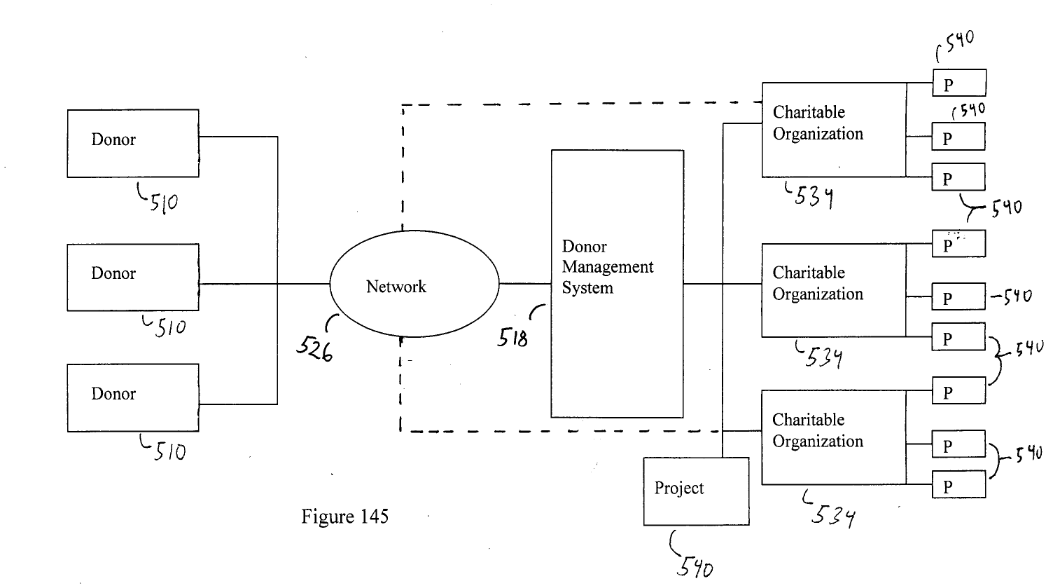

With reference to FIG. 145, embodiments of the invention allow a plurality of donors 510 and a plurality of charitable organizations 534 to interact using a donor management system 518. The donor management system 518 may have one or a plurality of components. For example, the donor managements system 518 may have a first portion (not shown) accessible to the donors 510 and a second portion (not shown) accessible to the charitable organizations 534. In this embodiment, the donor management system 518 integrates the first and second portions. In other embodiments, donor management system 518 is unitary structure, accessible to both the donors 510 and the charitable organizations 534. Of course, certain features and/or functions of the donor management system 518 may be limited to either the donor 510 or the charitable organizations 534.

The donors may be in communication with the donor management system 518, or a portion thereof, over a network 526, such as the Internet. Similarly, in at least certain embodiments, the charitable organizations 534 are able to access the donor management system 518, or a portion thereof, over a network, such as the Internet, which may be network 526. Additionally or alternatively, the charitable organizations 534 access donor management system 518 directly.

The donor management system 518 maintains information on the charitable organizations 534. Each of the charitable organizations 534 may have one or more projects or endeavors 540 that they are undertaking and wish to obtain donations to support. The charitable organizations 534 may use the donor management system 518 to input a variety of information, all or a portion of which can be displayed to the donors 510. This information may include anything related to the charitable organization 534 or its projects 540. For example, the information may include information regarding the nature of the charitable organization 534, ongoing or past activities or projects 540 of the charitable organization 534, the level of funding of the charitable organization 534 or projects 540, and financial data. In certain embodiments, the charitable organizations 534 may add or remove projects 540 from the donor management system 518 and update the information in donor management system 518, such providing progress reports on projects 540 and providing updated financial data.

The donors 510 may review all or a portion of the information on the charitable organizations 534 and projects 540. In certain embodiments, an interactive brochure, such as one or more web pages, may be created for each charitable organization 534, providing a convenient way for donors 510 to gather information about the charitable organizations 534. Similarly, in certain embodiments, donor management system 518 presents information related to the projects 540 to the donors 510 in the form of an interactive brochure.

A set of search keys may be created for each charitable organization 534 and/or project 540. The search keys may contain a number of elements related to the charitable organization 534 or project 540. For example, the search keys may include elements such as keywords, categories, budget, secularity, location, management, media coverage, number of projects, and similar factors. When a donor 510 wishes to find a particular charitable organization 534 or project 540, the donor 510 may search or sort charitable organizations 534 or projects 540 by entering search terms or sort criteria that are then compared with the search keys.

Similarly, a donor profile may be created for each donor 510. The donor profile may contain information regarding the types of charitable organizations 534 or projects 540 the donor 510 is interested in finding. For example, the donor 510 may be interested in funding a particular religious or environmental cause, such as protecting Lake Tahoe, for example. Each of the donors 510 may have a number of types of charitable organizations 534 or projects 540 they are interested in, each of these preferences may be stored in the donor's profile.

Certain embodiments allow donors 510 to find charitable organizations 534 or projects 540 of interest by searching one or more elements of the search keys. For example, a donor 510 could perform a keyword search to find matching charitable organizations 534 or charitable projects 540. Alternatively, a donor 510 could choose to sort or view all charitable organizations 534 or projects 540 within a particular category, such as all environmental charitable organizations 534 or all charitable projects 540 involving Lake Tahoe. This process may be reversed, allowing charitable organizations 534 to locate donors 510 based on donor preferences stored in the donor profiles. Of course, the selection process may be automated, with donor management system 518 automatically comparing donor profiles to search keys using various schemes to provide donors 510 with a list of charitable organizations 534 or projects 540 most likely to interest them or providing charitable organization 534 with a list of donors 510 most likely to make a donation. These searches may be updated periodically in order to call recently added or modified charitable organizations 534 or projects 540 to the attention of matching donors 510.

A donor 510 may choose to donate to a particular charitable organization 534. In certain embodiments, a donor may choose to donate to a particular project 540 of a charitable organization 534. The donation may be made directly to the charitable organization 534 or through an intermediary (not shown). The donor 510 may choose to be anonymous or make his or her identity known to the charitable organization 534. If the donor 510 desires to remain anonymous, the donation may first pass to an intermediary, who then remits the donation to the charitable organization 534.

The donor management system 518 may provide the donor 510 with a donation account. The donor 510 may place funds in the donor account until the donor 510 desires to donate to a charitable organization 534 or project 540. While the funds are in the donor account, they may be invested by the donor management system 518 for the benefit of the donor 510 or a third party, such as a charitable organization 534 or project 540 designated by the donor 510.

Certain embodiments of the invention provide the donors 510 with the ability to contact other potential donors 510 or charitable organizations 534. For example, a donor 510 may know other individuals who may be interested in making a donation to a particular charitable organization 534 or project 540. The donor management system 518 may provide the donor 510 the ability to contact such individuals and/or send them information regarding the charitable organization 534 or project 540. In this way, a group of donors 510 may act in concert (including by aggregating their funds into a single account) to fund a particular charitable organization 534, or project 540 of interest.

Similarly, one of the donors 510 may wish to make a donation to a charitable organization 534 or project 540 that is not in the donor management system 518. The donor management system 518 may provide the donor with the ability to invite the charitable organization 534 to use the donor management system 518. In other embodiments, the donor 510 can add the charitable organization 534 or project 540 to donor management system 518 and make a donation to the charitable organization 534 or project 540. The donor management system 518 may then take steps to notify the charitable organization 534 of the donation and remit the donation to the charitable organization 534.

In certain embodiments, the donor management system 518 is the service of a business. The business may charge a fee for various activities. For example, the business may charge donors 510 and/or charitable organizations 534 a fee for using the donor management system 518. The business may take a portion of each donation as a fee. The business may charge a fee for developing an interactive brochure for a charitable organization 534 or project 540, for making this interactive brochure available on the donor management system 518, or for otherwise featuring a charitable organization 534 or project 540, such as on an entry portal to the donor management system 518. The business may charge a fee for donors 510 searching for charitable organizations 534 or projects 540, or for charitable organizations 534 searching for matching donors 510.

The business may provide a number of additional services to charitable organizations 534. The business may provide, and charge a fee for, assistance in collecting and distributing funds, including tax reporting. The business may also provide assistance with management and operation of the charitable organization 534, such as assistance with budgets, human resources, supply chain management, and volunteer management. A great deal of data will be generated regarding donors 510, charitable organizations 534, projects 540, and their interactions. This data may be used and sold for various purposes, such as increasing the effectiveness of marketing efforts.

Navis.Carina (ProStar):

1. Home—Summary and dispatch page for organization, group, and project information
1.1. Project (2.3.)—Summary and dispatch page for project information
1.2. Project Media (2.3.2.)—Manage project media
1.3. Project Metrics (2.3.5.)—Manage project metrics
1.4. Project Financial (2.3.3.)—Manage project financial data
1.5. Project Journal (2.3.1.)—Manage project journal entries

2. Manage—Organization hierarchy tree with links to organization, groups, and projects
2.1. Organization—Summary and dispatch page for organization information
   2.1.1. Project (2.3.)—Summary and dispatch page for project information
   2.1.2. Metrics—Manage organization metrics
      2.1.2.1. Create—Create new metrics
      2.1.2.2. Edit—Edit metrics
      2.1.2.3. Assign—Assign metrics to groups and projects
      2.1.2.4. Update—Update metrics
   2.1.3 Addresses—Organization addresses
      2.1.3.1 Create—Create new address
      2.1.3.2. Edit—Edit addresses
   2.1.4 Organization Name and Description—Edit name and description
   2.1.5. Team—Organization users
      2.1.5.1. Create User—Create new user
      2.1.5.2. User Detail—View user details
   2.1.6 Manage Users—Manage organization users
   2.1.7. Manage Roles—Manage organization security roles
   2.1.8. New Group—Create new group
   2.1.9. Project Policy Update—Specify frequency and areas project must update
   2.1.10. Reports—Organization related reports
2.2 Group—Summary and dispatch page for group information
   2.2.1. Metrics—Mange group metrics
      2.2.1.1 Assign—Assign metrics to groups and projects
      2.2.1.2 Update—Update group metrics
   2.2.2 Group Name—Edit group name
   2.2.3. Team—Organization users
      2.2.3.1. Create User—Create new user
      2.2.3.2. User Detail—View user details
   2.2.4. Move Group—Move group below or above another unit
   2.2.5. New Project—Create new project
   2.2.6. New Sub-Group—Create new sub-group
   2.2.7. Reports—Organization related reports
2.3 Project—Summary and dispatch page for project information
   2.3.1. Journal—Mange journal entries
      2.3.1.1. Create—Create new journal entry
      2.3.1.2 Edit—Edit journal entries
      2.3.1.3. View—View journal entries
   2.3.2. Media—Mange media files
      2.3.2.1. Edit—Edit media files
      2.3.2.2. Upload—Add media files
      2.3.2.3. View—View media files
   2.3.3. Budget Details—Manage financial data
   2.3.4. Matching Grant—Specify matching grant (if any)
   2.3.5 Metrics—Manage metrics
      2.3.5.1. Update—Update metrics
   2.3.6. Timeline—Manage project timeline
   2.3.7. Timeline Tasks—Manage project timeline tasks
   2.3.8. Addresses—Organization addresses
      2.3.8.1. Create—Create new address
      2.3.8.2 Edit—Edit addresses
   2.3.9. Name and Description—Edit project name and description
   2.3.10. Problem and Solutions—Edit project problem and solutions
   2.3.11. Search Categories—Specify project search category
   2.3.12. Team—Organization contacts
      2.3.12.1. Create User—Create new user
      2.3.12.2. User Detail—View user detail
   2.3.13. Move Project—Move project below or above another unit
   2.3.13. New Sub-Project—Create new sub-project
   2.3.15. Donor Visibility—Turn on or off project visibility for donors
   2.3.16. Reports Organization related reports

3. My Account—Summary and dispatch page for user accounts
3.1. Profiles—Entry page to Vela and Carina profiles, and user settings
3.1.1. Profile—Dispatch to a Vela or Carina profile
3.1.2. Edit Address—Edit user account address
3.1.3. Edit Information—Edit user account information
3.1.4. Change Password—Change user account password
3.1.5. Edit Accessibility—Edit user accessibility preferences
   Navis.Vela (GivingPortfolio):

1. Home—Welcome page with project keyword search
1.1. Find Projects (2.) Project keyword search
1.2 Invite Friend—Invites other potential users to Vela

2. Find Projects—Project category list or keyword search results
2.1 Project—Displays project overview
   2.1.1. Organization (2.2.1.)—Specifies the organization sponsoring the project
   2.1.2. Category (2.2)—Project category
   2.1.3. Invite Friend—Invites potential users to a Vela project
   2.1.4. Journals—Project journal entries
   2.1.5. Media—Project media images and documents
   2.1.6 Project Details—Specifies a project
   2.1.7. Financial Details—Specifies financial information
   2.1.8. Print Report—Provides print-out of reports
   2.1.9. Fund Cart (3.5.)—Project funding
2.2. Organizations—List of organizations with public projects
   2.2.1. Organization—Specifies organization
   2.2.1.1. Projects—List of publicly reviewable projects for the organization
      2.2.1.1.1. Project (2.1.)—Displays project overview
      2.2.1.2. Addresses—Addresses of entities pertinent to the organization
2.3. Request—Request project be added to database

3. My Giving—Vela related account settings
3.1 Account Settings—Manage user account settings
3.1.1. Edit Address—Edit user account address
3.1.2. Edit Information—Edit user account information
3.1.3. Change Password—Change user account password
3.2. Giving Goal—Specify annual giving goal
3.3. Funded List—Projects the user has funded
3.3.1. Project (2.1.)—Displays project overview
3.3.2. Organization (2.2.1)—Specifies organization
3.3.3. Fund Cart (3.5.)—Stores projects that the user wants to fund
3.4. Watch List—Project the user is watching, but hasn't funded
3.4.1. Project (2.1.)
3.4.2. Organization (2.2.1.)
3.4.3. Fund Cart (3.5.)
3.5. Fund Cart—Stores projects that the user wants to fund
3.5.1. Fund Login—Required by user for each funding instance
   3.5.1.1. Fund Confirm—Confirms funding details
   3.5.1.1.1. Fund Complete—Confirms successful funding
3.6. Transactions—List of all donor transactions
3.6.1. Transaction Detail—View transaction details
3.7. Assets—Manage accounts that are used to fund projects
3.7.1. Create Asset—Create new asset
3.7.2. Transfer Asset—Transfer money from an existing asset
3.7.3. Edit Asset—Edit an existing asset
3.8. Profiles—Summary and dispatch page for user accounts
3.8.1. Profile—Dispatch to a Vela or Carina profile
3.8.2. Edit Address—Edit user account address
3.8.3. Edit Information—Edit user account information
3.8.4. Change Password—Change user account password
3.8.5. Edit Accessibility—Specify user accessibility preferences

4. My Projects—Marketing page for nonprofits interested in getting their projects on Vela

System Specification:

I. Naming Conventions and Nomenclature: The names in the system are organized in a way that should be familiar to programmers. Groups of related items are semantically related by their names and often by a prefix or theme that unifies the related items. These names will often provide the user with some semantic clue to the function and relation of the named item. In the case of themed items a need was seen to separate the so-called “marketing name” from the “development name”. This has become common practice in the computer industry, as the need for a common frame of discussion and the need for insulation from marketing nomenclature has become increasingly apparent. In this way, development will have a consistent way to name the items in the system, without having to worry about changing names as external forces dictate.

The System and Its Applications: The system and its applications are named after the theme of stellar constellations. A constellation called Navis (“The Ship”) has four smaller constellations: Carina (“The Keel”), Vela (“The Sail”), Pyxis (“The Compass”), and Puppis (“The Deck”). This is basis for naming the system (Navis) and the large applications in the system. The function of the application maps to the symbol of the constellation.

Databases: The theme of the ship has been carried to the other parts of the system. The databases are all named after Japanese fish names. The connecting components for these are named after fishing and boating related terms—spun so they will never conflict with the names used to actually create the system and so they are semantically useful.

For example, the word Turibune in Japanese means fishing boat. This is fairly difficult to remember and pronounce; so it was converted to Turbine and used to name a middle-tier common services component. In this way, the theme is more-or-less maintained while adding a semantically powerful association to the name.

Pages: Page names in the system are chosen based on their function. This provides several benefits. Once the user is familiar with the nomenclature, the user can discern the function of something just by its name. The names tend to provide a grouping hierarchy of functionality, which not only groups items with related functions, but also tends to create a natural tree of functionality—along the same lines as standard object-oriented component design.

For example, with regard to the Carina application discussed infra, there are distinct names and groups for the Project pages and the User pages (also discussed infra). The User pages typically have no awareness of what a Project is—they do not process Project parameters (like ProjectID infra)—nor do they conduct any data operations that involve the Project data structures. This satisfies the system architecture concept that Users exist independently of Projects. In the Project pages, each page performs some kind of operation on a Project, using Project parameters and Project data structures.

Nevertheless, there are several Project pages that involve User parameters and User data structures. The name for these pages derives from the nature of the operation and the dependencies of the operation. For these types of pages, the operation is fundamentally being performed on the Project, not on or by the User. The fact that the User is involved is incidental.

Controls, Smaller Elements: Controls have a name that is internally consistent, concise, and unique.

II. Navis Architecture:

Data System: data access in the system is accomplished with a variety of schemes designed to provide a balance between performance, platform independence, development speed, ease of use, and non-programmer (designer, marketer, etc) maintainability and configuration. Additionally, the system design seeks to provide minimal effort for creating development, test, and deployment environments, speeding those tasks and reducing the number of human steps (and potential mistakes).

With reference now to FIG. 2, web page databinding, generally 10, is instructive because it shows the generalized form of all data operations in the system. The presentation layer 12 makes a request 13 to the services layer 14. The services layer 14 analyses what is required to satisfy the request via a number of steps in data request processing logic 15. Each of these steps accomplishes a task needed to retrieve, format, transform, combine, or otherwise process the data before returning it 17 to the presentation layer 12. In the course of performing these steps, the data services may need to access several different data stores 16. In some cases, this may involve several different data manipulation technologies—such as SQL or XML. Typically, there is an object or a group of objects, e.g., 18, 20, that handle the data for the presentation layer 12 both for the request 13 and the result 22. This eases programming on the presentation side. The specific steps in this operation and the details of each layer will be discussed below.

Data Stores: The preferred system uses a variety of data stores 16. These range some simple files on a disk to multiple relational databases. Each serves a specific function both in how it is used and how it is maintained.

The Maguro database 24 is the core of the online website data structures. It is a relational database designed to provide relational integrity between tables, small record sizes, and performance for OLTP operations. Although capable of some analytical functions, the Moguro database's 24 emphasis on highly normalized data makes it best for real-time processing. Almost all dynamic data and client information is stored in this database 24—to make it relatable, reliable, and available in real-time.

OLAP Database: When requirements and performance concerns dictate, the system may be split into one or more separate database(s) 28 in order to provide, e.g., OLAP functionality. This may include a separate data mine and analysis database, but initially the split should move the long-term and detailed OLTP records to a single OLAP database and create additional analysis capabilities on top of that database. The OLTP database then should be pruned for optimal real-time performance. The OLAP database may then extend functionality in ways that the original OLTP database cannot.

The OLAP database should be synchronized with the OLTP database on a non-real-time schedule for performance concerns. Such synchronization is desirable both for OLTP performance and to keep the OLAP data static long enough to perform resource-expensive analyses.

The system makes use of a single, unified configuration file 30, stored on each of the web servers, to control all of its customizable behaviors. This is the web.config file 30 scheme provided by ASP.NET. It 30 parameterizes all of the settings that affect how the system behaves in development, testing, sales, and production environments. All other behaviors are consistent across the applications. This aids in testing and stability due to the limits of variability in configuration and allows the same version of software used to test to be deployed to the production environment.

XML Stores: The system 10 makes extensive use of XML stores 32 for static data. This includes email templates, XSLT transforms for page effects, XML databases of almost-static data, etc. These stores 32 serve several purposes. First, they are easy to modify by non-programmers and do not require a database update or tool to accomplish such modifications. This structure not only increases the flexibility of the system but also reduces problems with such modifications. In addition, by putting processor intensive items like transforms or static information such as branding mappings on the web servers, the load on the database servers, e.g., 24, and services layer 14 is lightened. This structure also increases the scalability of the system by taking advantage of divide-and-conquer techniques like caching and local processing.

Data Components: A Turbine.Data object (not shown in FIG. 2) is the front-end of the data services layer 14 within the data request processing logic section 15. Turbine.Data provides objects and interfaces to call into the lower data functions and abstracts the details of the data stores 16 underneath. Turbine.Data is based on the System.Data and System.Xml portions of the underlying framework. By abstracting (hiding) the details of the underlying data stores 16 and processing elements, Turbine.Data allows the presentation layer 12 to apply consistent logic to the data it uses. As a result, the system may switch from SQL Server to Oracle without changing code in the presentation layer (pages) 12. This provides effective testing and task isolation—which can translate into increased stability, maintainability, and scalability.

Turbine.Data exposes a single set of unified, consistent interfaces to read and write data. Internally, both operations are accomplished by a unified stored procedures interface for OLTP operations. This allows data simplified exchange between the data store and the data component. Also, by making modification requests atomic and simple on the request side, issues with locking and concurrency are reduced. Instead, the stored procedure can assure correctness of the modification.

A Turbine.Data.Assist object, also called DataAssist 36, services requests to, and responses from, the data services layer 14. It provides data access facilities to the presentation layer 12 including table, column, and row access for tabular data, as well as serialization, transformation, and persistence functions. Additionally, it includes a simple type-binder for expedient access to typed data. Lastly, it includes extremely deep, robust support for various data-binding mechanisms, which are discussed below.

Data Presentation: The data presentation layer 12 is the collection of application elements that performs data requests. This includes request from pages 38, services, components, applications, and in the future, outside parties wishing to access the data in the stores 16. The two most common methods of access are data-binding services 40, which are primarily used by pages and components, and data access services, which are used by reports and exports. Additionally, the presentation layer 12 can make requests to change data, which is handled by a simpler mechanism than data-binding or data access.

Data Binding: With continuing reference to FIG. 2, data binding is the process by which data from the data store 16 is made a part of an object in the presentation layer 12. There are many possible ways to perform data binding, and the system attempts to support a range of these to provide power and flexibility without burdening the developer with excess work.

Data binding starts when the presentation layer 12 makes a request 13 to the data services layer 14 to read some kind of data. This is mostly processed through the DataAssist object 36. Once the DataAssist object 36 receives the request 13, it 36 begins a processing flow that retrieves data from data stores 16, transforms the data, and continues processing until the DataAssist 36 presents a final result 22 for the request 13. This may involve only retrieving a single value from a table or procuring multiple XSLT passes against a hierarchical structure. Once the result(s) is (are) obtained, the DataAssist object 36 transports it 22 (them) back to the presentation layer 12 for binding. If there were any errors or problems, the DataAssist object 36 reports the problem to the presentation layer 12 so that appropriate action can be taken.

Once the presentation layer 12 has data 22 to bind, there are many options for deciding how to use the data in the binding. The system currently makes use of three primary mechanisms for binding. One is ASP.NET databinding 42. ASP.NET databinding 42 involves placing smart controls on a web page and advising that control that when binding occurs. ASP.NET databinding 42 should then locate the data to be bound in a specific place corresponding to a place inside of the DataAssist object 20.

Another binding method utilized by the preferred embodiment is XSLT rendering 44. XSLT rendering 44 is utilized for non-interactive content like lists and reports. An XSLT template receives the underlying data and transforms it into an appropriate representation for a web page.

The preferred system also uses manual code binding 46. Manual code binding 46 involves programming the exact steps to extract the data from the DataAssist object 20, manipulating the extracted data in any needed way, and placing the manipulated on the web page.

The binding mechanism of the preferred embodiment can extend to support new binding technologies. For example, ASP.NET 2.0 provides direct Web Services binding and XPath binding 48. These binding services 48 can eliminate steps of other binding techniques. XForms 48 might also be utilized binding and may allow more interactivity by combining the interface definition with the transform process.

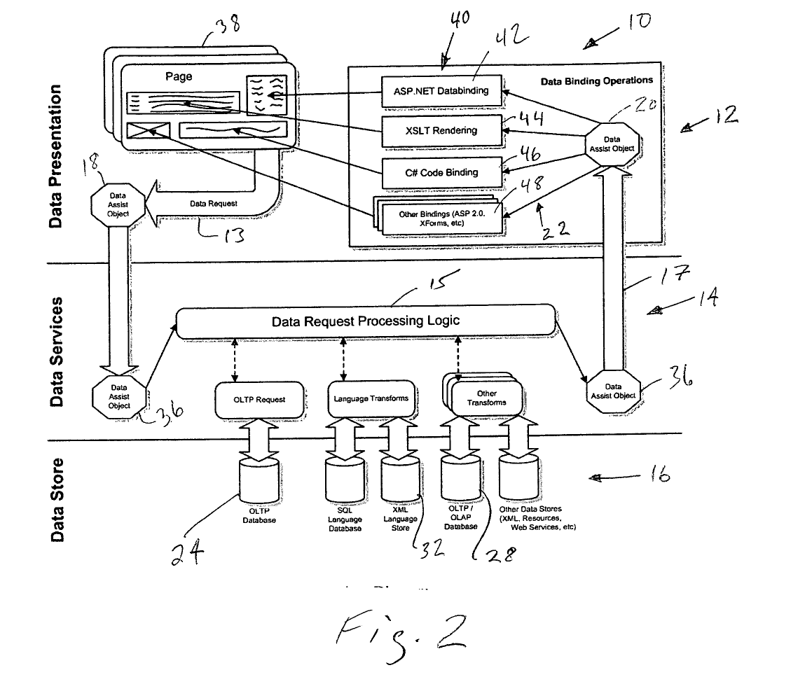

With reference now to FIG. 3, data access addresses the problem of how to get information out of the system, not to an interactive page, but to a foreign representation such as a static report. In this case, the underlying data may be retrieved from the data services layer 14 by a service request layer 50, formatted, and rendered to a simple, printable, savable format by an internal report generator 52. This can be handled internally by any number of means.

In certain instances, a third-party reporting engine or tool 54 can be utilized to generate the desired report output. In this case, the reporting engine or tool 54 receives the underlying data from the service request layer 50 and generates the report.

The preferred embodiment also includes XML export facilities 56 to support third party systems and other data reporting facilities. For any supported request, an XML version of the result can be made available to be handled however the consumer wishes. For client export capacity, the client system can use the XML export facility 56 to perform the client's desired operations on exported data in databases, spreadsheets, or other system. XML export facilities may also provide data exchange for other future data access systems 58.

Data Access: With reference now to FIG. 4, the preferred embodiment limits access to data and provides accountability features and a user authentication system. Throughout the system, user authentication is handled by a central component called the User Security Manager, or USM, generally 60. This centralization provides several benefits. First, it reduces opportunities for security circumvention by omission or ignorance. Second, it facilitates security development and testing.

The first system access pattern supported by the USM 60 is the anonymous page 62. In this case, a user on the web attempts to access a system page 64 and provides no identification information to the site. In this case, the page 64 receiving the request queries the USM 60 regarding whether the user may observe the contents of the page 60 without authentication from the user. If the particular page 60 is authorized for anonymous access, the USM 60 will authorize the request and the user will see the page 60. If the USM 60 does not allow anonymous access to the page, it will activate a security exception in the application, which will prevent the page 64 from returning information to the user and perhaps ask them to further identify themselves to the application. This prevents anonymous attacks on the system as well as errors due to inappropriate bookmarks and general user access.

The second access pattern, which may occur as a response to a failed anonymous access attempt, is the login request 66. When the user is asked to login 66, the user is asked to provide two pieces of information, a unique identifier and an authenticator. For the current implementation, this information consists of an email address and a password. In the future, this information may include a public-key credential or similar security technique.

Security System: The USM 60 enforces a minimum password length to prevent anyone from choosing a trivial or blank password. The USM 60 also prevents a brute-force online attack by locking out the user's account if too many bad passwords are attempted in a certain window of time.

Once the user has provided the appropriate login information, the USM 60 via the data manager 68 retrieves the user's credentials from the credentials store 70 in the database and issues the user a user credential 72 which proves who he is to the rest of the system. This credential 72 is not actually sent back to the user, but is stored in the session credentials store 74 via the state manager 76. The state manager 76 issues a session identifier to the user which it can use to later retrieve the credentials when needed. This prevents any accidental disclosure of sensitive data to the user and allows the system to perform caching of other security information without undue overhead on the client side.

Once the user has valid credentials, the user can now access the parts of the system to which that particular user is to have access. When the user requests a user page 78 requiring user authentication, the page 78 will ask the USM 60 if the user is authenticated. The USM 60 then procures the user's credentials from the session credentials store 74 through the State Manager 76 and validate the credentials.

Once validated, the USM 60 informs the page 78 that the user is authenticated and provides the user's identity if needed. If the page requires the user's identity (for example, to send an email), the page can then use the identity to process information specific to that user. This is especially important for auditing and non-repudiation. Auditing is the process by which changes to important data are recorded along with the identity of the person making the modification. When a user makes a change to a financial field for example, the system logs the changes and the identity of the user making the changes.

In the case of a unit page—a page subject to unit-level security—the unit page 80 asks the USM 60 if a particular user can perform a particular operation on the page 80. This operation might be a request to see or modify data on the unit page 80 The USM 60 checks the session credentials store 74 to determine if the user already has the appropriate credential. If not, the USM 60 loads the needed credential, if available for the user involved, from the persistent credentials store 70 and accepts or denies the operation based on that credential. If reuse of the credential is likely, the USM 60 will save the credential in the session credential store 74 for more rapid access later.

III. Network Topology:

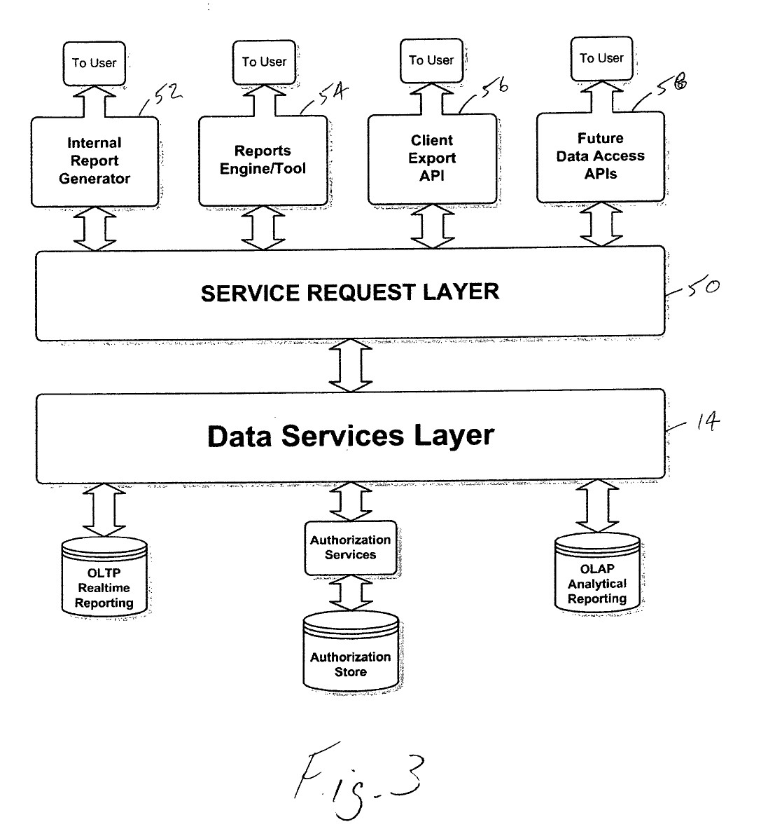

With reference now to FIG. 5, a router/firewall/load balancer 82 provides the interface between the preferred system and the Internet 84. Below the router 82 is the web server layer 86. This layer 86 provides computing machines 88, 90, 92 for processing of web requests. Generally speaking, these machines should be designed to be easily configured and replaced. They also should have few, if any, interdependencies on one another. This means that, if a machine, e.g., 88, fails, the failed machine 88 may be taken offline and replaced.

This web-server topology supports easy increasing of capacity of the web server layer 86. This topology also places primary computational resources for servicing requests in the web server layer 86, thus lightening the load on databases, other services, and other layers.

The web server layer 86 is connected by a high-speed switching network 94 to the databases, generally 96. The high-speed switching network 94 supports at least a 100 Mbps Ethernet and includes a dedicated switching backbone with intelligent routing capabilities. Each web server, e.g., 88, preferably supports two network connections, one for the slower-speed connection to the Internet 84 and one for the high speed connection to the high speed switching network 94.

Access Patterns: With reference now to FIG. 6, this “donor access pattern” represents a typical request through a web server, e.g., 88, to one or more databases, generally 96. Only components that are integral to the request spend resources on the request. The request first starts with a user requesting a donor webpage 98. The egress router 82, based on its load-balancing state, selects a particular web server, e.g., 88, sends the request to the selected web server 88. In the course of formulating the response, the web server 88 decides to make two database calls—one to the OLTP general database 100 and one to the OLTP donor database 102. The web server 88 issues those two calls from its backend interface (not shown in FIG. 6) to the database layer 96, bypassing the upper web server layer (not shown in FIG. 6) and thus avoiding consumption of switching/parsing resources by a non-web request. The switching layer intelligently routes the request to the appropriate servers, e.g., 100, 102, which process the request and return a response to the web server 88.

With reference now to FIG. 7, a reporting request 104 may be made by a user (not shown in FIG. 7) on the system, generally 10. The load-balancer 82 selects a particular web server, e.g., 106, to process this request 104. The web server 106 seeks authorization to provide the requested report for this user by issuing a request to the OLTP organization database 108 to obtain the credential (if available for the applicable user). If and when the credential comes back as authorized, the web server 106 begins constructing the requested report. In this case of FIG. 7 for example, part of the report is based on current information from the OLTP organization database 108 and part is based on an analytical function from the OLAP report database 110. The web server 106 issues request to both of these databases 108, 110. The result from the OLTP database 108 should be returned immediately, but the OLAP database 110 may take time to compute and return the result.

During this report request processing time, other system processing occurs as normal. Once the OLAP database 110 is finished processing its portion of the request, it 110 returns its response, which may be large and consume significant bandwidth in the communications line 112 to the Web server 106. All other lines, however, are isolated from this heavy traffic by the switching fabric, so no other operations on any other machine slows down as a result of the report request 104.

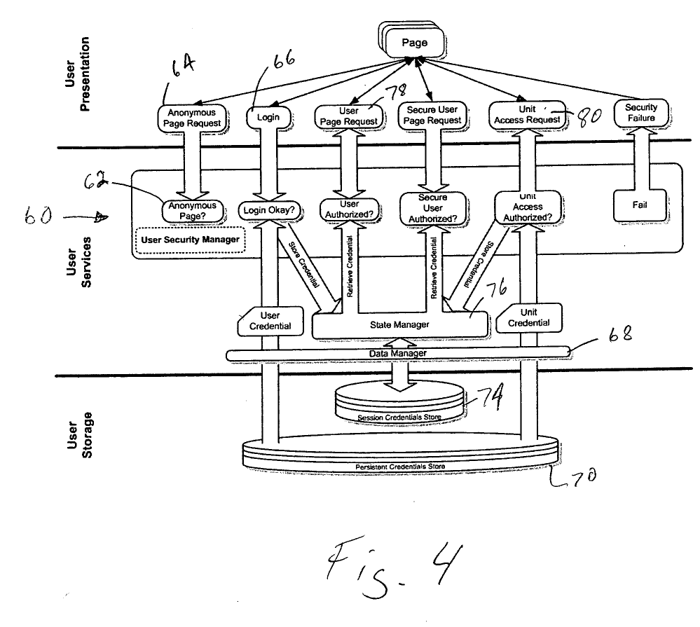

With reference now to FIG. 8, the media access topology may serve, for example, a media request 114 for an image is served by a web server, e.g., 116, selected by the load balancer 82 as noted above. If the requested image is a system image (icon, logo, etc), the web server 116 preferably has local access to the file and returns the result without further processing internally within the system 10. If the requested image is a user media image, which is stored on a media service machine/cluster 118, the web server 116 passes the request it to the switching fabric 94 (which may or may not be the same fabric as that for the databases 106, 102, 108, 110). The media services 118 return the requested image file to the web server 116 and the requested image file is returned to the user.

This media access request/return process does not consume or divert the database layer 96 resources. In addition, if during this process the requested media services are offline, a default “image not found” image is returned.

The system 10 thus provides inherent fault-tolerance and security. Because nothing has direct access to any particular machine from the internet, the parts are inherently capable of swapping and failover with limited or zero downtime. In addition, if a given web server, e.g. 88, fails, the load balancer 82 will redirect requests to another web server, e.g., 106.

Below the web server layer 86, the switching fabric 94 can be redundant as well, ensuring that no single switch failure can disrupt the system. This also allows re-cabling, hardware maintenance, and other soft-failure conditions. Below that, each service can be made redundant according to its capacities. The database servers 96 can be configured for clustering or failover. Other services can be made redundant according to function.

The topology described above also provides defense in depth or defense due to the number of layers that must be penetrated to get to the database layer 96 for example. By providing defense in depth, the system provides increased security against single points of failure in the security scheme.

For example, if a hacker were to penetrate the egress router, the only parts exposed are the web servers, which at most have some configuration files, content, and compiled code. These servers a may also have their own firewall protections. To gain access to any valuable data, the attacker must compromise the web server and penetrate the database server layer 96 (again, perhaps with its own firewall). Each of these attacks presents different difficulties and exposes the attacker to a higher risk of discovery—making a successful attack increasingly improbable. Compare this to a topology where the database is connected directly to the egress router or even the internet itself.

The above-referenced topology also supports remote access for maintenance. Remote access is a type of attack because it circumvents security in a controlled way to allow authorized personnel unlimited access to the systems. The present topology supports remote access through the high-speed switching level 94. At the web server layer 86, an IPSec or PPTP VPN server is installed with a back-end connection to the switching fabric 94. When the VPN server is engaged, a hole is opened for the authorized user to access all of the connected remote machines (not shown). This hole disappears when the VPN is disengaged and the system is again fully secure. If an even higher level of security is desired, another VPN can be placed behind the database servers 96 to allow two-level authenticated access to the other machines, providing there is a firewall on the front-end of the database machines.

State Management/Navigation System: The preferred system 10 utilizes a navigation manager and state manager. The navigation and state managers provide a consistent programming interface, enforcing discipline in state and navigation management. In order to pass parameters, the navigation manager interacts with the state manager to decide which parameters to pass in which medium.

Units: The preferred system 10 utilizes objects that are functional as well as architecturally defining. Most fundamentally, the system 10 utilizes a unit object, which represents an abstract operational unit, organization, or sub-organization administered by, or represented in, the system 10 From the unit object, the system derives hierarchy of projects, groups, and organizations. Through this unit object structure, the system 10 provides and supports an array of business functions.

With reference to FIG. 9, the organization object unit 120 represents the structure of an organization by an upside-down tree 119 with nodes representing entities or activities within the organization. These nodes include virtually any type of unit or business activity: departments or groups, e.g., 122, sub-groups 124, projects 126, tasks 128, etc. Each such entity or node has a name, a conceptualization within the organization, and a relationship with the other entities in the organization. The organizational unit, when combined with other sub-units, therefore can provide a generalized representation of the organization's hierarchy.

Each type of unit may have its own unique attributes. For example, groups can track data that projects may not; projects may have information that is not particularly relevant to an organization. By having unique attributes for the type of unit involved, other unit types need not have to track every possible value even if it's not used. Only values relevant to the particular unit type are stored. For example, may projects track a start and end date value - neither of which is relevant to a group or an organization since neither usually has a defined ending date or a starting date that provides any computational value. In this way, each derivation of the basic unit structure is extended in a natural way for the type of entity or activity represented by its particular unit type.

This customizable object unit format makes the system easier to revise, maintain, and expand. It also provides a readily understandable hierarchical structure for an organization, its entities, and its activities.

Unit security provides the preferred system with a unified interface to protect access to data within the unit. Based on the unit hierarchy, this protection is defined for each unit in terms of the roles certain types of users may have within the unit. The system breaks these roles into restrictions and in evaluating those restrictions limits or alters each user's allowed actions and options.

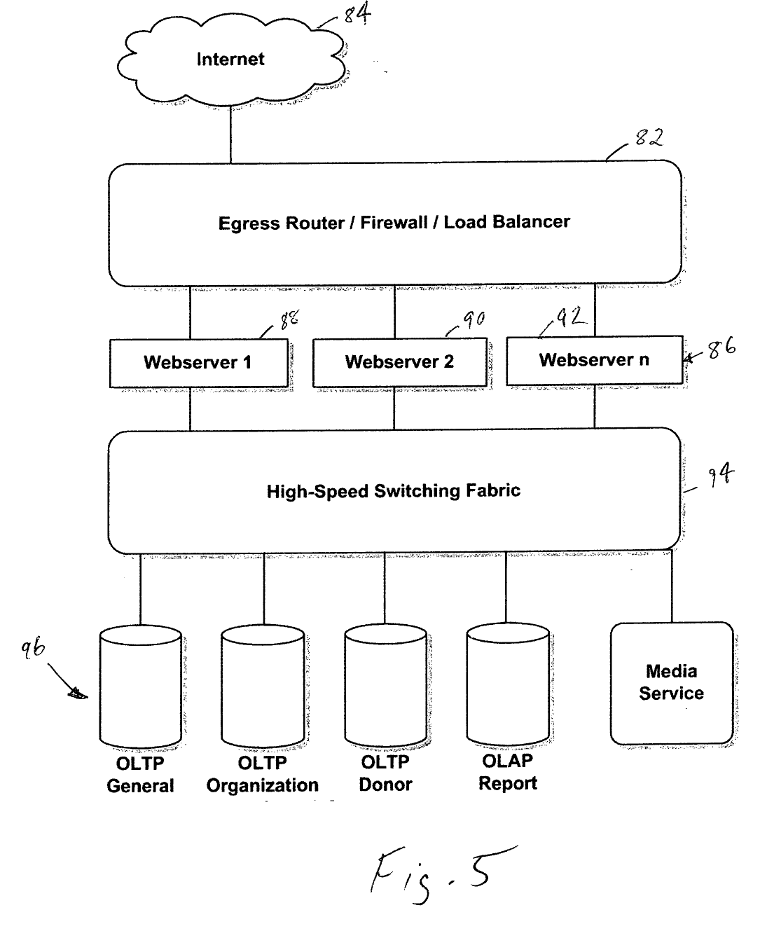

With reference to FIG. 10, a given unit 130 may be established, via the system software 10, which provides certain potential types of privileges, e.g., 132, 134, for users within the unit 130. The organization or entity responsible for management of the unit may then define roles, e.g., 136, for a particular user 140 of the unit granting or denying the user one or more of the privileges 132, 134 available to the unit 130. This results in a permission 138 providing a definition of allowed actions in that unit 130 for the user 140, and it coexists with other permissions in that unit 130 for other users (not shown in FIG. 10).

In this regard, each unit can not only have multiple users with permissions but can have multiple roles for each user. In addition, permissions can also be inherited by lower units.

With reference to FIG. 11, the user security manager (USM) 141 administers the unit security process. When, for example, a user 142 enters a system page 144, the USM 141 evaluates the user's rights on that page 144. The page 144 requests a privilege, e.g., 146, from the USM 141 for the applicable unit 148. As explained above, after login the USM 141 accesses the credentials store 150 to procure and load all permitted roles, e.g., 152, for this user 142 in the requested unit 148. These roles, e.g., 152, expand to privilege, e.g., 146, and the USM 141 merges those expanded privileges 154 into a single effective privileges set 154. The USM 141 refers to this privilege set 154 respond to a page's request for the privileges 154 available to the user 142 in the unit 148. Based on these responses, the page 144 will then which perform and allow activities according to the privileges set 154, including hiding data from view, navigating away, making things read-only, limiting choices, etc.

With reference now to FIG. 12, the USM 141 also supports permission inheritance. This means that each permission, e.g., 155, in a given unit, e.g., 156, also carries with it a flag that indicates whether or not the permission itself automatically transfers to (is inherited by) hierarchically lower units 158.

IV. System Platform:

The preferred system is implemented on a Microsoft-centric server platform, running Windows Server 2003. The system is built on the Microsoft ASP.NET 2.0 development platform and supports cross-platform and dynamically compiled and optimized code.

The ASP.NET compiler is backed by a framework supporting a large number of objects and functions. These technologies support rapid development and a flexible testing and deployment environment. Additionally, these ASP.NET and related framework technologies can run on Linux/Unix if desired.

The System runs against a Microsoft SQL Server 2000 database. SQL Server 200 integrates with the other platform technologies and provides online transaction processing (OLTP) database functionality. It therefore maintains a real-time online processing database. For more involved online application processing (OLAP), Oracle database products are supported by the platform via a system-wide data abstraction layer.

V. Navis Data Model

The Navis System embodiment builds on the concept that all data in the system can be represented as a type of object, which is serialized to a backend store. As a result, the Navis system embodiment has an object-oriented terminology throughout. In this regard, although the current implementation is serialized to a relational database, other forms of serialization are easily supportable with this model, including XML or .NET binary serialization.

The data model consists of several, mostly orthogonal data hierarchies. These hierarchies describe a particular area of functionality and are designed to minimize interference with each other. The overall order of the hierarchies and the objects within are based on importance/derivation-superiority.

Computed Values: Computed fields are, for the most part included inline with the other fields. This is due to the lack of distinction about whether the data store actually records those values.

A. User Hierarchy

The User Hierarchy contains all information related to a User of the system. In most cases, this User represents a person accessing the system, but may also represent any system entity, such as an Organization, that requires a unique identification. A User is the primary means of recording accountability in the system, so persons or entities that use the system are encouraged to have their own user account with the system. This allows the system to collect statistics on user behavior and preferences.

1. UserAccount

A User is the familiar user record that describes a single person or entity accessing the system. It contains all identity, security, and authentication information, as well as contact and policy information as follows:

Scope:private|Instance: multiple|Parent: Root

| FIELD | GROUP | DESCRIPTION |
|---|---|---|
| UserID | Basic | The unique identifier of the User. |
| Email | Identification | Effectively, the UserName. This is not only |
| | | the Company-to-User contact email address, |
| | | but also serves as the system login identifier. |
| UserPass | Security | The cryptographically hashed value of the |
| | | User's password. This is used to authenticate |
| | | that an entity claiming to be a User actually |
| | | is that User. |
| UserSalt | Security | A value that is cryptographically combined |
| | | with the User's password during hashing to |
| | | increase the resistance to attack of the |
| | | password value. It should be updated |
| | | anytime the password is changed to a |
| | | completely unrelated (to anything) value. |
| | | This value prevents a large-scale attack on |
| | | the entire User database from yielding any |
| | | useful results. |
| UserVerify | Security | This is a key used internally to encrypt |
| | | User-specific data in a way that is unique to |
| | | that user and secure. If a password changes, |
| | | this value should be reset to a new key, |
| | | preventing old encryptions from being valid |
| | | for this key. |
| SecretQuestion, | Security | The question, provided by the User, is asked |
| SecretAnswer | | of someone wishing to reset the User's |
| | | password in case that password is forgotten. |
| | | The answer must be provided in order for |
| | | the reset to proceed. This is also a possible |
| | | way to authenticate the User if a person-to- |
| | | person authentication needs to be |
| | | performed. |
| FirstName, | Personal | This is the personal name and surname of |
| LastName | | the User. This is the name that the system |
| | | would identify the User as. Users should be |
| | | strongly encouraged to give their real names |
| | | for these values. |
| CompleteName | Compute | This is the concatenation of the TitlePrefix, |
| | | FirstName, LastName, and TitleSuffix with |
| | | corrected spacing. It is used to provide a |
| | | single-field value for the User's preferred |
| | | name. |
| Birth Date | Personal | The date of birth of the User. This is used to |
| | | verify that the User is old enough to contract - |
| | | thus old enough to use the system. This is |
| | | currently 18 years old. This is also used to |
| | | authenticate the User in the event of a |
| | | password reset request. |
| PhoneHome, | Personal | These are the contact phone numbers for the |
| PhoneWork, | | User. |
| PhoneMobile, | | |
| PhoneFax | | |
| TitlePrefix, | Personal | These are the title appellations applied to the |
| TitleSuffix | | User's name when creating the User's |
| | | Complete Name. |
| AddressDesc, | Personal | These are the address values for the User's |
| AddressLine1, | | primary contact address. Users should be |
| AddressLine2, City, | | strongly encouraged to provide factual |
| State, PostalCode, | | information here, as this is the primary |
| CountryID | | backup contact method for the Company if |
| | | the email address cannot be used. |
| CreateDate | Basic | This records the creation date of the User. |
| AgreeLast | Policy | This records the last date the User agreed to |
| | | the User Policy. It is used to compare with |
| | | the current date of that policy to see if the |
| | | User needs to re-agree to the policy. |
| LoginLast, | Policy | These values record, respectively, the last |
| LoginAttempt, | | successful login date, the last login attempt, |
| LoginTries | | and the number of attempted logins. They |
| | | are used to enforce the login policy which |
| | | permits a fixed number of unsuccessful |
| | | logins in a given time period. |
| UserOption | Option | This records a value which maps to a certain |
| | | combination of User options. These options |
| | | include Accessibility options, etc. |

2. UserProfile

A UserProfile describes an interface into the system that is available to a User. Profiles are used to give the User access to the various applications and to provide interface options to those applications. For example, if the User enters an Organization Profile, the Profile's OrganizationID provides the application with the identity of the Organization the User wishes to interact with. If the User selects a Donor Profile, then the application initializes the donor interface and uses the AccountID to identify the Account the User wishes to interact with.

Profiles contain personal information that is public to an application interacting with that Profile. For example, a Profile contains an email and phone number. If the application displays the User's personal email and phone number, that might be undesirable for both business applications (different home/work emails) and for privacy concerns (anonymous information for sensitive personnel). As a result, Profile information is by default replicated from User information, but the User has the option to edit the Profile to provide different values for this information. Therefore, applications should be very cautious when revealing User information. Profile information is almost always the preferred disclosure, as it allows the User to choose how much they will reveal to their co-workers, donation organization, government, etc.

Scope: limited|Instance: multiple|Parent: UserAccount

| FIELD | GROUP | DESCRIPTION |
|---|---|---|
| UserID | Basic | The identifier inherited from UserAccount. |
| ProfileID | Basic | The unique numeric identifier of the Profile. |
| ProfileName | Basic | The name of the profile - provided by the User or |
| | | as a system default. This is to help the User keep |
| | | track of their various Profiles. |
| ProfileType | Basic | The type of the Profile. Current allowed values |
| | | are: Organization Profile and Donor Profile. |
| IsDefault | Application | Whether or not the Profile is considered the |
| | | Default Profile. A User may have at most one |
| | | Default Profile. If a User has a Default Profile, |
| | | then upon login, the system automatically enters |
| | | the Default Profile. |
| AccessLast | Application | The last time this Profile was accessed by the |
| | | User. |
| AccountID | Application | For Donor Profiles, the AccountID that this |
| | | Profile uses. This allows the user to have multiple |
| | | Accounts - each tied to a different Profile. |
| OrganizationID | Application | The Organization the Profile wishes to interact |
| | | with. For Organization Profiles, this is the |
| | | Organization that the User wishes to manage in |
| | | the Organization Management Application. For |
| | | Donor Profiles, a zero value means the User |
| | | wishes to interact with all public Organization's |
| | | Projects. A non-zero value means the User wishes |
| | | to interact only with the particular Projects of the |
| | | given Organization. |
| CreateUserID | Invitation | The UserID of the User that created this Profile. |
| | | In many cases, this is the same as the User who |
| | | owns the Profile. In the case of tracked |
| | | invitations, this is the User who created the |
| | | invitation. |
| CreateDate | Basic | The date the Profile was created. |
| IsContactUpdate | Option | Whether changes to the UserAccount record |
| | | automatically update this Profile's contact |
| | | information. |
| CompleteName | Compute | Same as UserAccount, but concatenated from the |
| | | Profile values. |
| FirstName, | Personal | Same as UserAccount. If contact updating is on, |
| LastName | | these will have same values as UserAccount. |
| TitlePrefix, | Personal | Same as UserAccount. If contact updating is on, |
| TitleSuffix | | these will have same values as UserAccount. |
| Email | Personal | Same as UserAccount. If contact updating is on, |
| | | these will have same values as UserAccount. |
| PhoneWork | Personal | Same as UserAccount. If contact updating is on, |
| | | these will have same values as UserAccount. |

3. UserProfileList

The UserProfileList provides a per-Profile list of Units along with some additional data useful to the specific type of list. These lists include the Donor Shopping Cart, the Donor Watch List, the Donor Fund List, and the Organization Bookmarks.

Scope: private|Instance: multiple|Parent: UserProfile

| FIELD | GROUP | DESCRIPTION |
|---|---|---|
| UserID | Basic | The identifier inherited |
| | | from UserProfile. |
| ProfileID | Basic | The identifier inherited |
| | | from UserProfile |
| ListType | Basic | The type of the list. |
| | | Allowed values are Shopping |
| | | Cart, Watch List, Fund |
| | | List, and Bookmarks. |
| UnitID | Basic | The Unit this list entry |
| | | refers to. Units must be unique |
| | | within a single list type. |
| Amount | Application | For the Shopping Cart, the |
| | | Amount of the pending |
| | | donation. For the Fund List, |
| | | the total value of all |
| | | donations to this Unit. |
| IsAnonymous | Privacy | Whether this donation |
| | | should be recorded as |
| | | anonymous. Applies to |
| | | the Shopping Cart. |
| ModifyDate | Basic | The last date this entry |
| | | was updated. This is used to |
| | | sort results to provide a |
| | | context-relevant listing. |

4. UserAsset

A UserAsset describes a particular Asset to or from which the User can transfer funds. It is some kind of outside account, such as a bank account, a credit card, etc.

Scope: private|Instance: multiple|Parent: UserAccount

| FIELD | GROUP | DESCRIPTION |
|---|---|---|
| UserID | Basic | The identifier inherited |
| | | from UserAccount. |
| AssetID | Basic | The unique identifier |
| | | of the Asset. |
| AssetName | Basic | The name of the Asset. This |
| | | is provided by the User |
| | | or as a system default and |
| | | is used to help the User |
| | | identify Assets. |
| AssetType | Basic | The type of the Asset. Allowed |
| | | values are Credit Card |
| | | and Checking Account. |
| AccountNumber | All | The account number of the |
| | | Asset. The format is |
| | | determined by the AssetType. |
| RoutingNumber | Check | For bank accounts, the |
| | | Routing Transit Number for |
| | | the account. |
| ExpirationDate | Credit | For credit cards, the |
| | | expiration date of the card. |
| CardType | Credit | For credit cards, the type |
| | | of the card. Allowed values |
| | | are Visa, MasterCard, |
| | | American Express, and |
| | | Discover. |
| CardVerify | Credit | The CCV2 code of the card. |
| | | As some authorizers may |
| | | prohibit the storage of this |
| | | field, this field may be |
| | | removed in a future revision. |

B. Unit Hierarchy:

The Unit Hierarchy stores the abstract representation of a Business Unit. Business Units (Units for short) store information that is generally applicable to any given unit of reporting or tracking within an Organization. For example, Organizations, Groups, and Projects are all Units. This allows a feature that is created for one type of Unit, perhaps an Organization Update Policy, to be applied as a Project Update Policy using the same backing structures.

1. Unit

A Unit stores the unique, common, and defining attributes of all Units. The Unit is the abstract representation of any Business Unit in the system and is heavily derived and extended by the system.

Scope: public|Instance: multiple|Parent: Root

| FIELD | GROUP | DESCRIPTION |
|---|---|---|
| UnitID | Basic | The unique identifier of the Unit. |
| Name | Basic | The User supplied name for the Unit. |
| ParentID | Basic | The superior (parent) Unit in the |
| | | Unit Hierarchy. |
| AncestorID | Deprecated | The highest related Unit in this Unit's |
| | | hierarchy. This field is deprecated. |
| IsWorking | Deprecated | Whether the Unit is currently in the |
| | | temporary initialization state. In this |
| | | state, any attempt to edit the Unit |
| | | results in the User being taken to a |
| | | special editing area just used to |
| | | initialize Units. This field is |
| | | deprecated. |
| CreatorID | Basic | The User who created the Unit. |
| CreationDate | Basic | The date of the Unit's creation. |
| LastUpdate | Basic | The last time any modification was made to |
| | | this Unit. This value is update-cascaded |
| | | from many lower objects, so it changes |
| | | frequently if any modifications are being |
| | | made anywhere to this Unit. |
| IsActive | Policy | Whether this Unit is disabled by the |
| | | system. This flag prevents Units from |
| | | being used if the Company decides that |
| | | the Unit (and possibly all related Units) |
| | | should be disabled for user interaction. |
| UnitType | Compute | The type of the Unit. Allowed values are |
| | | Root, Organization, Group, and Project. |
| | | This is computed from the one-to-some |
| | | relationship that subordinate objects |
| | | have with the Unit object. Although |
| | | technically possible to have an |
| | | Organization that is also a Project, |
| | | that possibility is currently disallowed |
| | | by system business logic. As a result, |
| | | this field can be non-ambiguously |
| | | resolved to a single Unit Type - |
| | | which aids runtime determination of |
| | | Unit Type greatly. |

2. UnitAncestor

UnitAncestor is a computed structure that allows hierarchy walks to be performed using database joins or other relational faculties without resorting to temporary tables, cursors, etc. It is never referred to outside of the data store and is not directly available for application use.

Scope: hidden|Instance: multiple|Parent: Unit

| FIELD | GROUP | DESCRIPTION |
|---|---|---|
| UnitID | Basic | The identifier inherited from Unit. |
| AncestorID | Compute | The identifier of the ancestor |
| | | object. One ancestor value is |
| | | recorded for each ancestor of |
| | | this object, including the |
| | | object itself, all the way up |
| | | to the root object. |
| Distance | Compute | The distance from this object |
| | | the ancestor is. These values |
| | | are negative, as they proceed |
| | | up the hierarchy. |
| Depth | Compute | The absolute depth from the |
| | | root this ancestor is. The root |
| | | itself has a depth of zero |
| | | and subordinate layers have |
| | | increasing positive integers |
| | | from there. |

3. UnitAccess

A UnitAccess is an Access Level defined by a Unit. Once defined for a Unit, that Unit and its subordinate Units can use that Access Level to assign permissions to Users, etc. An Access Level is composed of individual permissions, which the system uses to determine access rights. The Access Level itself has no meaning in resolving security rights. Each Organization hierarchy is given a single starting Access Level called “Administrator,” which has all permissions and inherits to all Units.

Scope: protected|Instance: multiple|Parent: Unit

| FIELD | GROUP | DESCRIPTION |
|---|---|---|
| UnitID | Basic | The identifier inherited |
| | | from Unit. |
| AccessID | Basic | The unique identifier of |
| | | this Access Level. |
| AccessName | Basic | The name of the Access Level. |
| | | This is user defined - |
| | | even for Administrator, which |
| | | can be changed by the |
| | | User. |
| Description | Basic | This is a longer description |
| | | provided to allow the user to |
| | | describe the conferred |
| | | rights in detail. |
| IsSystem | Security | This permission marks the |
| | | Access as system-defined and |
| | | therefore non-editable. |
| IsView | Security | This permission confers |
| | | view/read/list rights. |
| IsEdit | Security | This permission confers |
| | | edit/modify/add rights. |
| IsCreate | Security | This permission confers |
| | | object creation rights. |
| IsDelete | Security | This permission confers |
| | | object deletion rights. |
| IsAccessView | Security | This permission confers |
| | | access level viewing rights. |
| IsAccessEdit | Security | This permission confers |
| | | access level editing rights. |

4. UnitAccessUser

UnitAccessUser records the assignments of Access Levels to Users for Units. This specifies a User's access rights for any given Unit. It can be extended to each level of the Unit Hierarchy to allow permission inheritance.

Scope: protected|Instance: multiple|Parent: UnitAccess

| FIELD | GROUP | DESCRIPTION |
|---|---|---|
| UnitID | Basic | The identifier inherited |
| | | from UnitAccess. |
| AccessID | Basic | The identifier inherited |
| | | from UnitAccess. |
| UserID | Basic | The User that rights are |
| | | defined for this Unit and Access. |
| Inheritable | Security | Whether this Access inherits |
| | | for this User to subordinate |
| | | Units. |
| Denial | Security | Whether this causes a denial |
| | | of permissions for this Unit. |

5. UnitAddress

UnitAddress records the various addresses a Unit might require.

Scope: public|Instance: multiple|Parent: Unit

| FIELD | GROUP | DESCRIPTION |
|---|---|---|
| UnitID | Basic | The identifier inherited |
| | | from Unit. |
| AddressIndex | Basic | The unique identifier of this |
| | | Address. |
| Description | Basic | A user-supplied description |
| | | of this Address. |
| | | Examples: Shipping, |
| | | Billing, Fan Mail. |
| AddressDesc, AddressLine1, | Basic | These are the values for this |
| AddressLine2, City, State, | | Address. |
| PostalCode, CountryID | | |

6. UnitDescription

UnitDescription stores long-text fields to avoid overburdening the other objects with infrequently used textual data.

Scope: public|Instance: typed|Parent: Unit

| FIELD | GROUP | DESCRIPTION |
|---|---|---|
| UnitID | Basic | The identifier inherited |
| | | from Unit. |
| DescIndex | Deprecated | A type identifier of the |
| | | Description. This field usage |
| | | is deprecated and is being |
| | | replaced by a correct type |
| | | system. Allowed values are: |
| | | Problem, Solution, Issue, |
| | | Strategy, and Match. |
| Description | Basic | The Description value. This |
| | | is generally application |
| | | constrained up to a maximum |
| | | value allowed by the |
| | | data store. |
| DescriptionID | FullText | A unique identifier used to |
| | | provide a key for full-text |
| | | indexing. |

7. UnitUpdate

Unit Updates store information about updating policy, which describes how often edits must be made to areas of record. Updates allow users to decide how frequently to force others, such as coworkers, to freshen data via annoyances and reminders. The update computations allows utilization of several different schemes.

With regard to the update computation, the end result of the computation is always a date of expiration. If the last update for a particular feature is after the expiration date, then the feature is considered to be up-to-date. If the last update is before the expiration date, then the feature is considered to be expired and the system can notify the user.

The expiration date computation is based on an expiration Period. If the expiration Period is set to None, then the expiration date is set at the system-defined beginning of time, which means that any date compared against it will always be in the future. This obviates the need to update because the system date is always past the expiration date. If the Expiration Period is set to Range, then the Range value is subtracted from the current date to produce the Expiration Date. This has the affect of creating a sliding window (such as the last 30 days). Other expiration Periods are based on finding an even time measure boundary such as a month, week, year, etc. In computing the expiration date for this, enough Periods are added to the Feature Date to give the last occurrence of the Date within the Period. As a result, if the Period is monthly and the Feature Date is the 15th, then the Expiration Date will be the previous 15th of the month. If the Period is weekly and the Feature Date is a Monday, then the Expiration Date will be the previous Monday of the week. This pattern holds for all other Periods.

Scope: private|Instance: single|Parent: Unit

| FIELD | GROUP | DESCRIPTION |
|---|---|---|
| UnitID | Basic | The identifier inherited from |
| | | Unit. |
| FinancialDate, | Policy | The Feature Date that defines |
| JournalDate, | | the starting date for |
| MediaDate, MetricDate | | Expiration Date computations |
| | | as illustrated above. |
| FinancialPeriod, | Policy | The Expiration Period used to |
| JournalPeriod, | | compute the Expiration Date. |
| MediaPeriod, | | Allowed values are None, |
| MetricPeriod | | Range, Monthly, Bimonthly, |
| | | Quarter, Semiannually, |
| | | Yearly, and Weekly. |
| FinancialRange, | Policy | When the Period is set to |
| JournalRange, | | Range, this stores the |
| MediaRange, | | number of days in the range. |
| MetricRange | | |
| FinancialCompareExpire, | Compute | The comparable computed |
| JournalCompareExpire, | | Expiration Date. If the |
| MediaCompareExpire, | | computed expiration date was |
| MetricCompareExpire | | in the future, this date |
| | | will be the system-defined |
| | | beginning of time - which |
| | | causes no expirations. |
| FinancialActualExpire, | Compute | The actual computed |
| JournalActualExpire, | | Expiration Date. This |
| MediaCompareExpire, | | value may be in the |
| MetricActualExpire | | future because the user |
| | | may input a starting |
| | | comparison date that is |
| | | also in the future. |

C. Organization Hierarchy

The Organization Hierarchy stores all information about Organizations in the system. An Organization is an entity that typically describes a particular company using the system. Organizations have some unique descriptors, but most features come from common Unit features.

Organization stores information that applies to an entire Organization Unit.

Scope: public|Instance: single|Parent: Unit

| FIELD | GROUP | DESCRIPTION |
|---|---|---|
| OrganizationID | Derive | The unique identifier of the |
| | | Organization. This is |
| | | derived from UnitID. |
| GrowthStageID | | A type indicating the financial |
| | | growth stage of the |
| | | Organization. |
| Website | | The URL of the |
| | | Organization's website. |
| FiscalStart | | The starting date of the |
| | | fiscal year of the |
| | | Organization. |
| IsSecular | | Whether this is a faith- |
| | | based Organization or a |
| | | Secular Organization. |
| ReferredBy | | The entity that referred |
| | | this Organization to the |
| | | Company. |
| AgreeLast | | The last date the |
| | | Organization agreed to the |
| | | Organization Policy. This |
| | | field is not currently |
| | | enforced by an automated |
| | | part of the system, as it |
| | | is unclear who should be |
| | | responsible for assenting |
| | | to this agreement |
| MediaSizeMax | | The maximum media size per |
| | | Unit, in bytes. This |
| | | is the beginning of |
| | | allowing the Company to |
| | | charge fees for enhanced |
| | | functionality. In this case, |
| | | that means media storage |
| | | space. |
| OrganizationName | Derive | The name of the Organization. |
| | | This is derived from |
| | | UnitName. |
| AccountID | | The Account that holds |
| | | the funds for this |
| | | Organization. |

D. Group Hierarchy

The Group Hierarchy stores all information about Groups in the system. Groups typically are business entities that form containers for other Units. Their features primarily come from the common Unit features.

Group stores information that applies to an entire Group Unit.

Scope: public|Instance: single|Parent: Unit

| FIELD | GROUP | DESCRIPTION |
|---|---|---|
| GroupID | Derive | The unique identifier of |
| | | the Group. This is derived |
| | | from UnitID. |
| GroupName | Derive | The name of the Group. |
| | | This is derived from |
| | | UnitName. |
| OrganizationID | Compute | The Organization that |
| | | this Group belongs to. |

E. Project Hierarchy

The Project Hierarchy stores all information about Projects in the system. Projects are entities that have many common Unit features and many Project-only features. Projects are the entity around which the Donor system is based.

1. Project

Scope: public|Instance: single|Parent: Unit

| FIELD | GROUP | DESCRIPTION |
|---|---|---|
| ProjectID | Basic | The unique identifier of the Project. This |
| | | is derived from UnitID. |
| IsPublic | Basic | Whether this Project is visible to Donors. |
| | | The software should restrict this field |
| | | becoming true until sufficient criteria |
| | | are met to allow the Donors to have a |
| | | positive experience. |
| Description | Basic | A concise description of the Project. |
| StartDate | Timeline | The starting date of the Project. |
| EndDate | Timeline | The ending date of the Project. If the |
| | | Project has no ending date, the value |
| | | is set to a system-defined end of time. |
| MatchPercent | | The percentage of Donations that is |
| | | matched by a third party. If zero, |
| | | no matching occurs. |
| CategoryID | Search | The Donor Search Category that this |
| | | Project is mapped to. |
| MediaUpdate | Update | The last date the Project's Media |
| | | was updated. |
| FinancialUpdate | Update | The last date the Project's Financials |
| | | were updated. |
| MetricUpdate | Update | The last date the Project's Metrics |
| | | were updated. |
| JournalUpdate | Update | The last date the Project's Journal |
| | | was updated. |
| InitialAmount | Financial | The Initial Capital in the Project. |
| FundingAmount | Financial | The Funding Capital the Project has |
| | | received from outside sources. |
| DonationAmount | Financial | The Donations the Project has received |
| | | from the system. |
| ExpensesAmount | Financial | The Expenses the Project has. |
| BudgetAmount | Financial | The Budget the Project is requesting. |
| BalanceAmount | Compute | The current Balance of the Projects |
| | | funds. Equal to InitialAmount + |
| | | FundingAmount + DonationAmount − |
| | | ExpensesAmount. |
| NeededAmount | Compute | The amount Needed by the Project to |
| | | Complete its budget. Equal to |
| | | BudgetAmount − InitialAmount − |
| | | FundingAmount − DonationAmount. |
| ProjectName | Derive | The name of the Project. This is derived |
| | | from UnitName. |
| OrganizationID | Compute | The Organization to which this |
| | | Group belongs |

2. ProjectFinanceLog

The Finance Log tracks changes to any of the financial values by recording the values at the time of modification along with the User that performed the change. In this way, a simple “Changed From ### on Date” list can be produced. To produce a “Changed to ### on Date” list, additional processing would be required.

Scope: private|Instance: multiple|Parent: Project

| FIELD | GROUP | DESCRIPTION |
|---|---|---|
| ProjectID | Basic | The identifier inherited from |
| | | Project. |
| LogIndex | Basic | The unique identifier of the |
| | | Log entry. |
| CreationDate | Basic | The date of the Log entry. |
| UserID | Basic | The User performing the |
| | | modification. |
| InitialAmount | Basic | The value recorded just before |
| | | the modification. |
| FundingAmount | Basic | The value recorded just before |
| | | the modification. |
| DonationAmount | Basic | The value recorded just before |
| | | the modification. |
| ExpensesAmount | Basic | The value recorded just before |
| | | the modification. |
| BudgetAmount | Basic | The value recorded just before |
| | | the modification. |

3. ProjectJournal

The Journal provides a way for Projects to record a narrative. The narrative has a creator/editor who owns the Journal Entry. It is conceptually similar to a web-log.

Scope: public|Instance: multiple|Parent: Project

| FIELD | GROUP | DESCRIPTION |
|---|---|---|
| ProjectID | Basic | The identifier inherited from Project. |
| JournalIndex | Basic | The unique identifier of the Journal Entry. |
| Title | Basic | The title of the Journal Entry. |
| Description | Basic | The Journal Entry. |
| LastUpdate | Basic | The date of the last change to the Journal Entry. |
| CreateDate | Basic | The date of creation of the Journal Entry. |
| PublishDate | Basic | The date of publication of the Journal Entry. By |
| | | allowing the user to re-publish a Journal, it |
| | | becomes possible to sort Journal entries on this |
| | | value and create an ability to promote a Journal |
| | | Entry to the top of the list. |
| IsPublic | Policy | Whether this Journal Entry is visible to Donors. |
| UserID | Basic | The User who owns this Journal Entry. |

4. ProjectMedia

Project Media provides a way for Projects to have Media (images, documents) to describe the Projects in a way that other means cannot convey. This object tracks those items of Media. Currently, this table records both the Media item itself and the Project's descriptors and relation to the Media. This will be changing shortly, as Media will be applicable to all Units.

Scope: public|Instance: multiple|Parent: Project

| FIELD | GROUP | DESCRIPTION |
|---|---|---|
| ProjectID | Basic | The identifier inherited from Project. |
| MediaID | Basic | The unique identifier of the Media. |
| Extension | Media | The file extension of the original, native media |
| | | file. This is used to determine the type of Media. |
| FileName | Media | The original filename of the media file. This is |
| | | not currently used, but it retained in case the |
| | | system wants to make the original filename |
| | | available to users of the system. |
| Title | Basic | The Project's title for the Media item. This is |
| | | effectively used at the name of the Media in |
| | | most parts of the system. |
| Caption | Basic | The caption for the Media. This allows the User |
| | | to provide a more descriptive account of what |
| | | the Media means or represents. |
| CreationDate | Basic | The creation date of the Media. |
| IsPublic | Policy | Whether the Media is visible to Donors. |
| IsPresent | Media | Whether the media file virtually exists. |
| | | Existence of the record means that the media |
| | | file physically exists. This is used currently |
| | | as a kind of removed but not deleted flag, |
| | | since server locks prevent the immediate |
| | | deletion of media files when the User removes |
| | | the Media from the system. |
| Size | Media | The size of the original, native media |
| | | file, in bytes. |

5. ProjectTimeline

The Project Timeline creates a simple time tracking and planning structure. It records Tasks, which can be laid out into a simple Gantt chart or used to set internal milestones for a Project. It is not consumed by any other system and can be part of further planning and time tracking features.

Scope: private|Instance: multiple|Parent: Project

| FIELD | GROUP | DESCRIPTION |
|---|---|---|
| ProjectID | Basic | The identifier inherited from Project. |
| TaskIndex | Basic | The unique identifier of the Task. |
| Description | Basic | The name of the Task. |
| StartDate | Timeline | The starting date of the Task. |
| EndDate | Timeline | The ending date of the Task. |
| CompletePercent | Timeline | The percent of the task that is currently |
| | | complete. This allows a range to be |
| | | filled between the StartDate and EndDate, |
| | | producing a limited charting capability. |

F. Account Hierarchy

The Account Hierarchy tracks the accounting information for the system. This includes a complete Transaction structure to keep track of money going into and out of the system as well as an Accounts system that associates each of these Transactions with a particular Account. The particular Account can be tied to a User, a Unit, or another object. Much of the information is statically (non-relationally denormalized) stored since many of these details cannot be changed over time to maintain the integrity of the Transaction's information.

1. Account

Account tracks the fundamental and summary numbers for an Account, which can provide a virtual bank account. Each entity that allocates a share of a trust account, company account, etc., receives an Account. Therefore, each Donor, each Organization, etc., receives an Account. The values of an Account, such as the current balance, are the sum of all Transactions against the Account. The sum of all Account balances should be the balance of the underlying account itself.

Scope: private|Instance: multiple|Parent: Root

| FIELD | GROUP | DESCRIPTION |
|---|---|---|
| AccountID | Basic | The unique identifier of the Account. |
| BalanceAmount | Compute | The balance of the Account. This is |
| | | the sum of all debits and credits to |
| | | the Account. |
| PendingAmount | Compute | The total pending (non-finalized) |
| | | Asset Transactions. |
| FundAmount | Compute | The total finalized Fund Transactions. |
| CurrentFundAmount | Compute | The total finalized Fund Transactions |
| | | for the current year. |
| GoalAmount | Basic | The User-supplied funding goal. |
| RemainAmount | Compute | The remaining funding goal for the |
| | | current year. Computed as |
| | | GoalAmount − CurrentFundAmount. |

2. AccountTransaction

Transactions track atomic modifications to Accounts (and the underlying (bank, trust, etc) accounts)). They are the fundamental unit of financial accounting, auditing, and processing. As a result, they store many values statically (denormalized), so that they cannot change over time as their related data changes.

Transactions are either finalized or non-finalized. Typically, a finalized Transaction is not modified unless the system is in error in original finalization. Long-term computations may use finalization state as a guarantee of immutability, so violation may present complications in the future.

Transactions generally start in an initial state and proceed to one of two finalization states: Approved or Declined. Approved Transactions finalized successfully and contribute to balances and computations. Declined Transactions either finalized unsuccessfully or were declined due to business rules (insufficient funds, etc) and do not contribute to totals or computations. They are recorded to provide a complete, auditable, immutable record of all attempted financial modifications to the system. Generally, each transaction may be preserved.

The Transaction object may be subordinate to the Account object. Each Transaction has an Account, so the sum of all Accounts reflects the underlying account's balance and state. The sum of all Transactions reflects the underlying account's balance and state in kind. This can provide atomic integrity in the Transactions and an efficient summarization capacity in the Accounts.

Scope: protected|Instance: multiple|Parent: Account

| FIELD | GROUP | DESCRIPTION |
|---|---|---|
| TransactionID | Basic | The unique identifier of the Transaction. |
| TransactionType | Basic | The type of Transaction. Allowed values are: Asset, Fund, Income, and Disburse. |
| TransactionStatus | Basic | The status of the Transaction. Allowed values are: Approved, Declined, Waiting, |
| | | Clearing, Initializing, Pending, and Batching. Approved and Declined are |
| | | finalize states, all others are non-finalized. |
| OriginalAmount | Basic | The original amount of the Transaction. This is either input by the user or system- |
| | | generated. |
| FeeAmount | Basic | If a fee is applicable, it is recorded here. As fee schedules may change, this is |
| | | stored statically. |
| BalanceAmount | Basic | This is the amount that the Transaction contributes to balance totals. This is the |
| | | effective Amount of the Transaction. Generally, this will not attain a non-zero |
| | | value until the Transaction reaches the Approved state. |
| CreateDate | Basic | The date of creation. |
| ModifyDate | Basic | The date of last modification. |
| AvailableDate | Policy | The date at which the funds in the Transaction become valid for use. |
| UserID, FirstName, | Personal | When applicable, the User, and a static copy of the User's Names. This is |
| LastName | | typically the User that initiated the Transaction. |
| ProfileID, CompleteName | Personal | For Transactions that occur in a User Profile context, the Profile of the User |
| | | and a static copy of the CompleteName. This can be used to extract appropriate |
| | | contact information at a later time and provides a copy of the formal, Profile- |
| | | protected name for display. |
| Reason | Basic | The reason a Transaction reached its finalization state. This is currently used to |
| | | provide a descriptive reason for the declination of a Transaction. |
| ProjectID, ProjectName | Unit | When applicable, the related Project and a static copy of its information. This may |
| | | be updated to Unit in the future, as it may be possible to fund Organizations and |
| | | other Units directly. |
| OrganizationID, | Unit | When applicable, the related Organization and a static copy of its information. |
| OrganizationName | | |
| AssetID, AssetType, | Asset | When applicable, the related Asset and a static copy of its information. |
| AssetName, | | |
| AccountNumber, | | |
| RoutingNumber, | | |
| DocumentNumber, | | |
| ExpirationDate, CardType, | | |
| CardVerify | | |
| ApprovalCode | Asset | When using a payment authorizer, the approval code provider by the authorizer |
| | | to allow the Transaction. |
| IsAnonymous | Policy | Whether the User designated this Transaction as anonymous. Minimal |
| | | relational and no static User information should be recorded for these Transactions, |
| | | so the User can be reasonably assured that their anonymity can be guaranteed by the |
| | | system. Note that storing the UserID is still performed in this case, to provide |
| | | integrity for the Company's data. If the User wished to be truly anonymous to the |
| | | Company, they could provide anonymous information for their User information. |
| | | Otherwise, the Company could not contact the User in the course of |
| | | processing a Transaction or in resolving problems with it and aggregate reporting |
| | | would suffer from non-relatable data. |
| AccountID | Basic | The identifier inherited from Account. This is the Account to which this |
| | | Transaction's information contributes. |
| ParentID | Basic | When creating aggregation Transactions like the Disburse Transactions that |
| | | contain constituent Transactions, those constituent Transactions will record the |
| | | aggregation Transaction here. This is to support a very limited form of grouping. |
| | | Any additional grouping capability should be very carefully considered as it may |
| | | create dependencies on finalization, totaling, atomicity, etc. |

G. Metrics Hierarchy

The Metrics Hierarchy tracks numeric indicators for Organizations to gauge and measure their progress in a quantifiable way. Metrics are arbitrarily definable and derivable to any degree. They also have time periods that can be used to group and track the metrics over time periods meaningful to the Organization. For each Metric, a goal or target value is supported as well as a means of recording the actual amount of the metric that was attained.

1. Metric

Metric stores the fundamental information about each Metric. Metrics are derived from a defining Unit (as opposed to an assigning Unit—discussed in MetricGoal). Subordinate Units can also see the defined Metric of a Unit.

Scope: protected|Instance: multiple|Parent: Unit

| FIELD | GROUP | DESCRIPTION |
|---|---|---|
| MetricID | Basic | The unique identifier of the Metric. |
| UnitID | Basic | The identifier inherited from Unit. |
| Description | Basic | The name of the Metric. |
| ParentID | Basic | The parent Metric of this Metric. This is used to |
| | | create another, orthogonal hierarchy for Metrics |
| | | adjacent to the primary Unit hierarchy. |

2. MetricAncestor

MetricAncestor is a computed structure that allows hierarchy walks to be performed using database joins or other relational faculties without resorting to temporary tables, cursors, etc. It is not referenced outside of the data store and is not directly available for application use.

Scope: hidden|Instance: multiple|Parent: Metric

| FIELD | GROUP | DESCRIPTION |
|---|---|---|
| MetricID | Basic | The identifier inherited from Metric. |
| AncestorID | Compute | The identifier of the ancestor object. One |
| | | ancestor value is recorded for each ances- |
| | | tor of this object, including the object |
| | | itself, all the way up to the root object. |
| Distance | Compute | The distance from this object the ancestor |
| | | is. These values are negative, as they |
| | | proceed up the hierarchy. |
| Depth | Compute | The absolute depth from the root this |
| | | ancestor is. The root itself has a depth |
| | | of zero and subordinate layers have |
| | | increasing positive integers from there. |

3. MetricPeriod

A Metric is internally divided into a number of user-defined Periods. There are two types of Periods: Periods and Milestones. Though functionally the same, Milestones subdivide a Period. Periods provide a structure for assigning goals and grouping reporting.

Scope: private|Instance: multiple|Parent: Metric

| FIELD | GROUP | DESCRIPTION |
|---|---|---|
| MetricID | Basic | The identifier inherited from Metric. |
| PeriodID | Basic | The unique identifier of this Period. |
| Description | Basic | The name of this Period. |
| StartDate | Compute | The starting date of the Period. For |
| | | Periods, this is specified by the user. |
| | | For milestones, this is computed to |
| | | correspond to the next date following |
| | | the EndDate of the previous Milestone or |
| | | the StartDate of the containing Period. |
| EndDate | Basic | The ending date of the Period. This is |
| | | user defined. In the case of a milestone, |
| | | this must fall within the date range of |
| | | a Period - referred to as the containing |
| | | Period. |
| IsPeriod | Basic | This designates the Period as an actual |
| | | Period or a Milestone. Though this could |
| | | be computed, it is computationally |
| | | desirable to specify it explicitly. |

4. MetricGoals

MetricGoals track per-Unit goals for a Metric in a given Period. This allows the system to compute success for the Unit's metrics actuals based on these goals.

Scope: private|Instance: multiple|Parent: MetricPeriod

| FIELD | GROUP | DESCRIPTION |
|---|---|---|
| MetricID | Basic | The identifier inherited from MetricPeriod. |
| PeriodID | Basic | The identifier inherited from MetricPeriod. |
| UnitID | Basic | The Unit for which a goal is assigned. |
| GoalAmount | Basic | The amount of the goal. |

5. MetricActual

MetricActuals are the actual value of the Metric attained by a Unit during a Period. Because the Period can be inferred from the Date of the Actual, no relation is made between the Actual and the Period. Instead, the relation is recorded simply as the actual date and related later based on enclosed range.

Scope: private|Instance: multiple|Parent: Metric

| FIELD | GROUP | DESCRIPTION |
|---|---|---|
| MetricID | Basic | The identifier inherited from Metric. |
| UnitID | Basic | The identifier inherited from Metric. |
| Date | Basic | The date this Actual is recorded for. |
| Amount | Basic | The amount of the actual. This is a delta value. |
| UserID | Basic | The User recording the Actual. |

H. Category Hierarchy

The Category Hierarchy tracks orthogonal means of classification for Units other than the primary Unit Hierarchy. The Category Hierarchy allows each Project to designate itself part of a particular Donor Search Category. In turn, this allows grouping the Projects also with the Donor Search Category Hierarchy. This system can be extended to support other mutually-orthogonal hierarchies for searching, sorting, updating, reporting, etc. either at a system-wide level (like the Donor Search Category) or at an Organization or even Unit specific level.

1. Category

Scope: public|Instance: typed|Parent: Root

| FIELD | GROUP | DESCRIPTION |
|---|---|---|
| CategoryID | Basic | The unique identifier of the Category. |
| Description | Basic | The name of the Category. |
| ParentID | Basic | The parent Category of the Category in |
| | | the Category Hierarchy. |
| ProjectCount | Compute | The number of Projects assigned to the |
| | | Category and subordinate Categories. |
| InProjectCount | Compute | The number of Projects assigned to the |
| | | Category. |
| SubProjectCount | Compute | The number of Projects assigned to |
| | | subordinate Categories. |

2. CategoryAncestor

CategoryAncestor is a computed structure that allows hierarchy walks to be performed using database joins or other relational faculties without resorting to temporary tables, cursors, etc. It is not referenced outside of the data store and is not directly available for application use.

Scope: hidden|Instance: multiple|Parent: Category

| FIELD | GROUP | DESCRIPTION |
|---|---|---|
| CategoryID | Basic | The identifier inherited from |
| | | Category. |
| AncestorID | Compute | The identifier of the ancestor |
| | | object. One ancestor value is |
| | | recorded for each ancestor of |
| | | this object, including the |
| | | object itself, all the way up |
| | | to the root object. |
| Distance | Compute | The distance from this object |
| | | the ancestor is. These values |
| | | are negative, as they proceed |
| | | up the hierarchy. |
| Depth | Compute | The absolute depth from the |
| | | root this ancestor is. The root |
| | | itself has a depth of zero |
| | | and subordinate layers have |
| | | increasing positive integers |
| | | from there. |

I. Company Hierarchy

The Company Hierarchy tracks values that apply at a Company level outside the bounds of a particular Unit, User, etc. These values are generally global constants that require a backing store or values that are recorded by the system to reflect its global state in some manner.

Country stores a list of allowed countries in the system for use in addresses, reporting criteria, etc. It also contains helper expressions for use in validating/processing data that have country-specific formats.

Scope: public|Instance: typed|Parent: Root

| FIELD | GROUP | DESCRIPTION |
|---|---|---|
| CountryID | Basic | The unique identifier |
| | | of the Country. |
| Description | Basic | The English name of the |
| | | Country. |
| ISOCode | Standard | The two-letter ISO Code of |
| | | the Country from ISO3166. |
| PostalRegEx | Format | A regular expression that |
| | | validates a correct Postal |
| | | Code. |
| PostalHint | Format | A format hint to show the |
| | | user expected input for a |
| | | correct Postal Code. |
| PhoneRegEx | Format | A regular expression that |
| | | validates a correct Phone |
| | | Number. |
| PhoneHint | Format | A format hint to show the |
| | | user expected input for a |
| | | correct Phone Number. |

VI. Navis Functional Specification

The following functional specification for the Navis system includes a description of each Navis feature and its behavior and business logic. Organization, project, and user content shown in the referenced Figures is exemplary. References in this section VI to a “page” may include less than an entire page provided by, for example, a browser application.

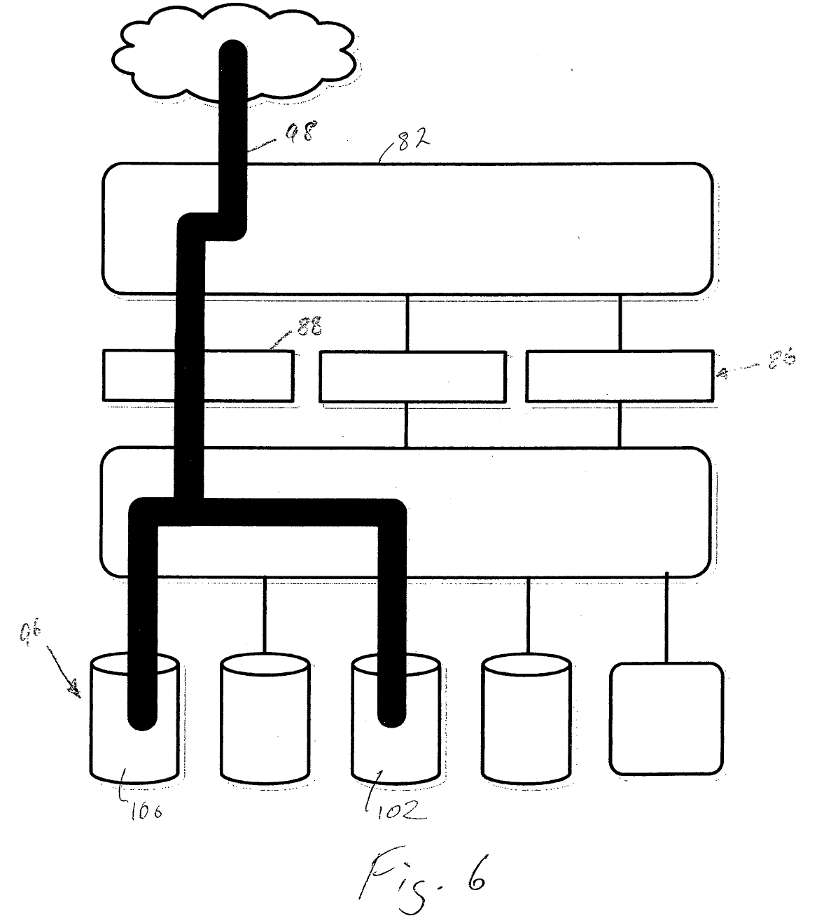

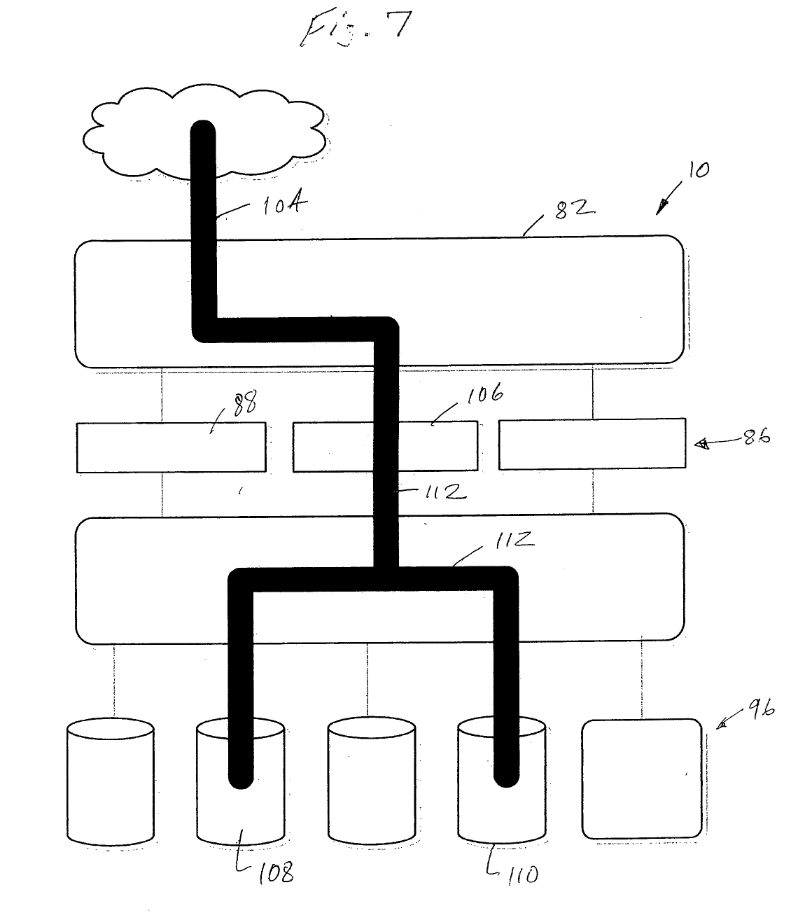

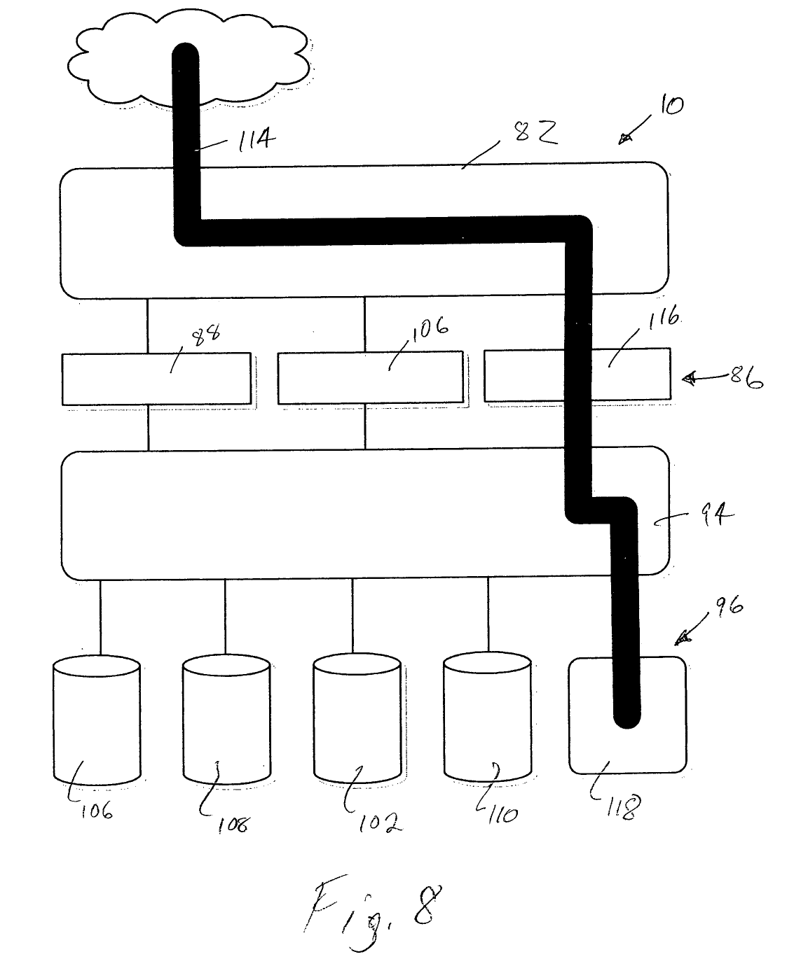

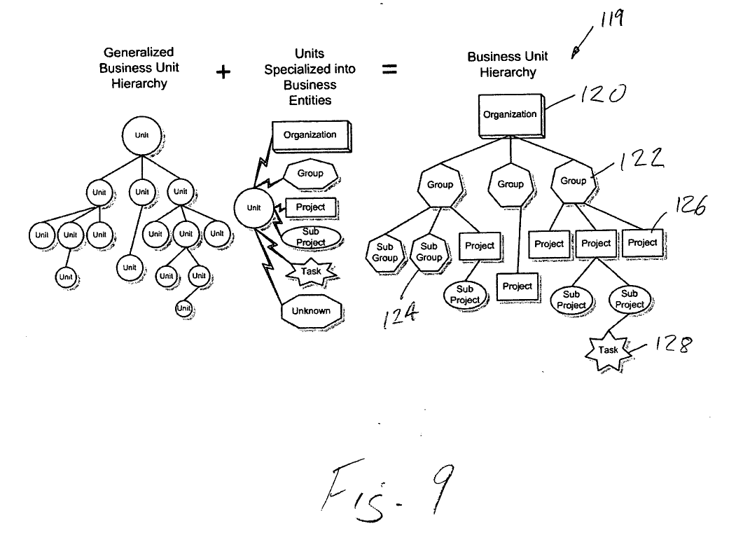

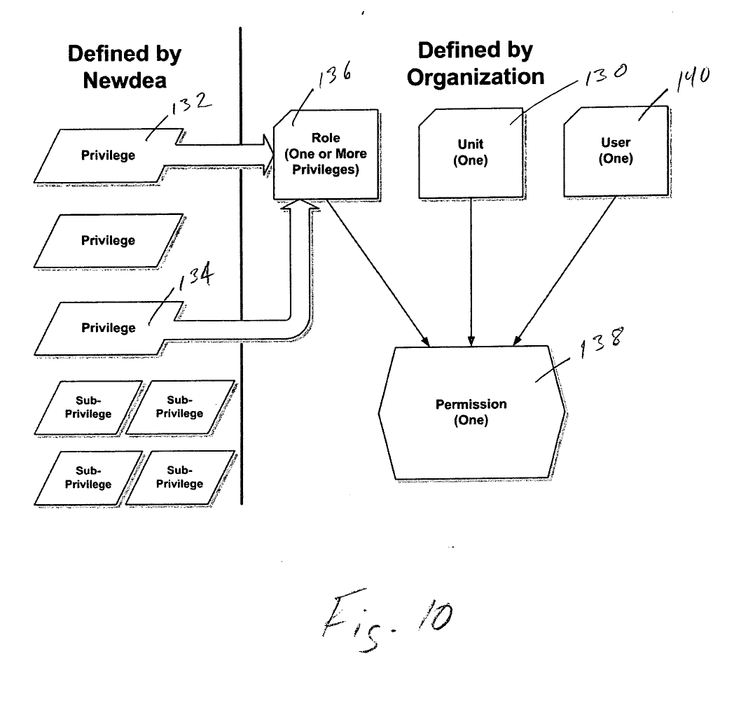

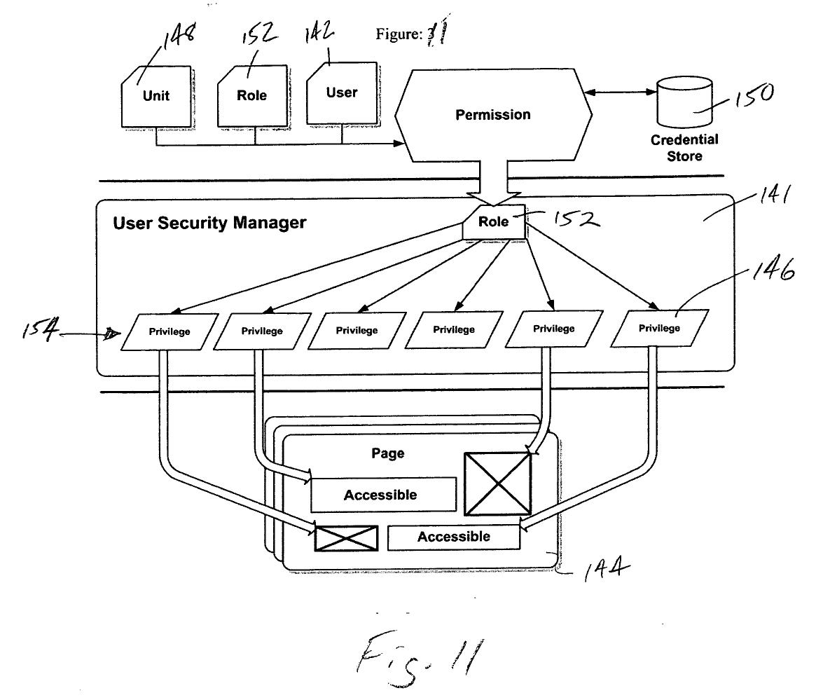

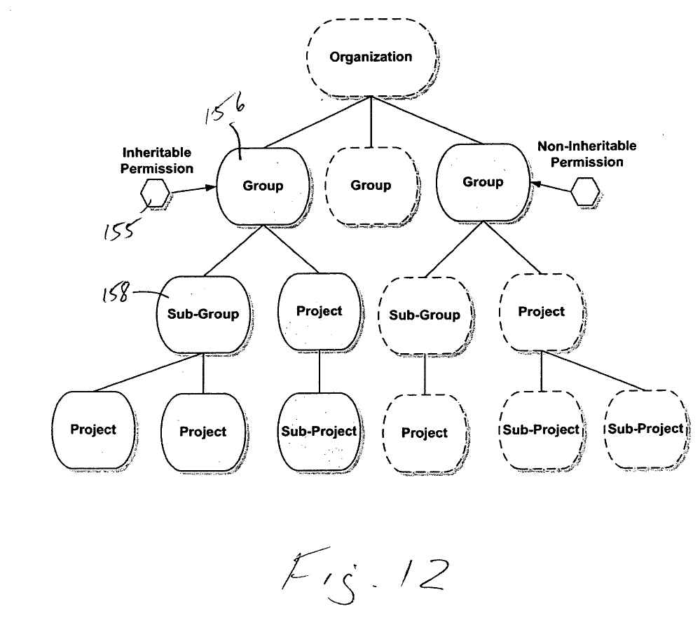

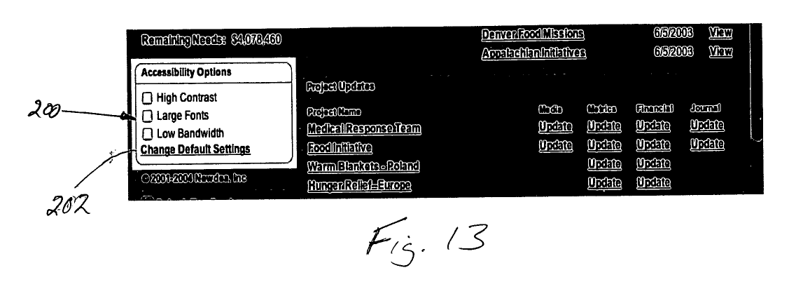

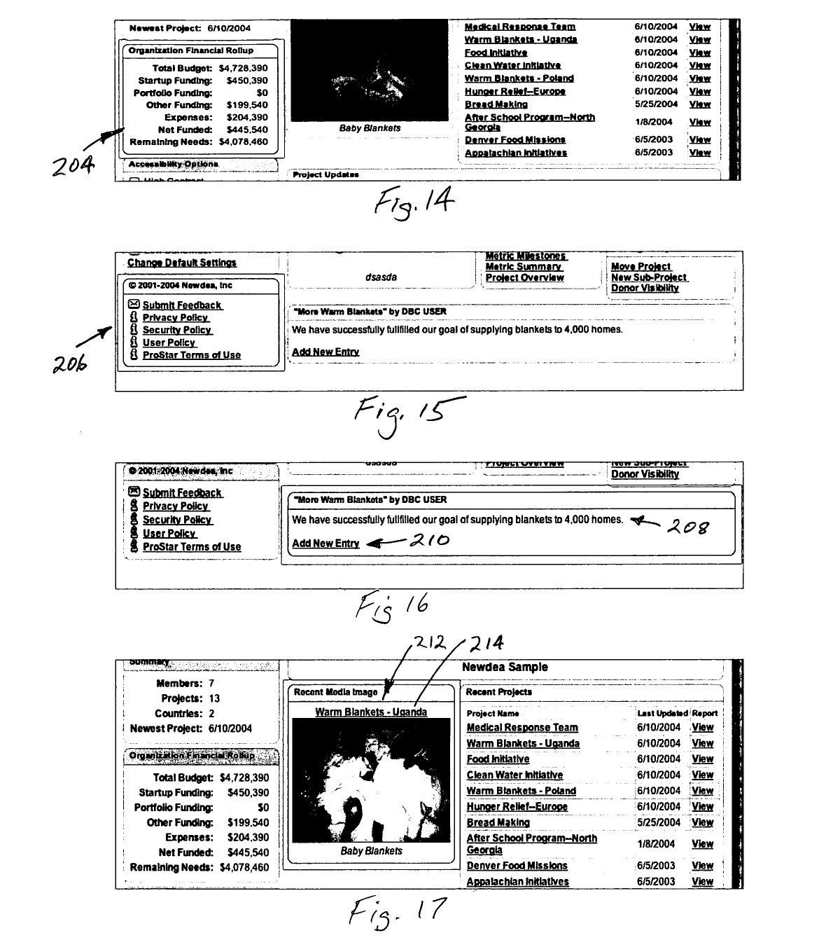

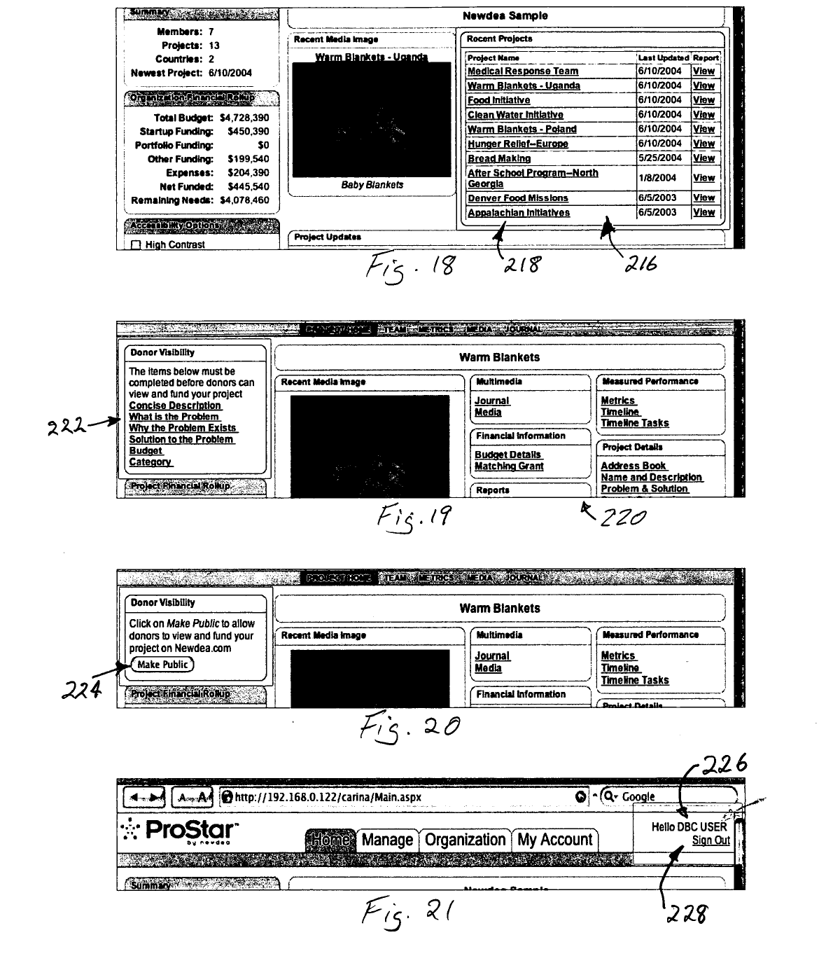

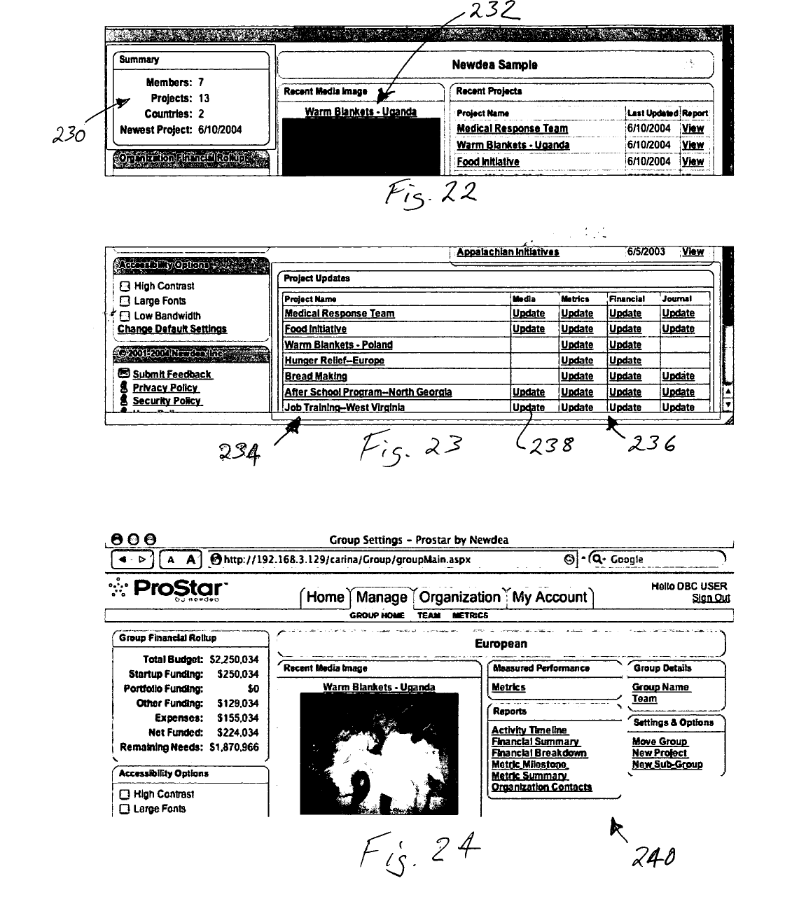

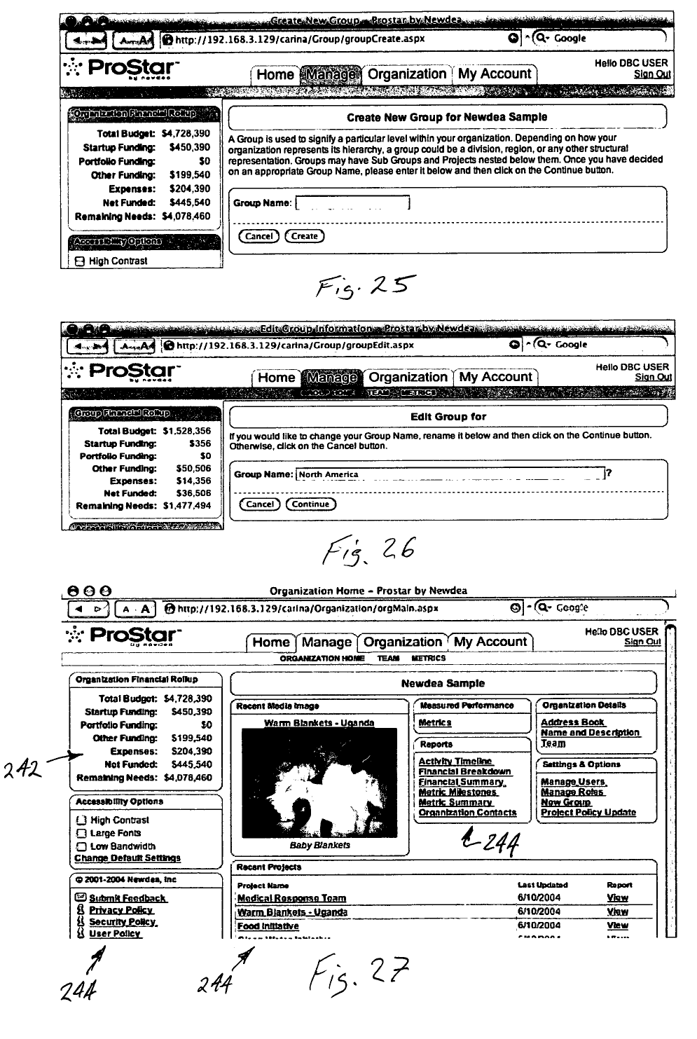

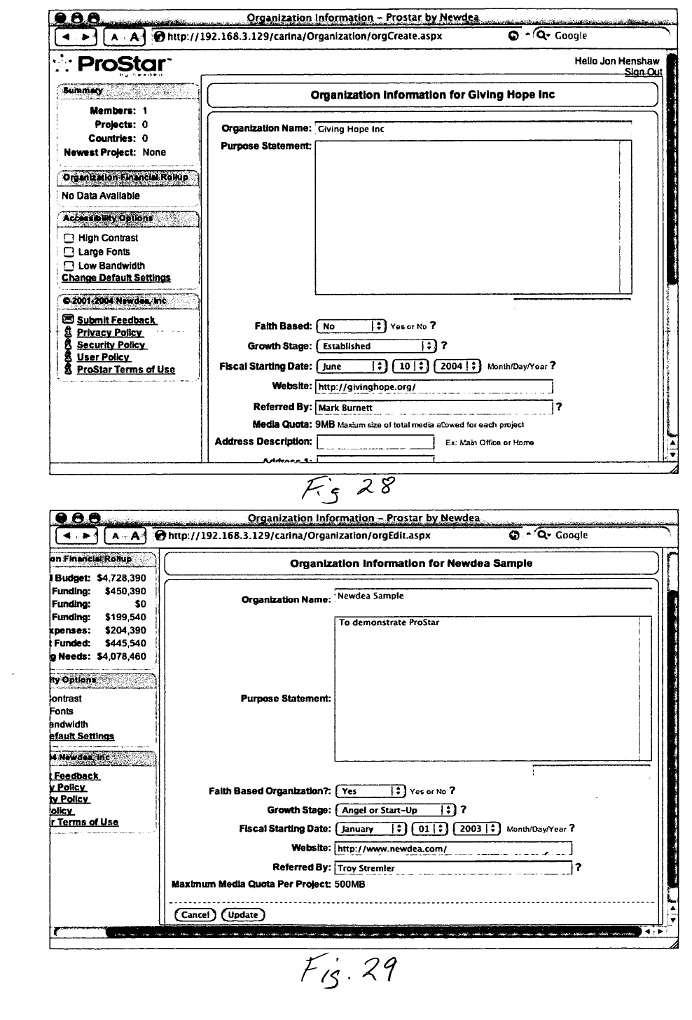

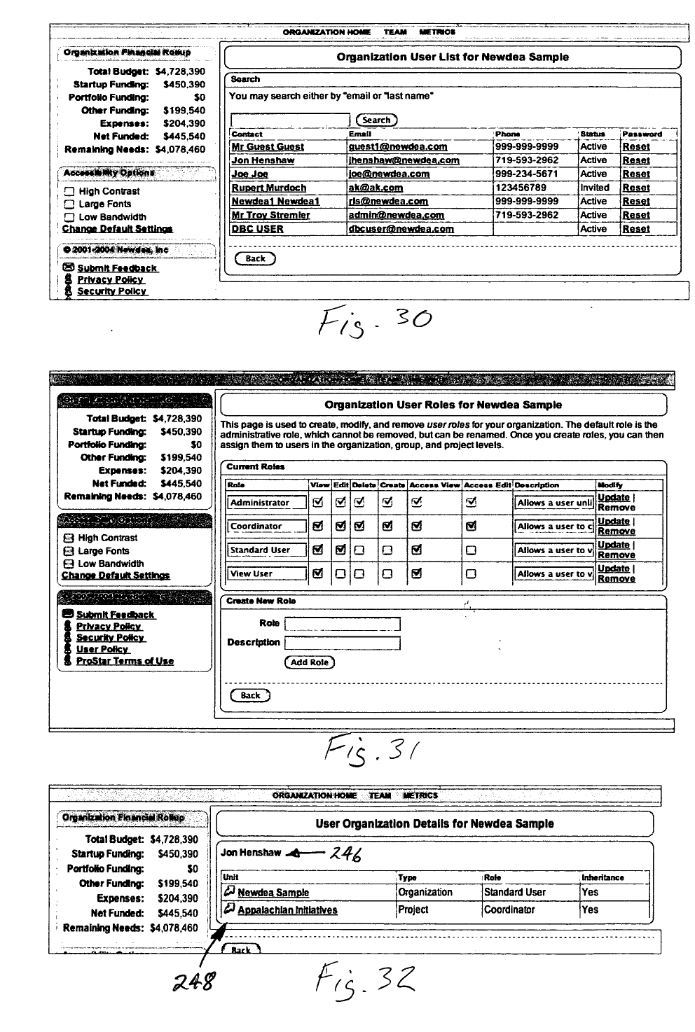

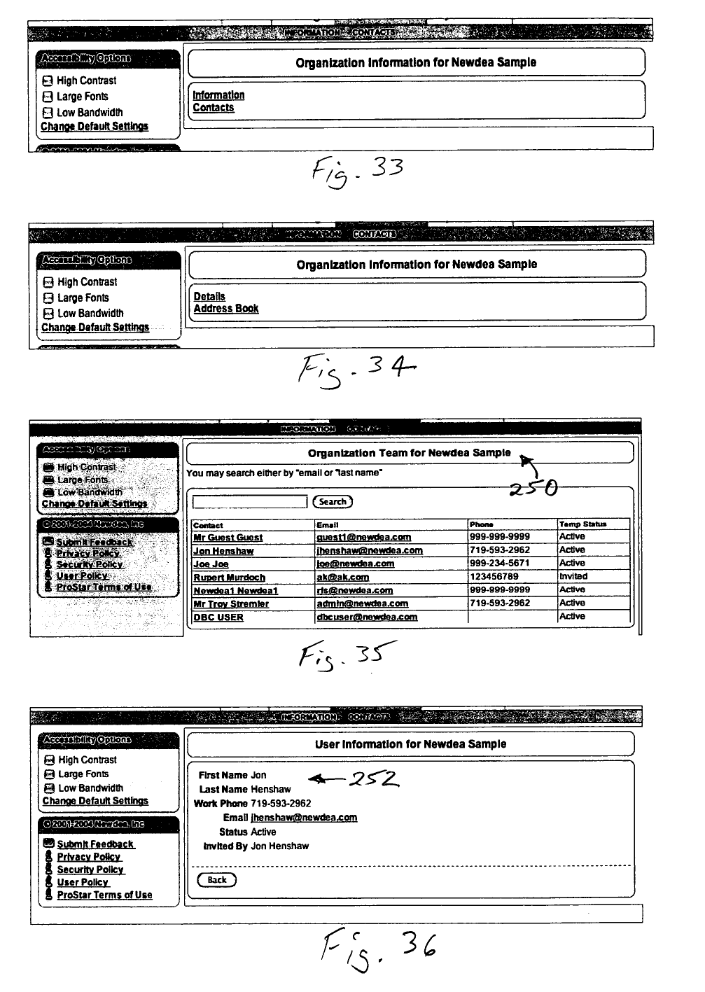

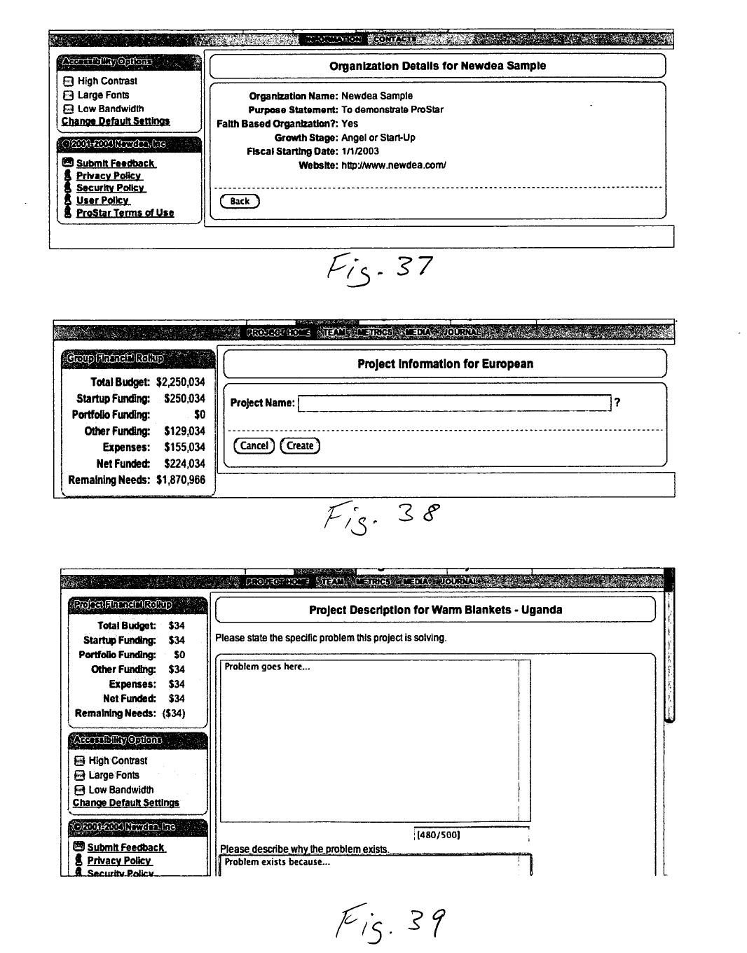

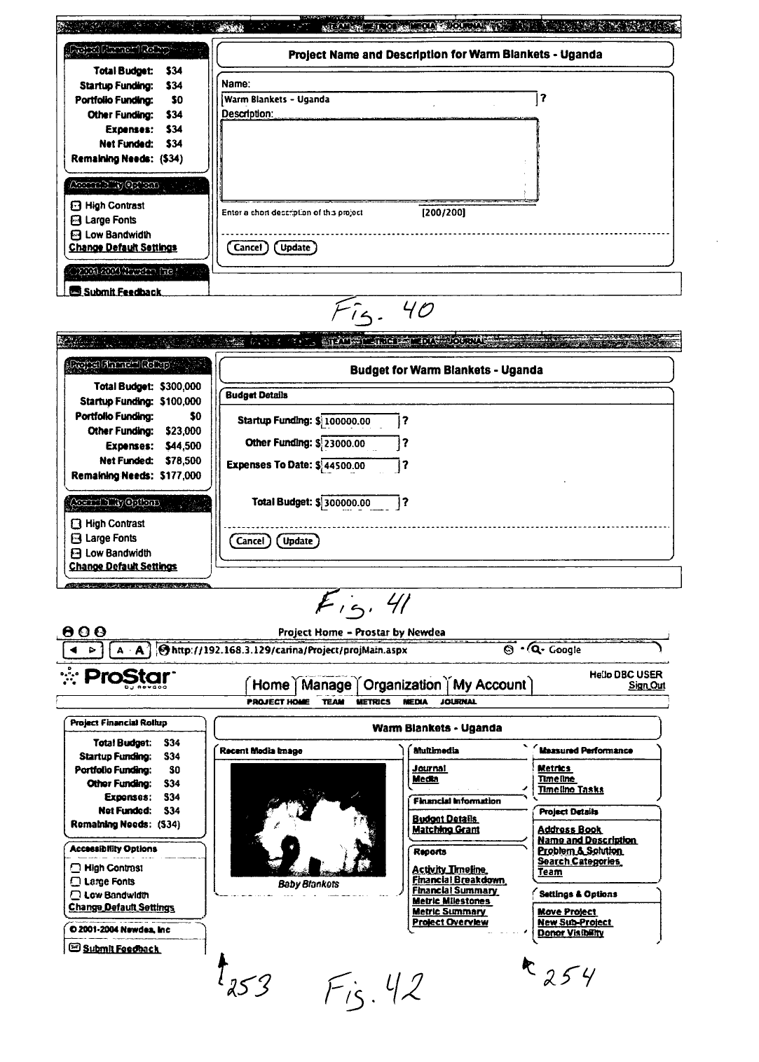

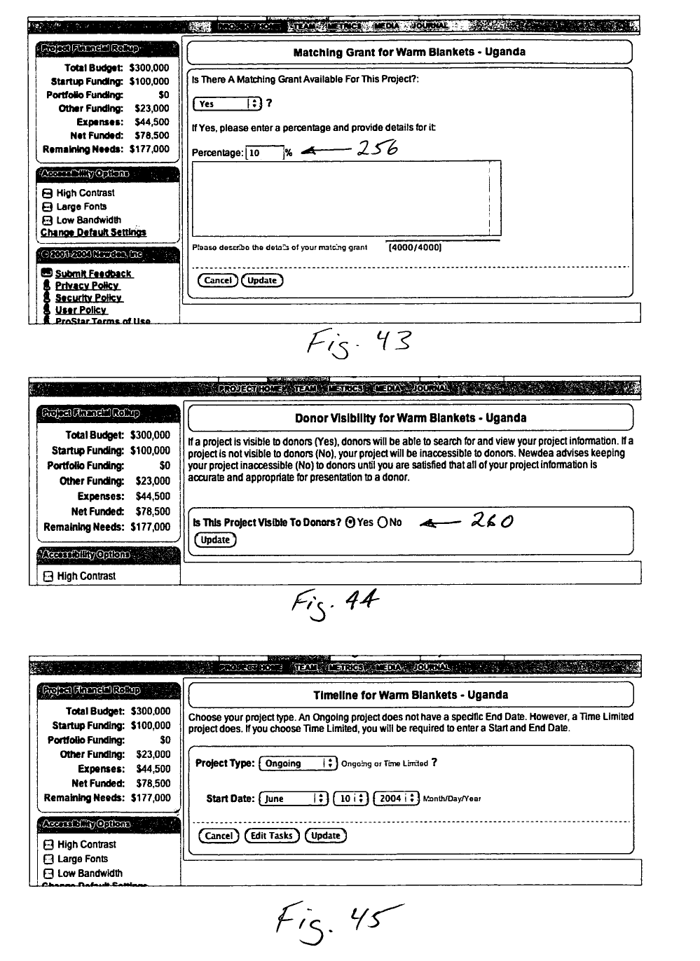

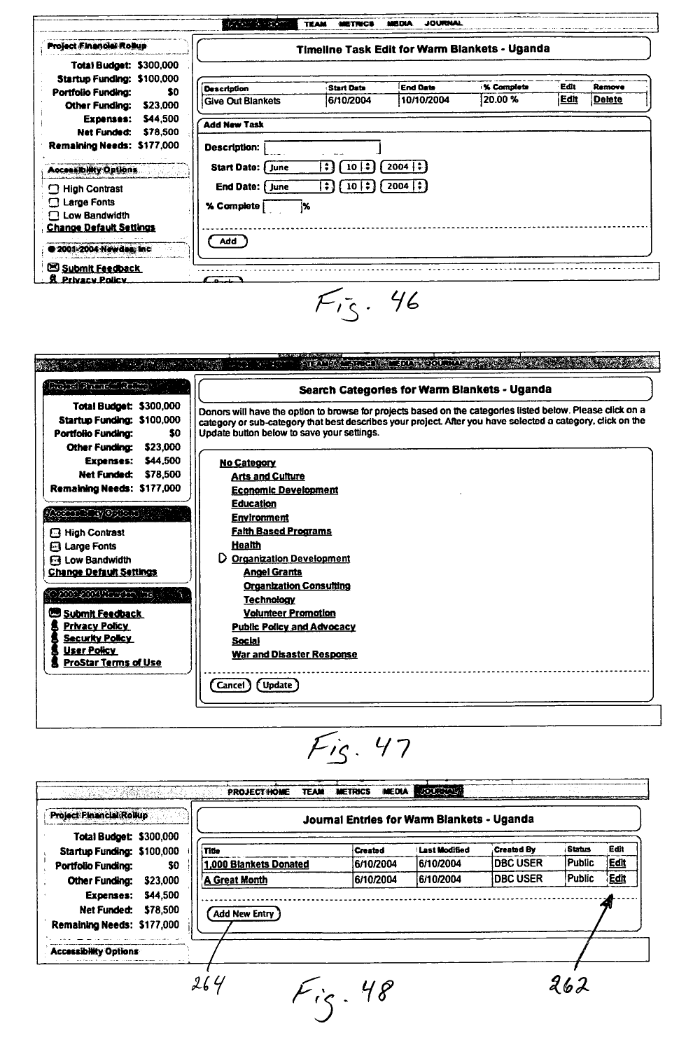

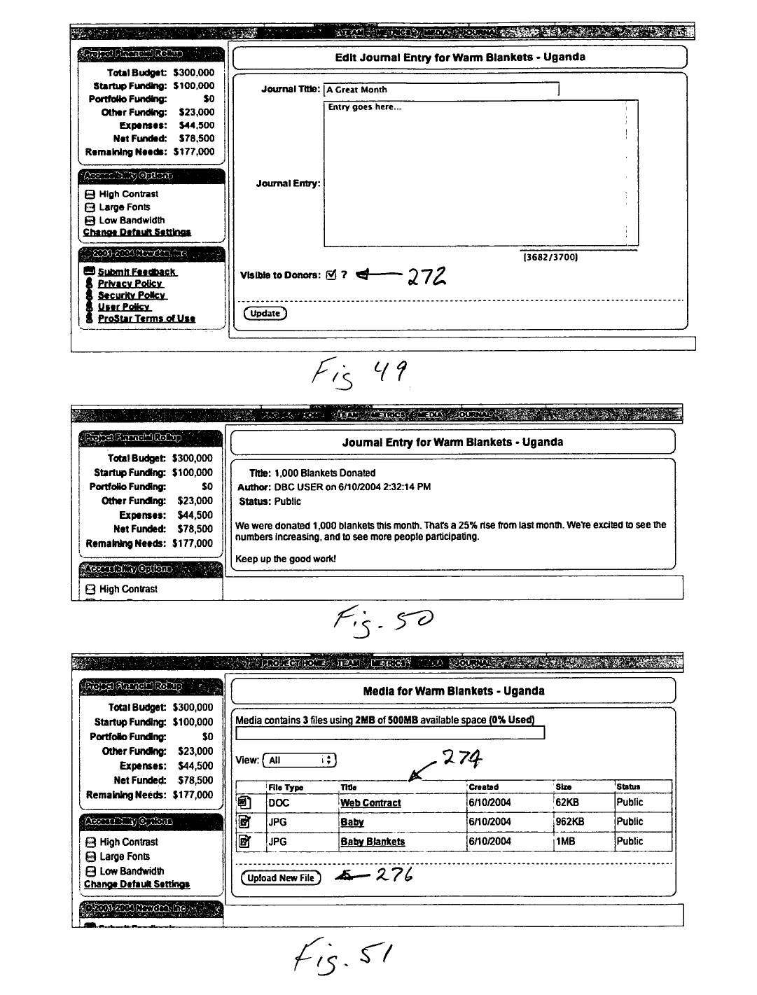

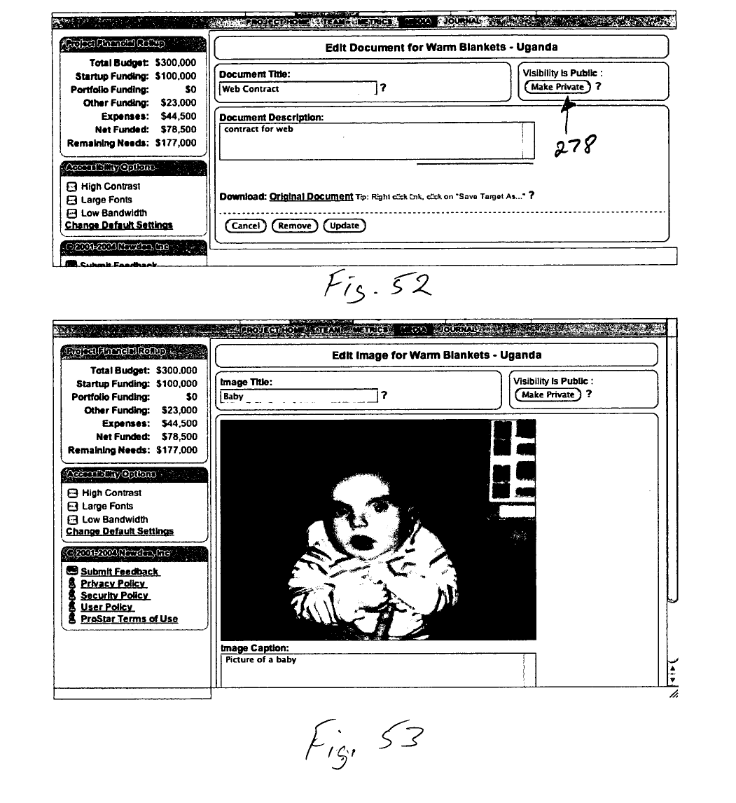

A. ORGANIZATION/PROSTAR/CARINA: The following specification provides an organization management application.
1. Main Dispatch (/main): A starting point in the application that presents a unique view each user for their organization, and an interface to direct the user to the various features. The page is modularized.
2. Menu (/menu): A feature that displays a menu on every page and allows the user to navigate to the main features.
3. Modules (/module): Provides modules to be used in the application pages to present the user with detailed and specific information for various subjects. Create a container to house these modules.
a. Information Module (/module/Information): Provides a module to be the container for the other modules.
b. Accessibility Module (/module/accessibility): With reference to FIG. 13, provides a module for the user to edit the accessibility options 200 for their session and a link 202 to change the default accessibility options for their account.
c. Financial Module (/module/financial): With reference to FIG. 14, provides a module to show the user the following statistics 204 about the finances of the current unit: total budget; startup funding; donation amount; other funding; expenses amount; balance amount; and remaining needs.
d. Footer Module (/module/footer): With reference to FIG. 15, provides a module populated by links 206 to the policy pages and the feedback page.
e. Journal Module (/module/journal): With reference to FIG. 16, provides a module that shows the beginning of a project's most recently updated journal entry 208, with a link to view that entry or create a new entry 210.
f. Media Module (/module/media): With reference to FIG. 17, provides a module that shows the most recently updated visual media item 212 for a user's projects, and a link 214 to view that media item.
g. Project Module (/module/project): With reference to FIG. 18, provides a module to show a list of the most recently updated projects for a user's organization, the time they were last updated, and a link, e.g., 218, to view a report for each particular project.
h. Public Module (/module/public): With reference to FIGS. 19 and 20, provides a module that checks the current project to see if it has completed the steps to allow the project to go public. If the steps are not complete, this module lists the steps 222. If they are and the project is not public, this module provides a link to make the project public 224 as shown in FIG. 20. The steps 222 to include are: concise description; what is the problem; why the problem exists; solution to the problem; budget; and category.
i. Status Module (/module/status): With reference to FIG. 21, provides a module that shows the name of the user logged in 226, and provides a link 228 for that user to sign out of the system.
j. Summary Module (/module/summary): With reference to FIG. 22, provides a module reporting the total numbers of members, projects, and countries included in the current organization 230, and also the name of the most recent project created 232.
k. modUpdate (/module/update): With reference to FIG. 23, provides a module showing a list 234 of an organization's projects that have not been updated recently, along with an identification 236 of the features that have not been updated recently for each such project. Provides links, e.g., 238, to the project different areas to be updated.
4. Group(/group): Provides capacity to organize the features relevant to a group.
a. Group Main (/group/main): With reference to FIG. 24, provides a display of relevant information for a group within an organization and links 240 to all the features for the group.
b. Group Create (/group/create): With reference to FIG. 25, provides an interface to create a new group.
c. Group Edit (/group/edit): With reference to FIG. 26, provides an interface to edit the name of a group.
5. Help (/help): Provides a display of the results of help queries, provided via a popup with a button to close the popup.
6. Organization (/organization): Provides a repository of views of features relevant to an organization.
a. Organization Main (/organization/main): With reference to FIG. 27, provides a display of relevant information 242 for an organization and links 244 to all the features for organizations.
b. Organization Create(/organization/create): With reference to FIG. 28, provides a feature that allows a user to populate the base information of a created organization.
c. Organization Edit (/organization/edit): With reference to FIG. 29, provides a feature to allow the user to edit information for an organization as follows: organization name; purpose statement; faith based; growth stage; fiscal starting date; website; and referred by.
d. Organization User (/organization/user): Provides a repository of pages to house features associated with users of an organization.
   i. Organization User List (/organization/user/list): With reference to FIG. 30, provides a feature 246 to allow a managing user to review information about users of the organization's information within the system and delete (confirmed), remove access (confirmed), or reset a password (confirmed, emailed, previewed) for a user in their organization.
   ii. Organization User Role Edit (/organization/user/role): With reference to FIG. 31, provides a function for a managing user to edit existing user roles in the organization, create new roles, or remove roles (confirmed).
   iii. Organization User Unit List (/organization/user/unit): With reference to FIG. 32, provides a feature that shows all of the access levels for a given user 246. The user may view the user's unit security level via a link 248, or remove the access (confirmed) for that user.
e. Organization Information (/organization/information): Provides a repository of pages to house different information pertinent to the organization.
   i. Organization Information Main (/organization/information/main): With reference to FIG. 33, provides a selection screen that allows users to proceed to the different main information areas for organizations. The following items are included in the list as links: information; and contacts.
   ii. Organization Information Select (/organization/information/select): With reference to FIG. 34, provides an organization's contacts selection screen to proceed to the user contact information including details and address book.
   iii. Organization Information User (/organization/information/user): Provides a location for pages associated with the users from an organization.
A. Organization Information User List (/organization/information/user/List): With reference to FIG. 35, provides a display that shows information regarding the users, and their contact information, from the current organization 250.
B. Organization Information User View (/organization/information/user/view): With reference to FIG. 36, provides a display of the contact information for a particular organization user 252.
iv. Organization Information View (/organization/information/view): With reference to FIG. 37, provides a page to display summary information about the current organization.
7. Project (/project): Provides a repository of pages to house the features associated with projects.
a. Project Create (/project/create): With reference to FIG. 38, provides a page that allows an organization or sub-entity user to create a project.
b. Project Description Edit (/project/description): With reference to FIG. 39, provides a page that allows the user to edit the following description fields for a project: what is the problem; why the problem exists; solution to the problem (not shown); and strategy and implementation (not shown).
c. Project Edit (/project/edit): With reference to FIG. 40, provides a page that allows the user to enter or edit identification information for a project. This page includes the ability to edit the project name and description.
d. Project Financial Edit (/project/financial): With reference to FIG. 41, provides a page for a user to edit the following financial information for a project: startup funding; other funding; expenses to date; and total budget.
e. Project Main (/project/main): With reference to FIG. 42, provides a display of relevant information 253 for a project and links 254 to all the features for project.
f. Project Match Edit (/project/match): With reference to FIG. 43, provides an interface for the user to enter or edit information regarding matching grant for a project. The user should be able to enter the percentage 256 of the matching grant and pertinent details 258 about it.
g. Project Option Edit (/project/option): With reference to FIG. 44, provides an interface for the user to toggle the project's public/private status 260. This page also prevents a project from being publicly accessible before necessary steps are completed for the project.
h. Project Timeline (/project/timeline): Provides a storage area for pages that deal with project timelines.
i. Project Timeline Edit (/project/timeline/edit): With reference to FIG. 45, provides a page that allows a user to enter or edit information about project timeline such as: project type; start date; and end date.
   ii. Project Timeline Task Edit (/project/timeline/task): With reference to FIG. 46, provides an interface that a user can use to create, delete, and edit timeline tasks. The fields required to create a new timeline task are: description; start date; end date; and % complete.
i. Project Category (/project/category): Provides a capacity to manage category information for projects.
i. Project Category Edit (/project/category/edit): With reference to FIG. 47, provides a page that allows a user to enter or edit the category for the current project.
j. Project Journal (/project/journal): Create a repository for all pages associated with project journals.
   i. Project Journal List (/project/journal/list): With reference to FIG. 48, provides a page displaying the existing journal entries for the current project. This page also provides links 262 to edit each entry and a link 264 to create a new entry. The page also includes the following information in the list for each entry: title; create date; last modified; created by; and status.
   ii. Project Journal Edit (/project/journal/edit): With reference to FIG. 49, provides a page that allows a user to edit an existing journal entry. This page also provides functionality for the user to edit or delete the current journal entry. It also allows the user to promote the currently viewed entry 272. The fields on this page for new/existing entries include: title; entry; and visibility.
   iii. Project Journal View (/project/journal/view): With reference to FIG. 50, provides a page to allow a user to view a journal entry. The following information should be included in the display: title; author; and status.
k. Project Media (/project/media): Provides a capacity to organize the features associated with the media of projects.
   i. Project Media List (/project/media/list): With reference to FIG. 51, provides a feature that shows a managing user the list of all available media for the current project. Also provides the user links to view the media items 274 or create a new media item 276.
   ii. Project Media Document Edit (/project/media/document): With reference to FIG. 52, provides a feature that allows the user to edit a selected document. The user should be able to edit the document title and description and select whether to make document public or private 278.
   iii. Project Media Image Edit (/project/media/image): With reference to FIG. 53, provides a feature allowing the user to edit a selected media. The user should be able to edit the title, caption, and the indication of whether the media is public or private.
   iv. Project Media Upload (/project/media/upload): With reference to FIG. 54, provides a feature that allows a user to upload media for the current project. This page also allows the user to input the following information for this media item: title; caption; and public/private
8. Report (/report): Provides a capacity issue reports.
a. Report Organization Contact (/report/organizationContact): With reference to FIG. 55, provides a page reporting all of the contacts for the current organization. The information to display includes: First Name; Last Name; Email; and Work Phone.
b. Report Project Info (/report/project): With reference to FIG. 56, provides a report displaying information for a project, such as: project name; organization name; concise description; category; media image; media image title; current needs; project budget; startup funding; funding; expenses; donations; last budget update; what problem is this solving?; why does the problem exist?; what is the solution?; and what is the implementation strategy?
c. Report Unit (/report/unit): Provides an area to house unit-based reports for projects.
i. Report Unit Financial (/report/unit/financial): With reference to FIG. 57, provides a report showing an aggregate amount of financial details for all of the units below the current unit and including the current unit. This page displays: project count; total budget; startup funding; funding to date; and expenses to date.
   ii. Report Unit Metric (/report/unit/metric): With reference to FIG. 58, provides a space for pages that report the status of metrics.
A. Report Unit Metric Milestone (/report/unit/metric/milestone): With reference to FIG. 58, provides a report of metrics for the current unit with milestones for each metric and a display of goal and actual information about each metric. The information to be displayed includes: metric name; milestone; date; goal; actual; and amount %.
B. Report Unit Metric Summary (/report/unit/metric/summary): With reference to FIG. 59, also provides a second report of metrics for the current unit. The information displayed is: metric name; start date; end date; goal; actual; and amount %.
iii. Report Unit Project (/report/unit/project): Provides a report about the current unit.
A. Report Unit Project Financial(/report/unit/project/financial):

With reference to FIG. 60, provides a report of the financial information for projects under the current unit. The information includes: project name; total budget; startup funding; funding to date; and expenses to date.
B. Report Unit Project Timeline (/report/unit/project/timeline):

With reference to FIG. 61, provides a report of the timeline tasks for projects under the current unit including the current unit if the current unit is a project. The items displayed include: project name; description; start date; end date; % complete; and bar graph of completion.

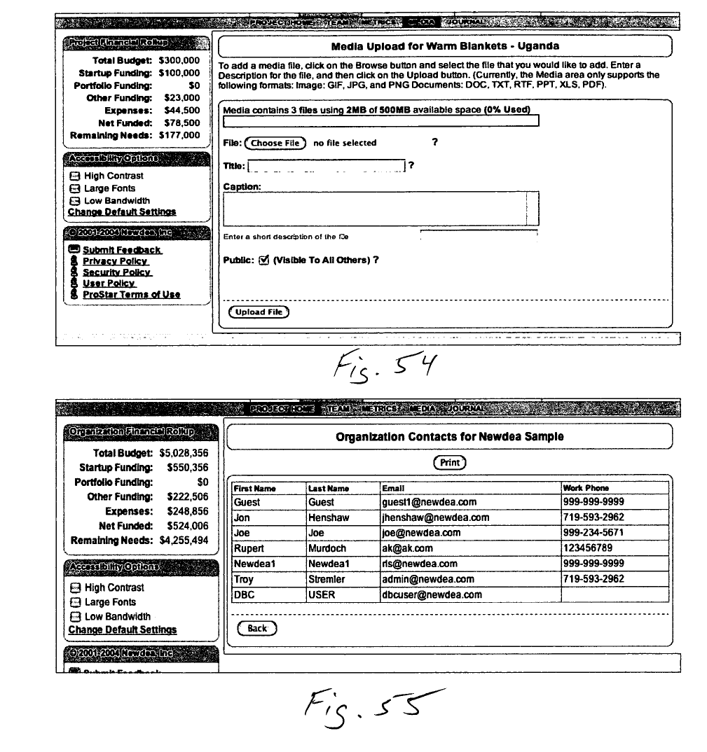

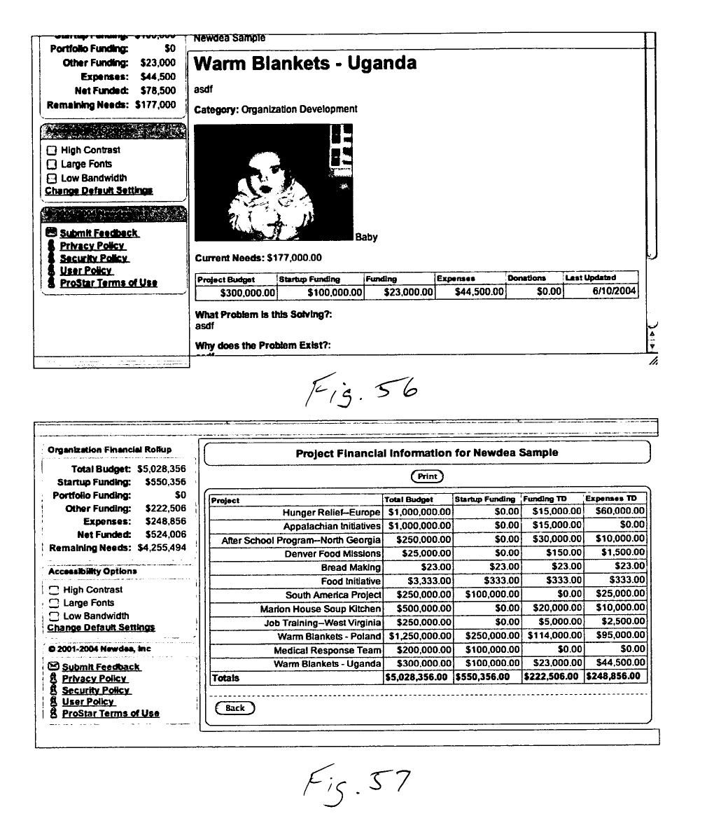

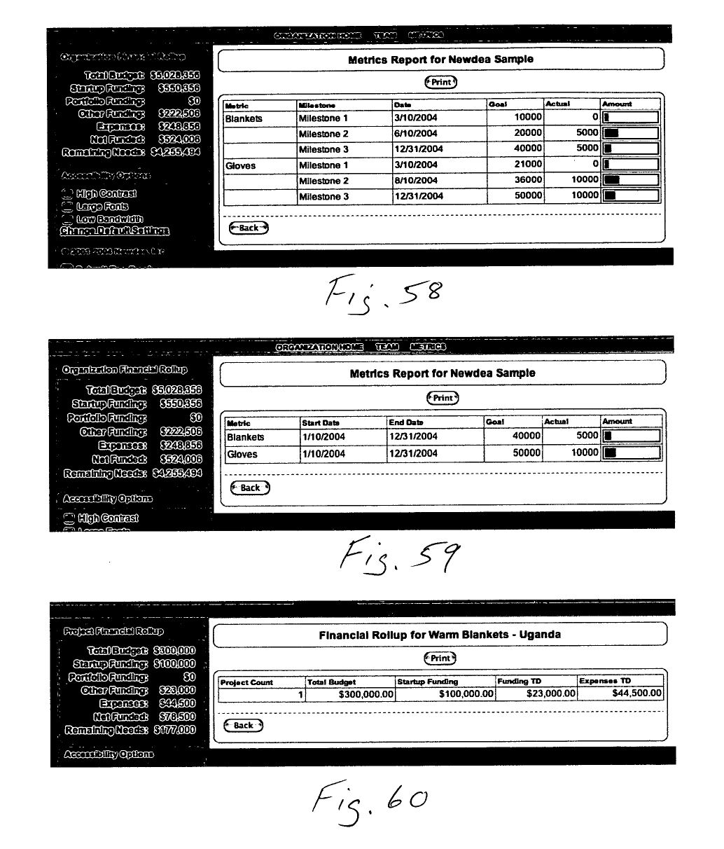

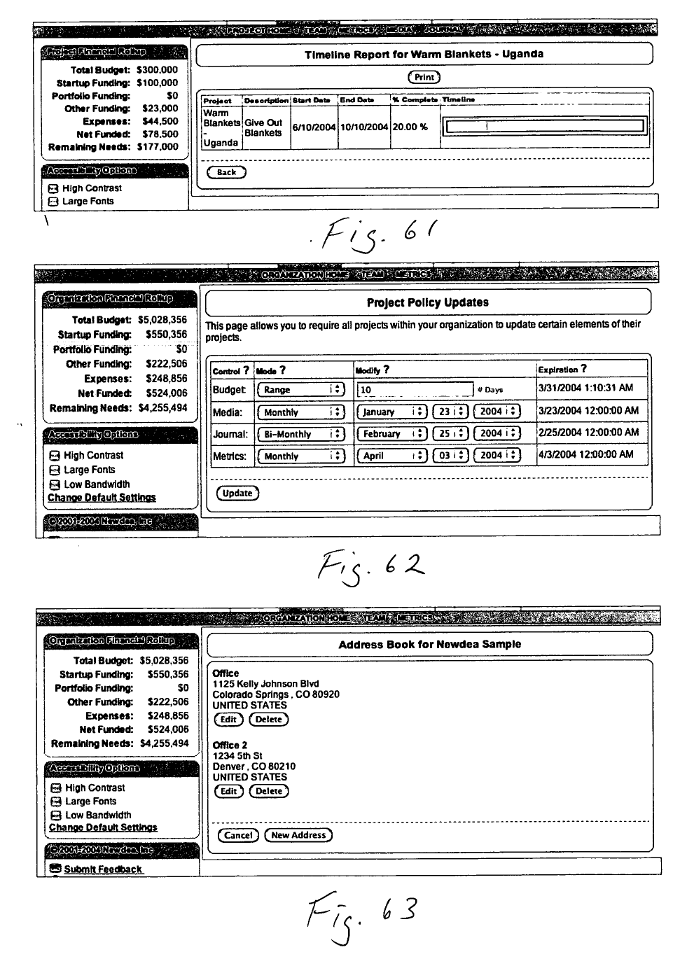

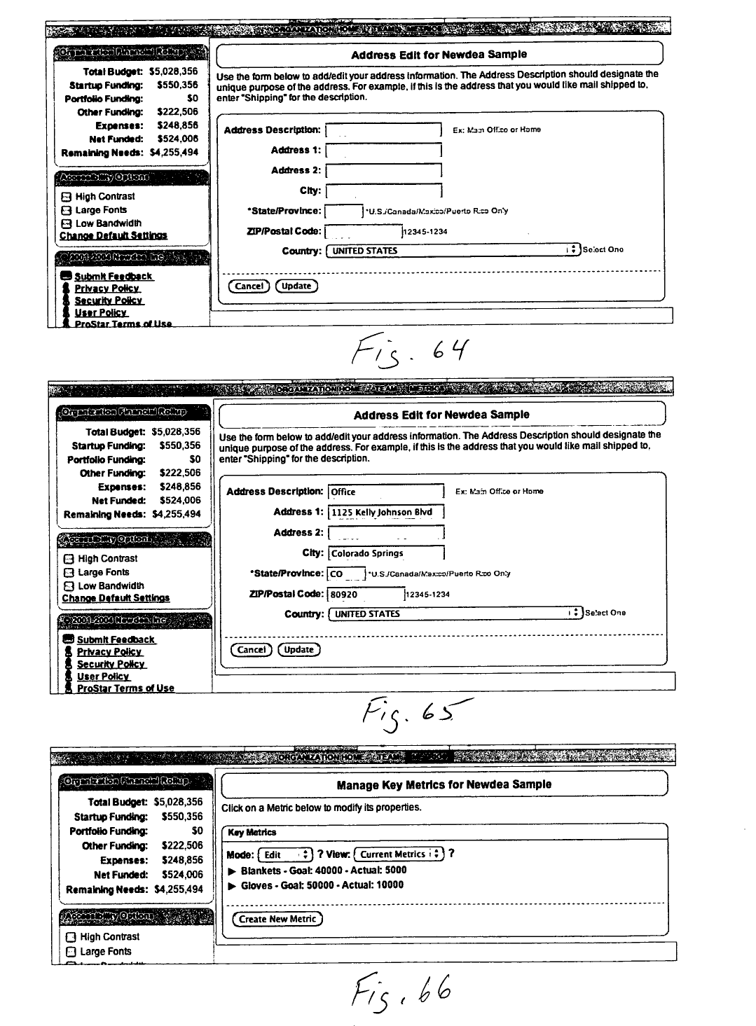

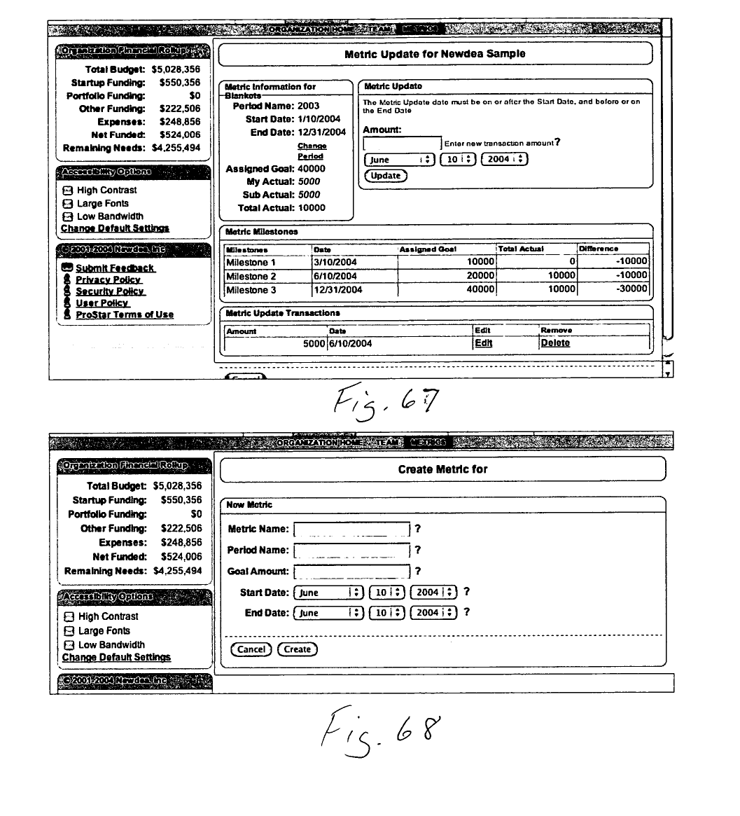

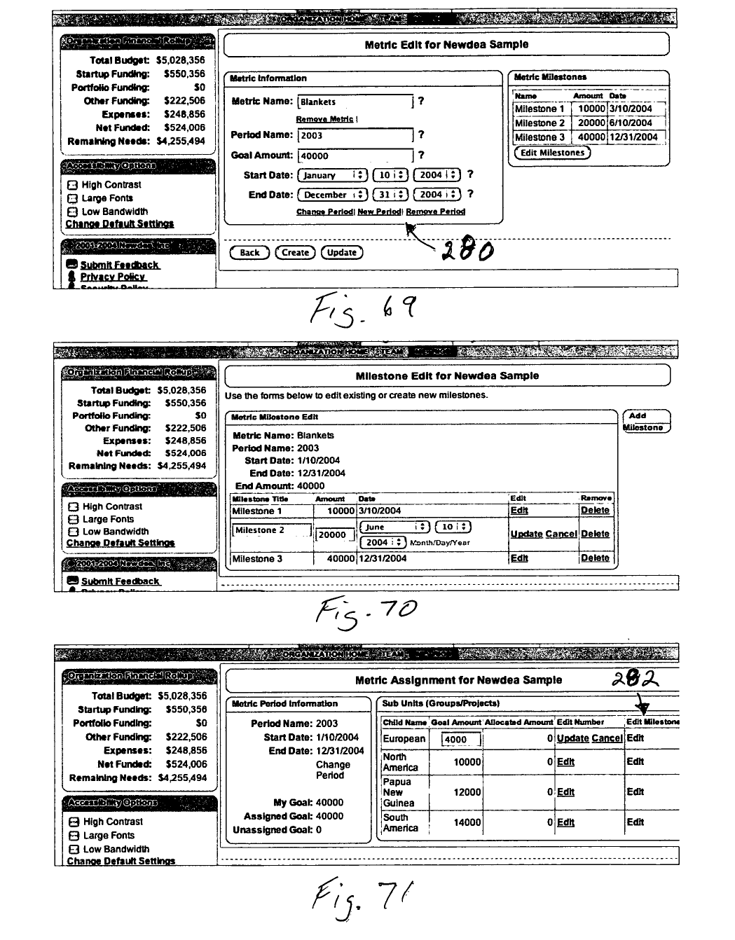

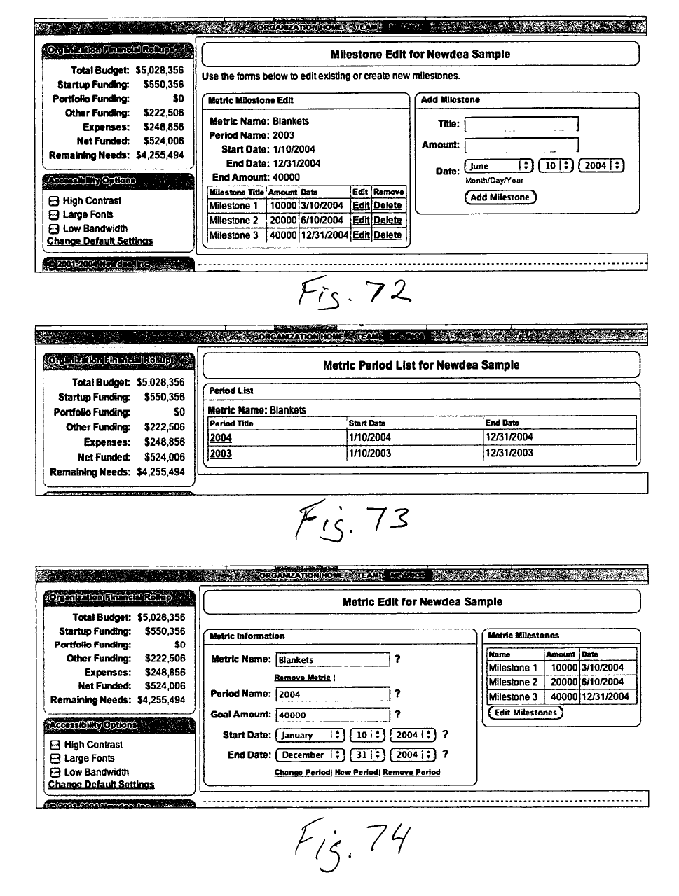

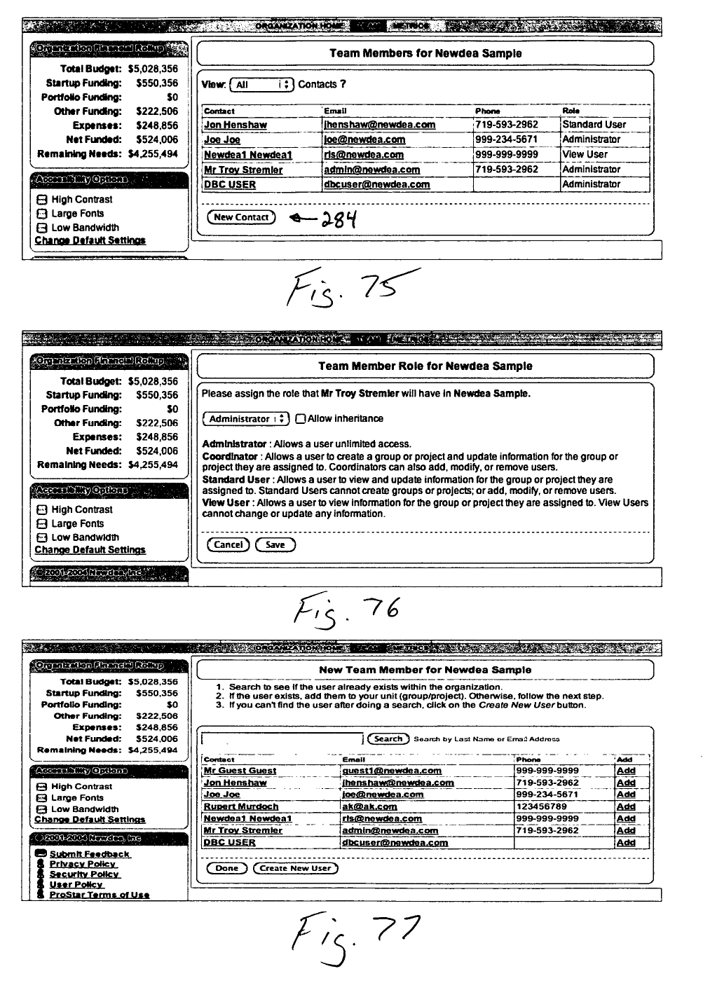

9. Unit (/unit): Provides capacity for features that are specific to units.
a. Unit Update Edit (/unit/update): With reference to FIG. 62, provides a feature that allows a user to edit the update policies for projects for that organization. Policies can be set by a range since last update, or a specific date with a timeframe for updating. The items that the policy can set to be updated are: budget; media; journal; and metrics.
b. Unit Address (/unit/address): Provides a capacity for features relating to addresses for units.
   i. Unit Address List (/unit/address/list): With reference to FIG. 63, provides a page for viewing the addresses associated with the user's unit. From this page, the user can also follow a link to edit individual addresses, create a new address, or delete an address (confirmed).
   ii. Unit Address Create (/unit/address/create): With reference to FIG. 64, provides a page that allows a user to create a new address for an associated unit.
   iii. Unit Address Edit (/unit/address/edit): With reference to FIG. 65, provides a page that allows a user to edit address information for a specific address.
   iv. Unit Address View (/unit/address/view): Provides a page that allows a user to view (but not edit) existing addresses for the organization.
c. Unit Metric (/unit/metric): Provides a capacity for features relating to metrics.
   i. Unit Metric List (/unit/metric/list): With reference to FIG. 66, provides a page for users to view metrics relating to the current unit. For organizations, a managing user may edit, update, assign, or create metrics. For other units, the user may only update or assign metrics. Users may view current metrics or all metrics. The page should display the metric name, goals, and actuals for the metric.
   ii. Unit Metric Actual Edit (/unit/metric/actual): With reference to FIG. 67, provides a feature for users to edit actuals for a currently selected metric for a selected period. From this page, the user can add new actuals, edit existing actuals, and delete actuals from the current period's milestone. Information pertinent to the current metric and current period should be displayed, as well as the information for milestones and actuals.
   iii. Unit Metric Create (/unit/metric/create): With reference to FIG. 68, provides a feature to allow a user to create a new metric. This information should be displayed on all Metrics pages for specific periods. The information that should be collected is as follows: metric name; period name; goal amount; start date; and end date.
   iv. Unit Metric Edit (/unit/metric/edit): With reference to FIG. 69, provides a feature to edit the existing information for a metric or create a new period an existing metric. Milestones for this metric and period should also be displayed. Thos page also provides a link 280 to a page to change periods for this metric.
   v. Unit Metric Goal (/unit/metric/goal): Provides a place to house pages associated with metric goals.
      A. Unit Metric Goal Milestone Edit (/unit/metric/goal/milestone): With reference to FIG. 70, provides a feature to allow a user to add, edit, or remove milestone goals from a specific metric's period. The information collected for milestones includes: milestone name; amount; and end date.
      B. Unit Metric Goal Sub Unit Edit (/unit/metric/goal/subUnit): With reference to FIG. 71, provides a feature to edit goals for sub-units of the current unit. This page allows the user to enter numbers for the user's direct sub-units equal to the goal allotted to them. The page also provides a link 282 to edit the current unit's milestones.
   vi. Unit Metric Milestone Edit (/unit/metric/milestone): With reference to FIG. 72, provides a feature that allows a user to add, edit, or delete a milestone for the current metric's current period. The information collected and displayed for a milestone includes: milestone title; amount; and date.
   vii. Unit Metric Period (/unit/metric/period): Provides a capacity to work with metric periods.
      A. Unit Metric Period List (/unit/metric/period/list): With reference to FIG. 73, provides a page that lists all the periods for the current metric. This page also allows the user to select a specific period for implementation on other metric pages.
      B. Unit Metric Period Edit(/unit/metric/period/edit): With reference to FIG. 74, provides a page that allows a user to edit, create, and delete periods for the current metric. This page collects the following information for periods: period title; amount; start date; and end date.
d. Unit Security (/unit/security): Provides a capacity to house the pages dealing with unit security for specific users.
   i. Unit Security List (/unit/security/list): With reference to FIG. 75, provides a page displaying the list of users associated with the current unit. This page includes the ability to link 284 to the page to add a new contact, and allows the user to click on the user's name to link to a page to view the user's information.
   ii. Unit Security New (/unit/security/new): With reference to FIG. 76, provides a page allowing a user to assign the currently selected user an access role, and provides the option of allowing inheritance of that role.
   iii Unit Security Search (/unit/security/search): With reference to FIG. 77, provides a feature allowing the user to search through the list of users associated with the organization, with the ability to add that user to the unit. Included for each user are: contact name, e-mail, and phone.
   iv. Unit Security Temp (/unit/security/temp): With reference to FIG. 78, provides a feature that allows a user to create a new temporary user (emailed, previewed) for the current unit. The information collected is: first name, last name, work phone, and e-mail address.
   v. Unit Security User (/unit/security/user): With reference to FIG. 79, provides a page that allows a user to view a user role in the current unit. This role can be defined as inherited or not. The page provides links to change the user's role, remove the user, or add the user to the current unit. The user's contact information as well as current role also are displayed.
e. Tree (/unit/tree): Provides a capacity for unit tree structure pages to be housed.
   i. Unit Tree (/unit/tree/tree): With reference to FIG. 80, provides a feature that allows a user to view and select different nodes e.g., 286, of (sub-units in) the unit hierarchy.
   ii. Unit Move (/unit/tree/move): With reference to FIG. 81, provides a feature that allows a user to move a unit from one node in the hierarchy to another. The user should be able to click on and highlight a node, and then commit the operation.
10. Feedback (/feedback): Provides a feature that allows a user to submit comments by e-mail to company staff (emailed, previewed).

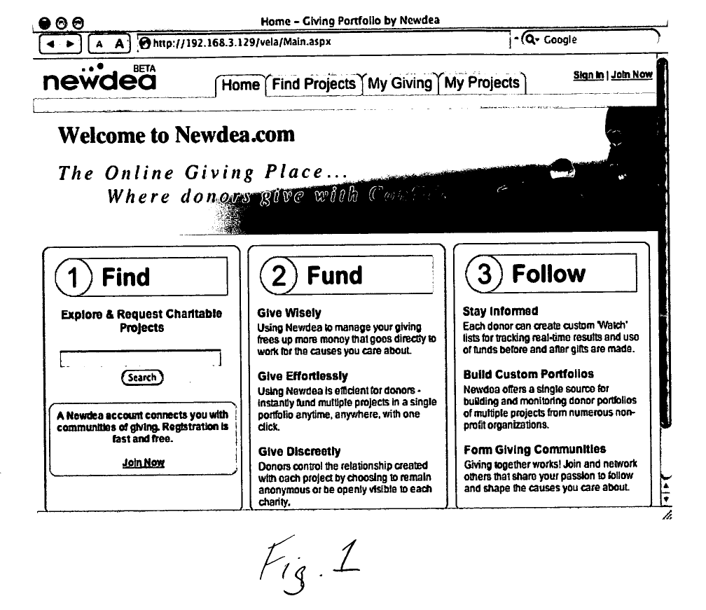

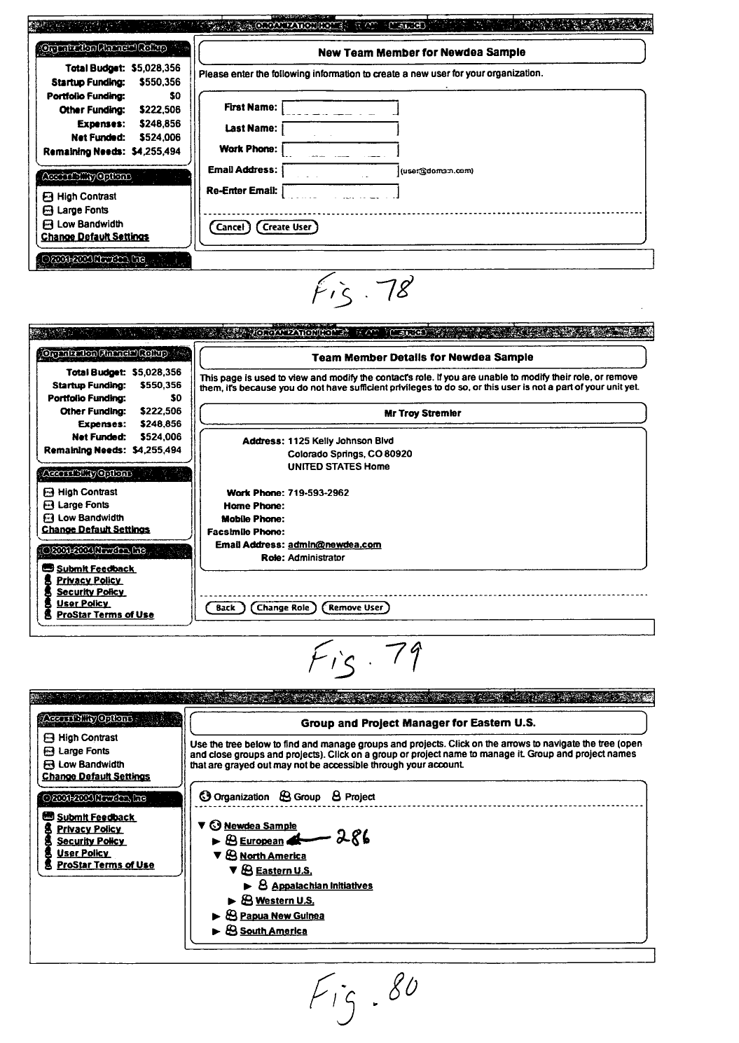

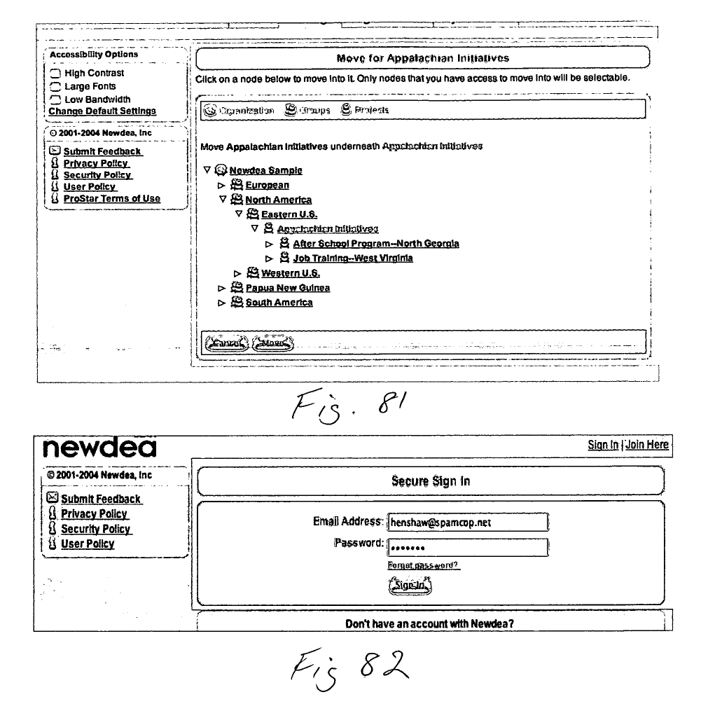

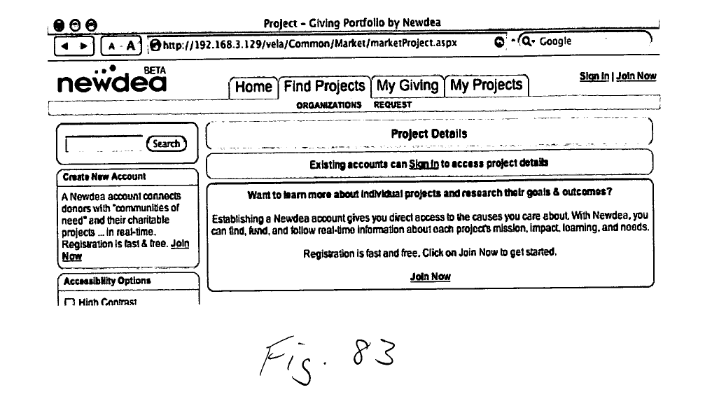

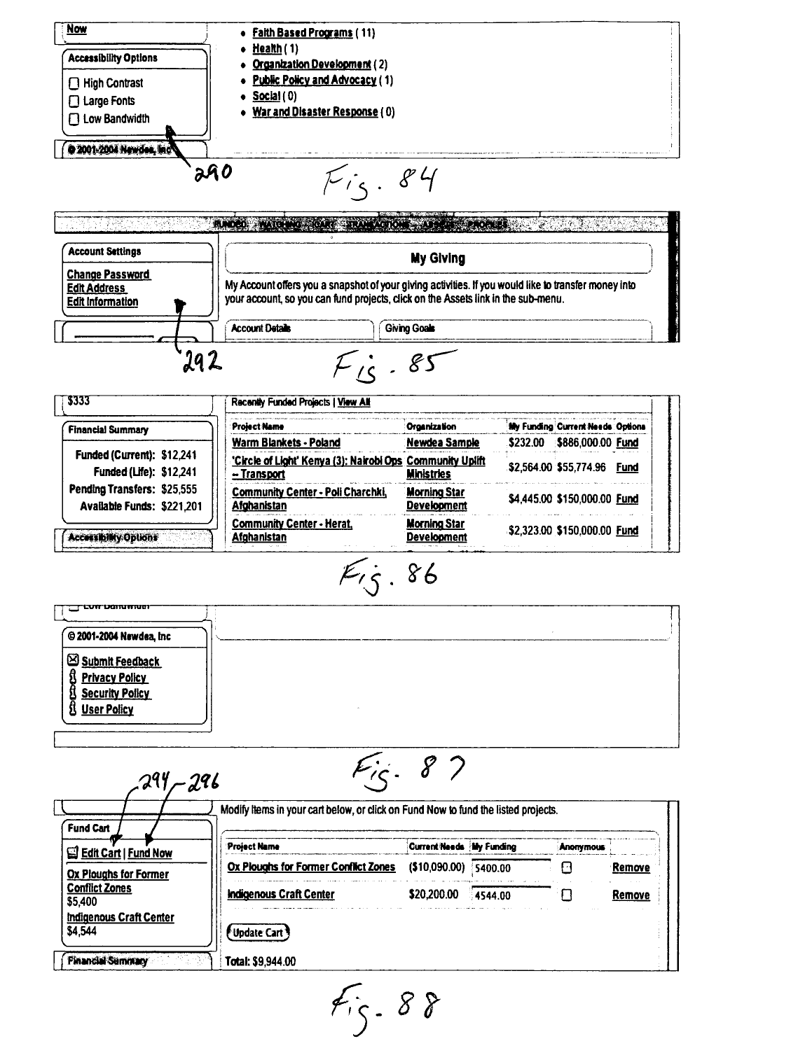

B. DONATION/GIVING PORTFOLIO/VELA: The preferred embodiment also includes a Donor Application to provide complete donor services. This includes the ability to find and research projects or possible interested, transfer assets into the Company trust, use assets to fund projects, and observe and monitor the projects. This application also provides the donor with tools to analyze and manage their giving.
1. Anonymity (/anonymity): Provides a system that allows anonymous users to navigate portions of the system without restriction. Pages can redirect users to specific marketing pages based on whether the page being accessed is permitted to be viewed anonymously.
2. Help (/help) Provides a system that includes a full-featured, context-sensitive help system. The help system provides “helptags” scattered throughout the system where appropriate to help educate users on how the system works. Clicking a helptag brings up a popup window with information specific to the area in which the helptag is located.
3. User Security (/user/security): The system maintains security at all times; it redirects any unauthorized users and those that are not logged. If the user is not logged in, the system can redirect the user to the login page (see, e.g., FIG. 82), ensuring that users do not see information the user is not authorized to view. As mentioned below, some pages are visible to anonymous donors, as a way of allowing users to observe aspects of the system without disclosing sensitive information.
4. Marketing Pages (/marketing): The system maintains a collection of marketing pages, such as shown in FIG. 1, for the purpose of handling anonymous user redirection specific to the intended target page. Depending on the specific system location of a page selected by an anonymous user, the system redirects the user to a marketing page tailored for that section of the system. The marketing pages include the following: marketing account page; marketing main page; marketing organization page; marketing portfolio page; and marketing project page (see FIG. 83).
5. Module (/module): Provides a series of modules to keep the user apprised of information specific to the user's location in the system.
a. Accessibility (/module/accessibility): With reference to FIG. 84, provides a module that allows the user to choose large fonts, high contrast, or low bandwidth options 290. This permits the user to modify viewing of the site to conform to specific limitations for the user's accessing of the site.
b. Edit (/module/edit): With reference to FIG. 85, provides a module that allows the user to edit the user's account settings, including address, other information, and password within the system 292.
c. Financial (/module/financial): With reference to FIG. 86, provides a module that allows the user to view available funds, any pending transfers of money, how much the user has funded for the life of the account, and how much the user has funded currently.
d. Footer (/module/footer): With reference to FIG. 87, provides a module that allows the user to review privacy, security, and user policies, as well as submit feedback to the administrators of the system.
e. Fund List (/module/fund/list): With reference to FIG. 88, provides a module that allows the user to view the last five funded transactions, and provides a link to edit the current fund cart 294 and a link to the fund login page 296.
f. Search (/module/search): With reference to FIG. 89, provides a module that allows the user to search for a particular project based on an exact-match keyword. The module will send the user to the project search page, which will show a list of matching projects to the keyword entered into the search module.
g. Sign Up (/module/signup): With reference to FIG. 90, provides a module that allows a new user to join the system. The module provides a link 298 to the application that handles new user entry.
h. Status (/module/status): With reference to FIG. 91, provides a module reporting a user's status, including whether the user is logged in. If so, the user is greeted by name in this module 300.

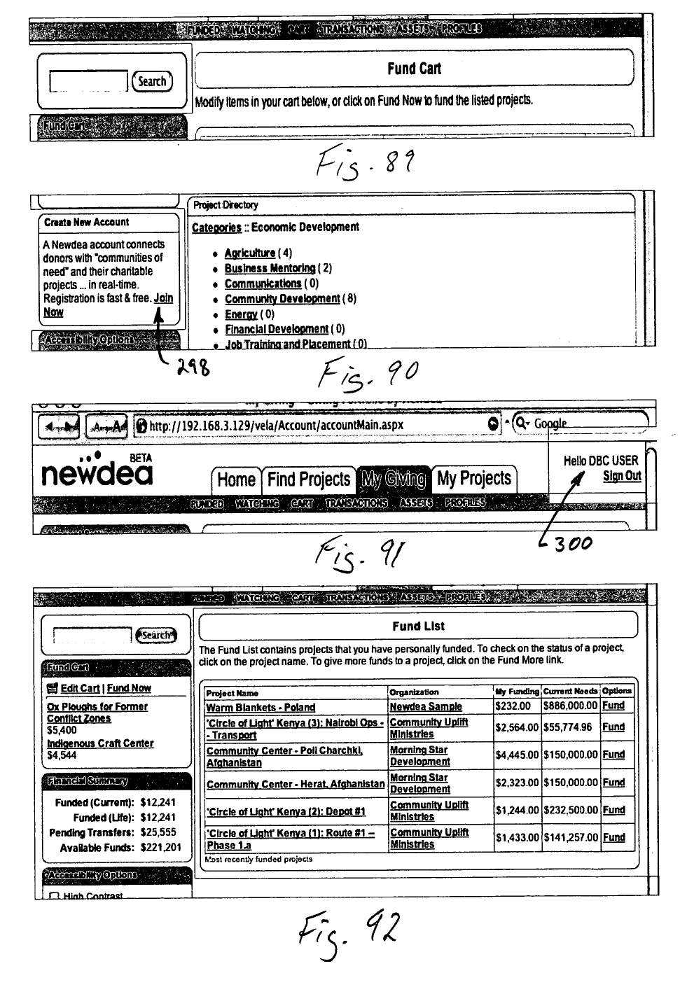

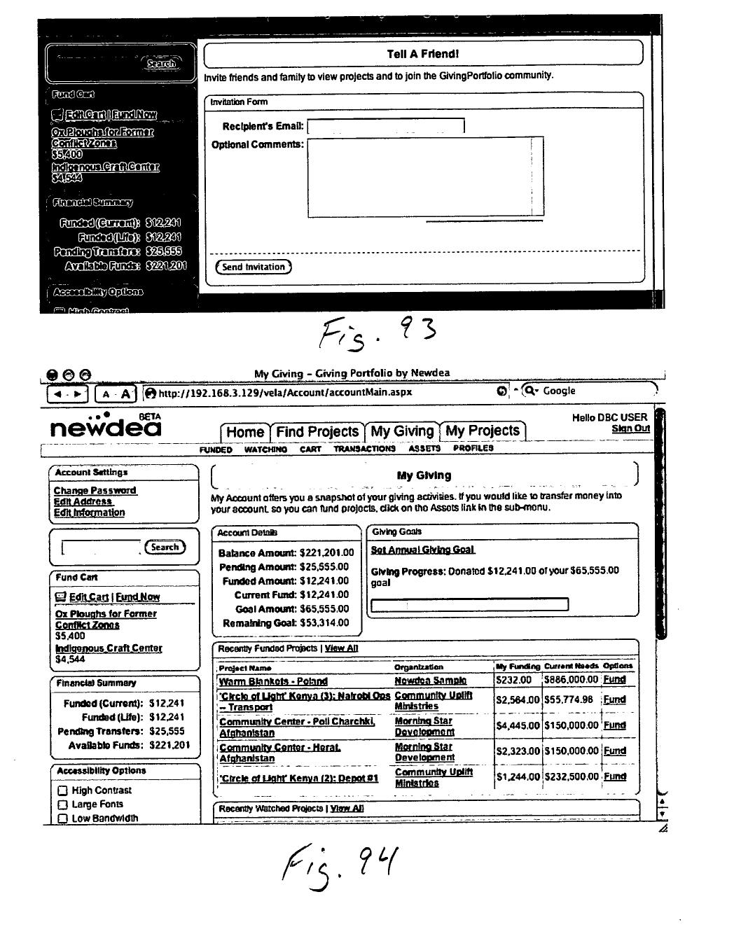

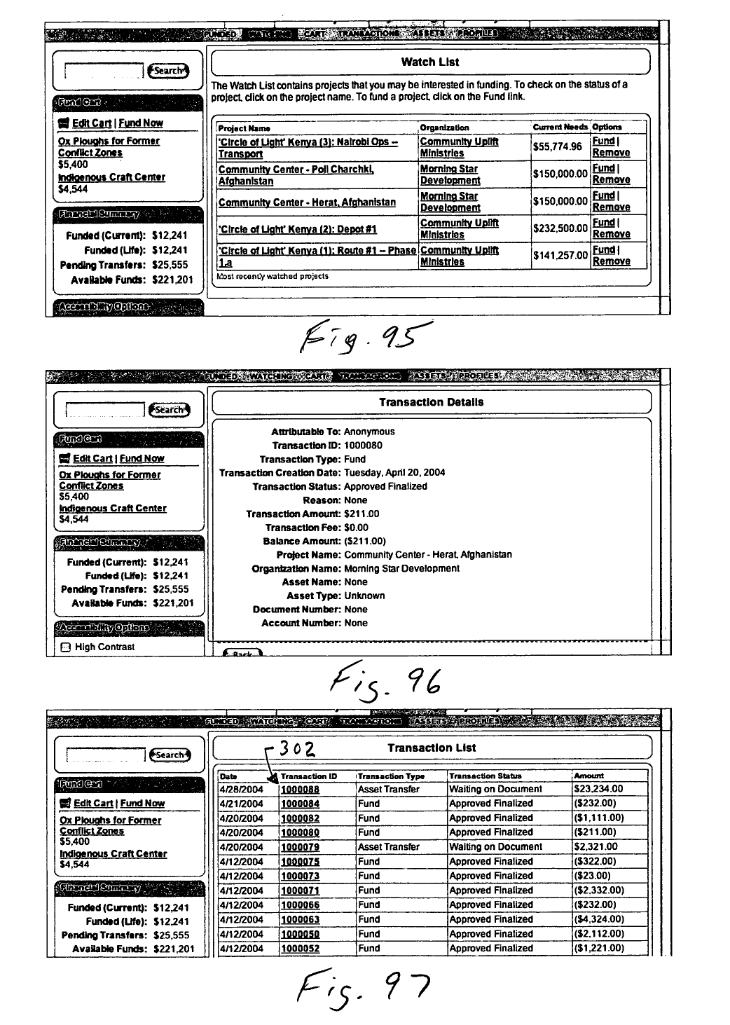

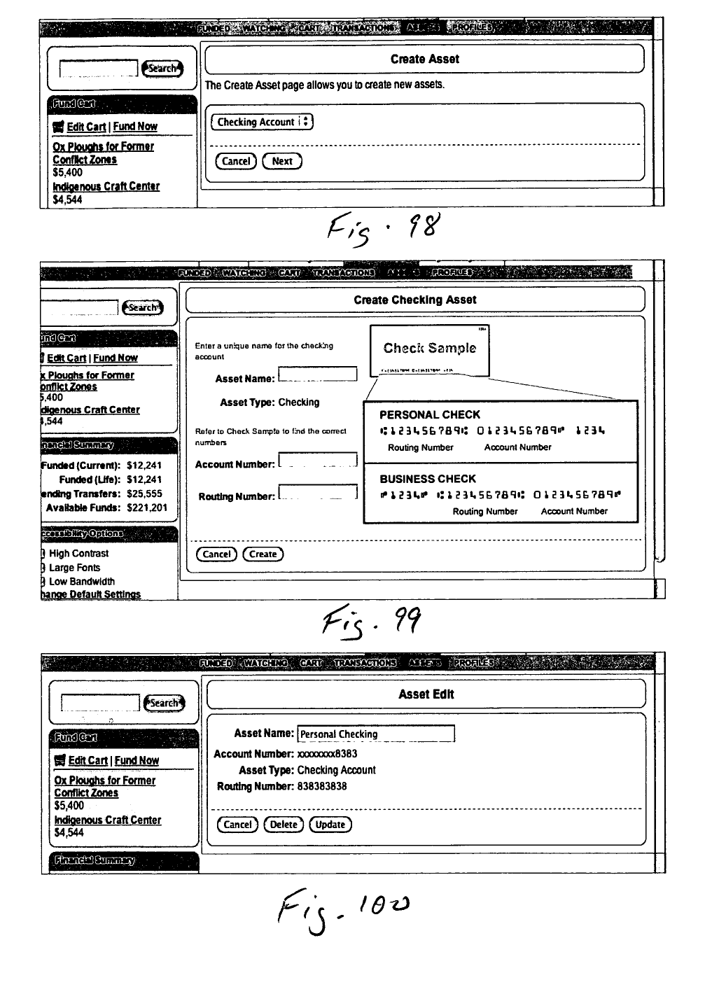

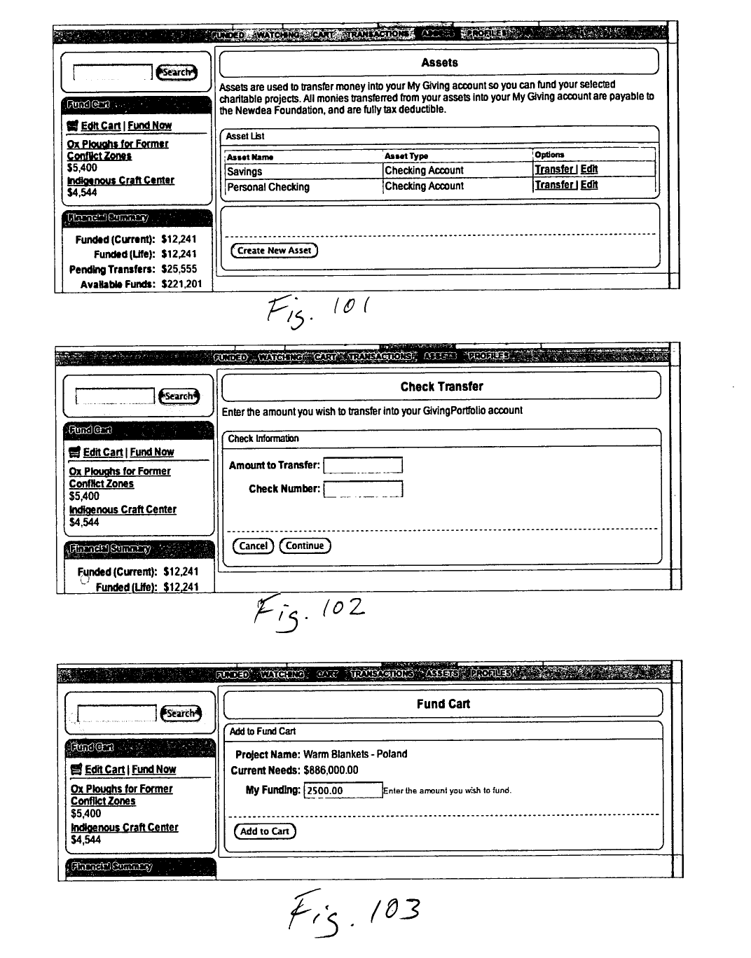

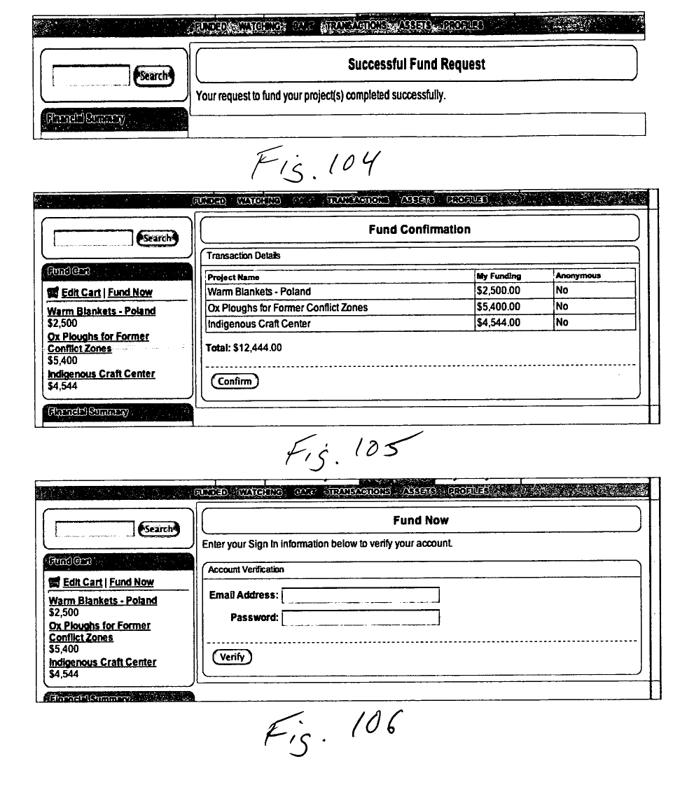

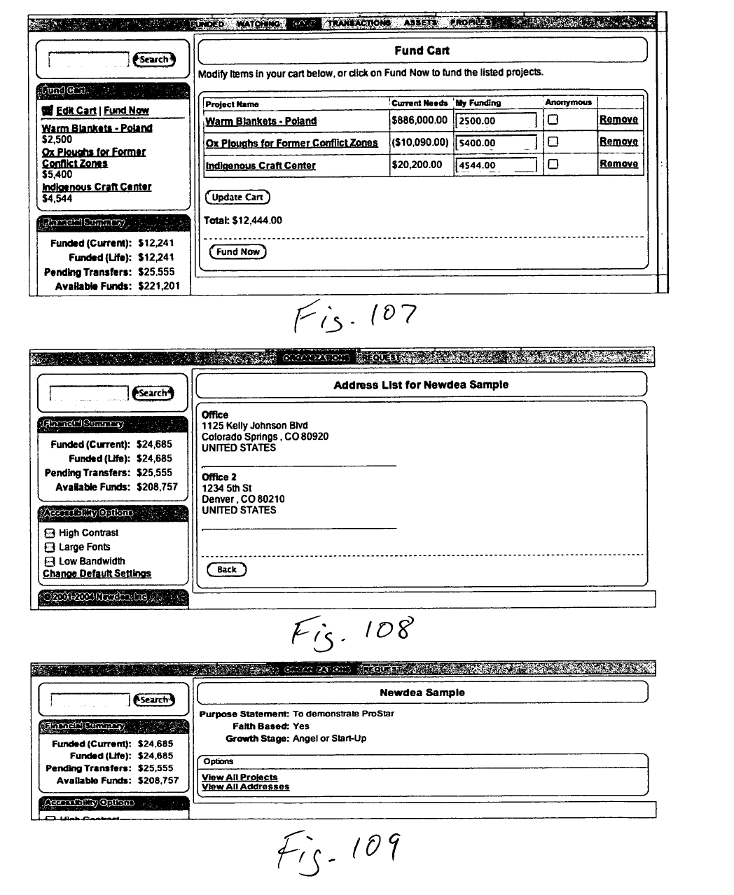

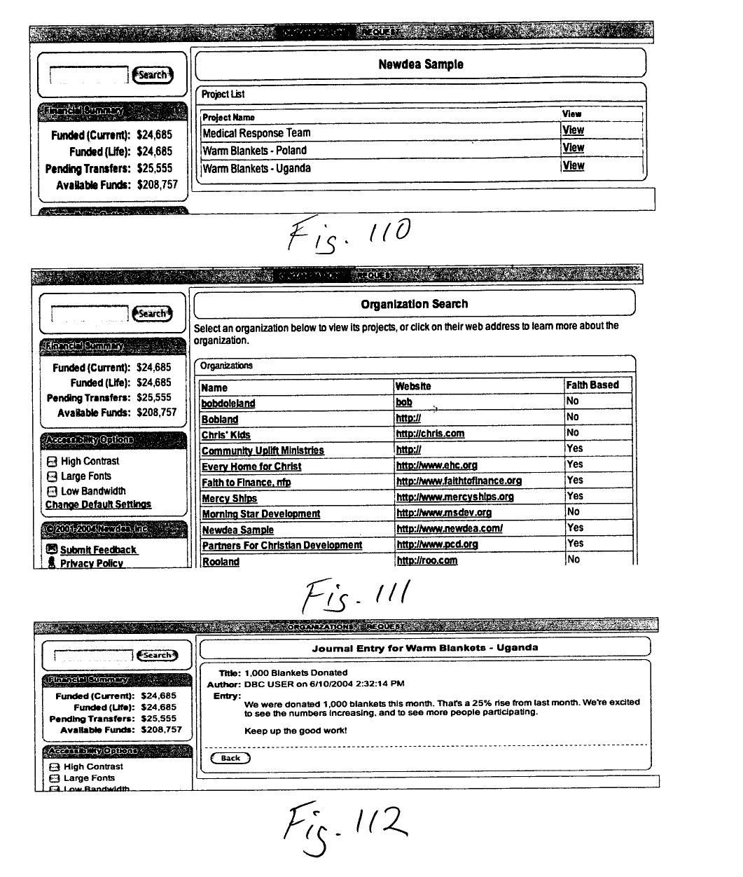

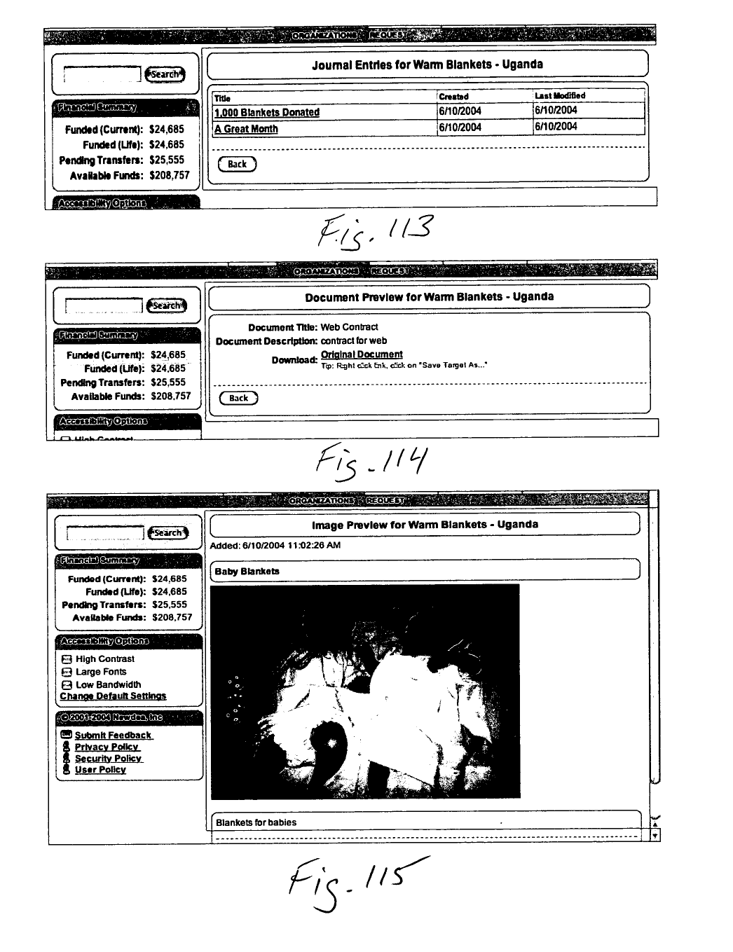

6. Account (/account): Provides a capacity to manage accounts in the system and an interface for transactions within these accounts.
a. Account Edit (/account/edit): Provides an interface to edit accounts.
b. Account Fund List (/account/fund/list): With reference to FIG. 92, provides a page that lists all funded projects organized by project name. This page includes the amount funded, the name of the organization to which the project belongs, and a link to fund more if desired
c. Account Invite (/account/invite): With reference to FIG. 93, provides the ability for a user to invite another person via email (previewed) to fund a particular project.
d. Account Main (/account/main): With reference to FIG. 94, provides a page that shows a snapshot of the user's funding to date, including projects that the user has either already funded or is monitoring. The user may set an annual giving goal and review current account details.
e. Account Watch List (/account/watch/list): With reference to FIG. 95, provides a page that lists all projects on a user's watch list, with the ability to link to a funding page when a user so desires.
f. Transaction (/account/transaction): Provides the ability for users to handle transactions within an account.
   i. Transaction Detail (/account/transaction/detail): With reference to FIG. 96, provides a page in which a user can review the details of a transaction, including its status, transaction fees to others or the system provider, etc.
   ii. Transaction List (/account/transaction/list): With reference to FIG. 97, provides a page where a user can review a list of the user's transactions, regardless of status. The page also provides a link 302 to view further information about the individual transactions.
7. Asset (/asset): Provides an interface for users to manage assets.
a. Asset Create (/asset/create): With reference to FIG. 98, provides the ability for a user to create an asset for funding of projects.
   i. Asset Create Check (/asset/create/check): With reference to FIG. 99, provides a page allowing a user to create a checking account asset and record pertinent information.
   ii. Asset Create Credit (/asset/create/credit): Provides a page that allows a user to create a credit card account asset, recording pertinent information.
b. Asset Edit (/asset/edit): With reference to FIG. 100, provides a page that allows a user to edit asset information.
c. Asset List (/asset/list): With reference to FIG. 101, provides a page that allows a user to list asset information and provides a link to view a specific asset.
   i. Asset Transfer Check (/asset/transfer/check): With reference to FIG. 102, provides a page that allows a user to transfer funds from a checking account asset into the system. The page may also provide check mailing information.
   ii. Asset Transfer Credit (/asset/transfer/credit): Provides a page that allows a user to transfer funds from a credit card account asset into the system.
8. Fund (/fund): Provides an interface to allow users to Fund projects from available funds in the system.
a. Fund Add (/fund/add): With reference to FIG. 103, provides a page that allows a user to assign an amount to fund to a particular transaction.
b. Fund Complete (/fund/complete): With reference to FIG. 104, provides a page that indicates to a user when the funding process has completed.
c. Fund Confirm (/fund/confirm): With reference to FIG. 105, provides a page that allows a user to confirm all funding transfers that are about to take place. The page also provides a link to asset transfer if the funding amount is less than available funds.
d. Fund Login (/fund/login): With reference to FIG. 106, provides a page that can require a user to log into the system again, to confirm identity. This provides a security feature to ensure that the funding transaction that is about to take place is being performed by an authorized (verifiable) user.
e. Fund Main (/fund/main): With reference to FIG. 107, provides a page that allows a user to manage funding transactions, including the ability to remove these transactions on an individual basis. This page also provides the ability to finalize funding by having the user choose which transactions are ready for completion.
9. Organization (/organization): Provides an interface for users to search for and examine organizations in the system. This interface allows users to donate to projects sponsored by organizations.
a. Organization Address List (/organization/address/list): With reference to FIG. 108, provides a page that allows a user to view a list of addresses for a specific organization.
b. Organization Main (/organization/main): With reference to FIG. 109, provides a page that allows a user to view the details of a particular organization, including its purpose, whether it is faith-based, and the organization's growth stage.
c. Organization Project List (/organization/project/list): With reference to FIG. 110, provides a page that allows a user to view a list of projects associated with a particular organization, grouped by project name. The page also provides a link for users to view any particular project in the list.
d. Organization Search (/organization/search): With reference to FIG. 111, provides a page that allows a user to choose from a list of organizations, select the organization's posted website, and determine if an organization is faith-based in nature.
10. Project (/project): Provides an interface that allows the user to view, choose, and donate to a specific project.
a. Journal (/project/journal): Provides an interface for users to view the journal entries associated with projects in the system.
   i. Journal Detail (/project/journal/detail): With reference to FIG. 112, provides a page that shows a specific journal entry for a particular project.
   ii. Journal List (/project/journal/list): With reference to FIG. 113, provides a page that shows a list of journal entries for a particular project. This page also provides a link to a specific journal entry if so chosen.
b. Media (/project/media): Provides an interface for users to view media uploaded for a particular project. This media includes documents and images.
   i. Media Document Preview (/project/media/document/preview): With reference to FIG. 114, provides a page that allows a user to preview an uploaded media document.
   ii. Media Image Preview (/project/media/image/preview): With reference to FIG. 115, provides a page that allows a user to preview an uploaded media image.
   iii. Media List (/project/media/list): With reference to FIG. 116, provides a page that shows the user a list of uploaded media, both documents and images, and provides a link to a page that allows the user to access these media.
      c. Report (/project/report): Provides a report that allows the user to view pertinent information related to a particular project.
   i. Report Project Information (/project/report/project/information):

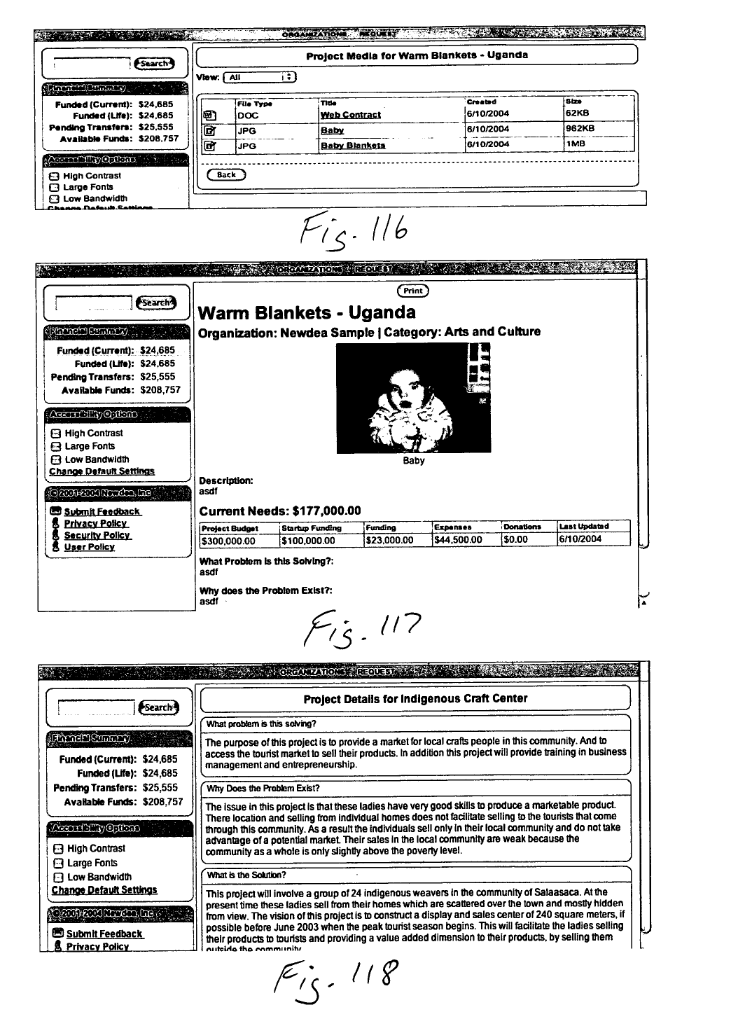

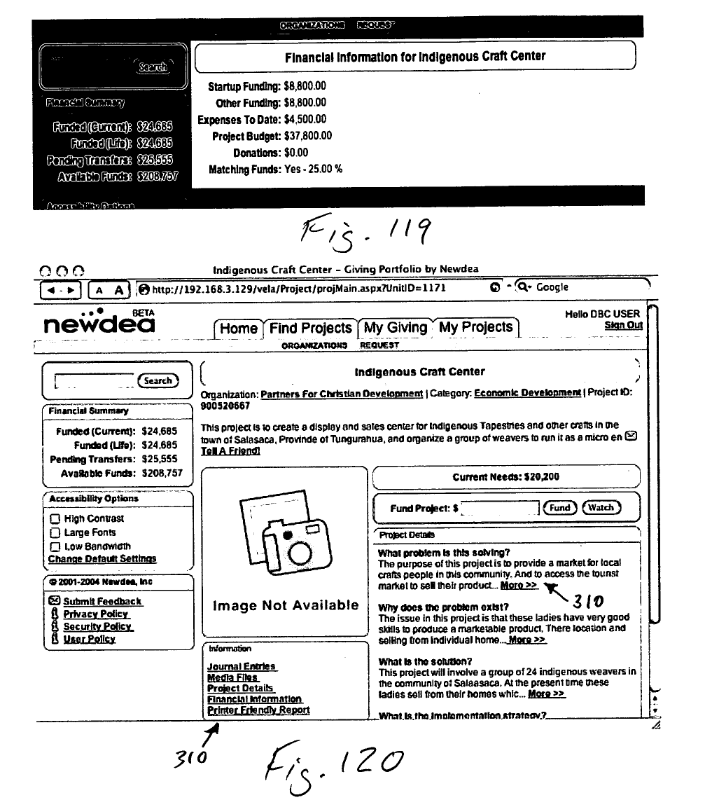

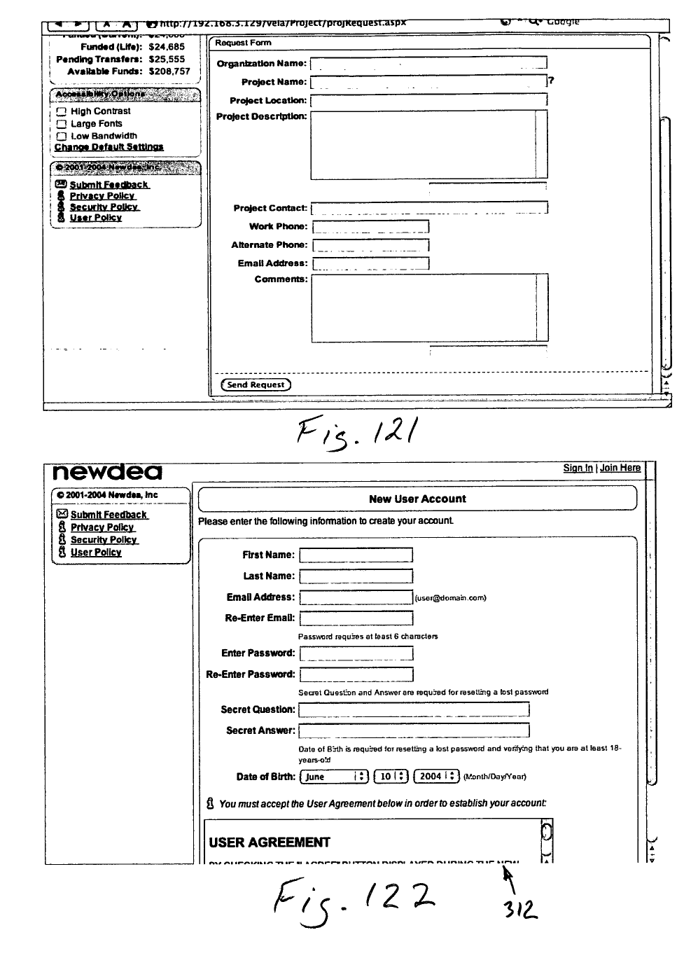

With reference to FIG. 117, provides a report of the following information about a particular project: project name; organization name; category; concise description; current needs; project budget; startup funding; funding; expenses; donations; last updated; purpose; statement; detail; and strategy.
d. Project Description (/project/description): With reference to FIG. 118, provides a page that allows a user to view the description details of a particular project, including the project purpose, statement, detail, and strategy.
e. Project Financial (/project/financial): With reference to FIG. 119, provides a page that allows a user to view the specific financial information for a particular project, including: initial funding amount; other funding amount; expenses to date; project budget; donations; and matching funds.
f. Project Main (/project/main): With reference to FIG. 120, provides a page that shows a summary of the main details of a project and provides links e.g., 310, to other pages unique to the project, including links to journal entries, media uploaded for the project, project details, financial information, and reports. This page also provides abbreviated descriptions of the project purpose, statement, detail and strategy. Anonymous users can view this page, but some functionality requires a valid login. Those links that are not available for anonymous viewers will redirect the user to the appropriate marketing page, as discussed elsewhere.
g. Project Match (/project/match): Provides a page that shows the matching grant information, if any, for a project. This page also shows the percentage of the matching grant and details associated with this matching grant.
h. Project Request (/project/request): With reference to FIG. 121, provides a page that allows a user to request that a project or organization be added to the system. Information is gathered from the user and then emailed (previewed) to administration.
   i. Project Search (/project/search): Provides a page that allows a user to find a project by using an exact match keyword search. This page also provides a list of matching projects that link to the main page for the project selected.

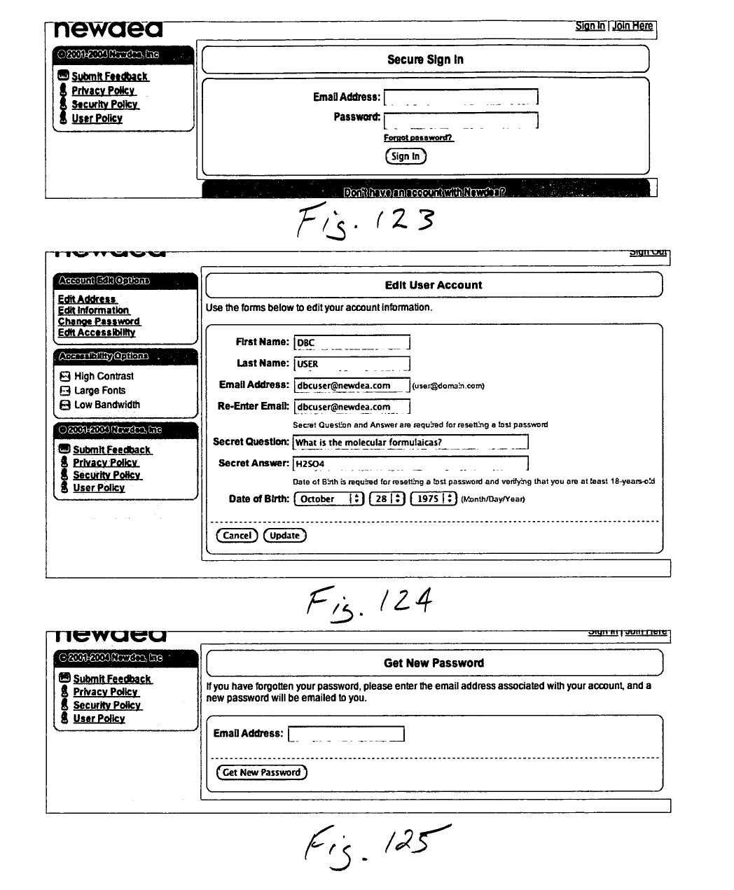

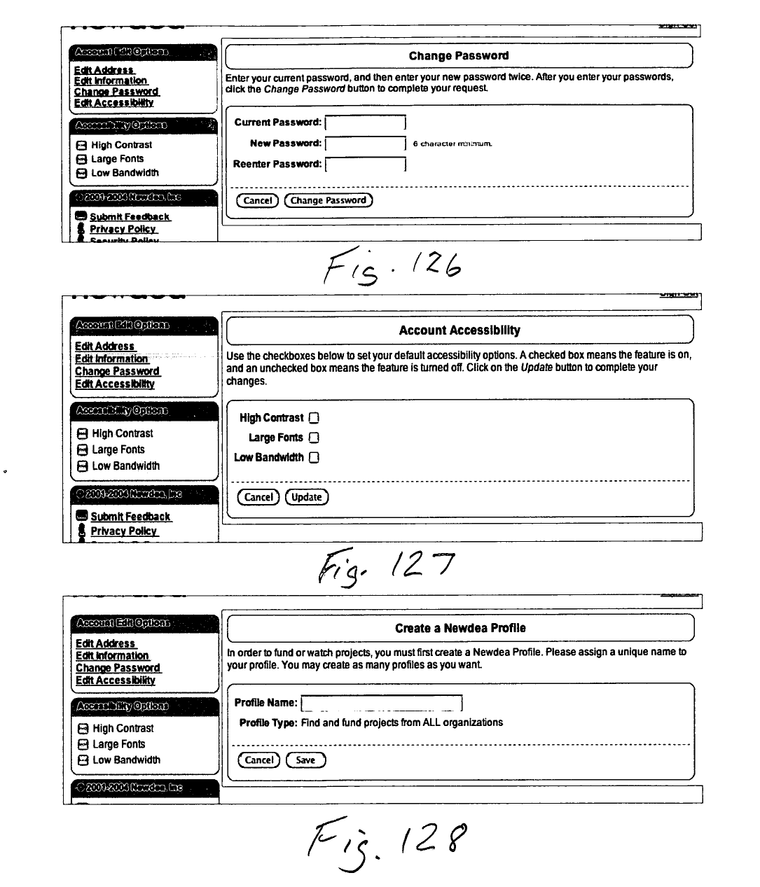

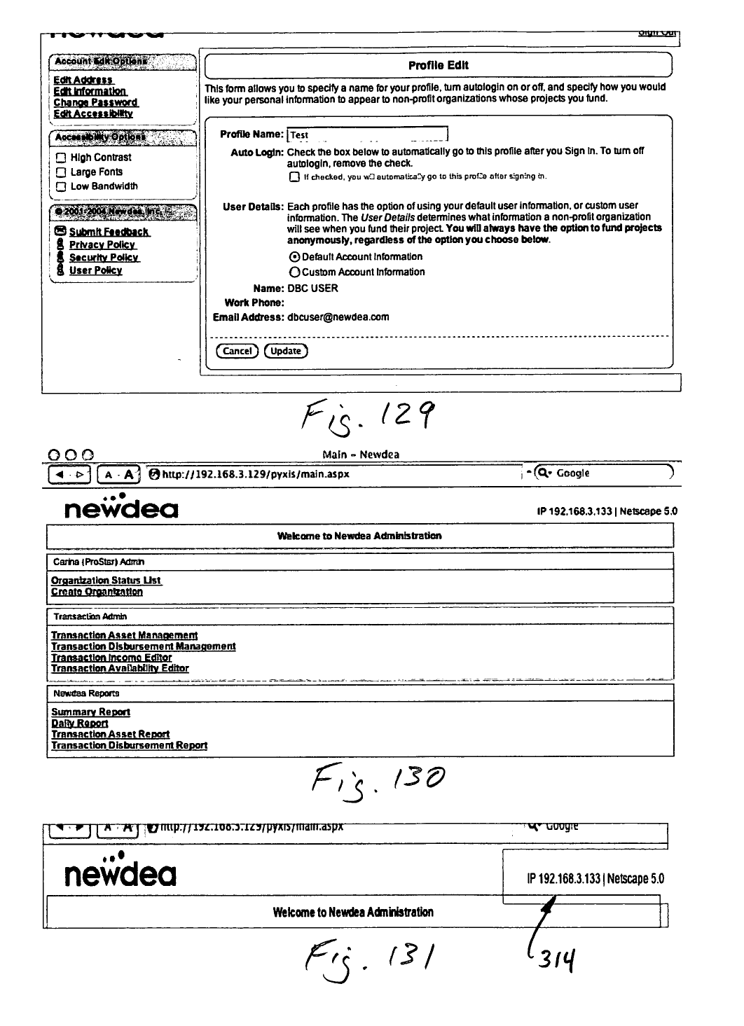

C. PORTAL/PUPPIS: The Portal Application is designed to provide a centralization of common activities for the various applications and to provide a single point of entry into the entire system. It provides user authentication and management services, ingress operations for external linking, and common processing for functions out of the normal flow of application processing, such as help and error handling.
1. User Account (/user): Provides a capacity to add, store, and retrieve user data. Establishes the user account as the main source of authentication and access to the Navis System.
a. User Account New (/user/new): With reference to FIG. 122, provides a page that gathers user account data. This page requires the user to agree to the Terms of Service (ToS) 312. The user becomes active in the Navis System upon successful completion of the form and acceptance of the ToS. User account data gathered by this page includes: first name; last name; e-mail address; password; secret question; secret answer; and date of birth.
b. User Login (/user/login): With reference to FIG. 123, provides secure user login. The required login information is based on the user's e-mail address and unique password. Only valid user accounts, in good standing, may log into the System.
c. User Edit (/user/edit): With reference to FIG. 124, provides the capability to allow a user to edit the user's account data, including the user's address.
d. User Password (/user/password): Provides protection of a user account by the user's password, which the user specifies.
   i. User Password Reset (/user/password/reset): With reference to FIG. 125, provides a feature that allows a user to reset the user's password. When a password is changed, the system then e-mails the newly created password to the e-mail address stored in the User Account.
   ii. User Password Change (/user/password/change): With reference to FIG. 126, provides a page for the user to change the user's password. The user must enter the existing password in order to change it to a new one.
2. Accessibility (/accessibility): With reference to FIG. 127, provides the following accessibility features: high contrast, large fonts, and low bandwidth. The high contrast accessibility option changes the colors of the system. The changed colors are visible to the three major types of color blindness (protan, deutan, and tritan). The large fonts accessibility option will increase the font size throughout the system, enabling users who are farsighted to have a more legible view of the system. The low bandwidth accessibility option reduces the amount of data transfer required to view a system page. This is done by reducing the number of images delivered to the client system.
3. Feedback (/feedback): Provides a page that allows the user to submit feedback to the administrator. The feedback page reports the user, the page the user was visiting when the user accessed the feedback page, and the user's comments.
4. Profile (/profile): Provides a capacity to house features relating to user profiles.
a. Profile New (/profile/new): With reference to FIG. 128, provides a page that allows the creation of a profile. The user can designate a custom name for the profile and choose either a single organization or all organizations to associate with the profile.
b. Profile Edit (/profile/edit): With reference to FIG. 129, provides the capability to edit the following profile settings: profile name; auto login; first name; last name; work phone; and e-mail.
5. Policy (/policy): Policies must be agreed upon by all users. When a policy is updated, the user is prompted, after logging into the system, to agree to the new policy. The user will be denied access to the system until the user agrees to the updated policy.

D. ADMINISTRATION/PYXIS: The Administration Application is designed to provide Company personnel with a single interface to maintain the system and its data. This includes User management, Organization management, Company reporting, Transaction processing, Funding management, etc. Because it is an internal tool, access and behavior are different from the other applications.

1. User Authentication (/user): The user authentication application supports a method of authentication that is both secure and not vulnerable to attacks on the authentication system used by the other applications. Since users of this system are small in number and all known to the system administrator, this system can operate and be administered differently from the system's other applications. This application is both highly secure and tied in transparently with the rest of the Company's authentication procedures.

2. Main Dispatch (/main): With reference to FIG. 130, provides a starting point that can dispatch to the various features. Only options that are available and allowed are shown, so that each organization can have a unique interface. Each feature is quickly accessible with a single link from this page.

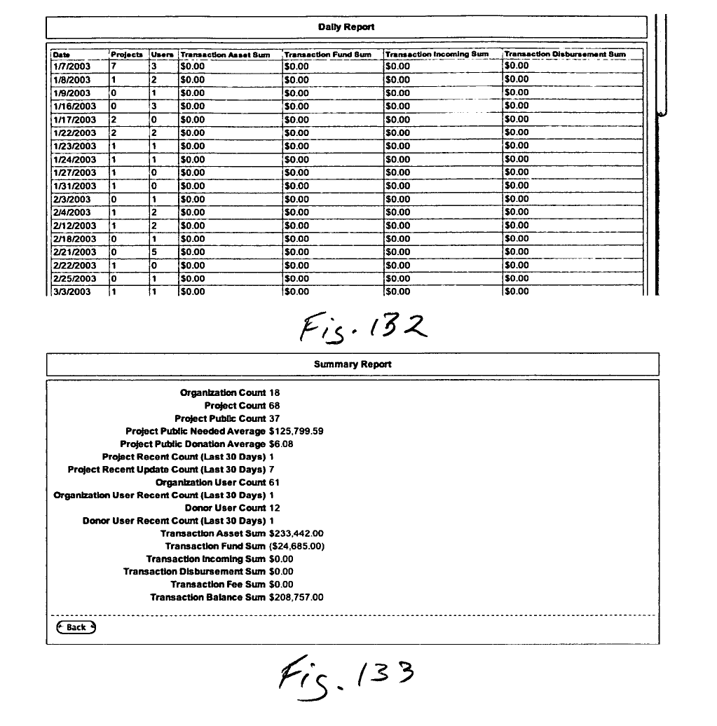

3. Modules (/module): Provides capability for dashboard modules to be shown in the application and creates a per-page container that can hold all needed modules.
a. Status Module (/module/status): With reference to FIG. 131, provides a module that shows information about the user currently accessing the system. Since the security and authentication in this application is different than that in the other applications, this module will behave differently. The page provided by this module shows the user's identity (if known), IP address, and browser type.

4. Company (/company): Provides a capacity to maintain company information.
a. Company Reports (/company/report): Provides a capacity to procure company reports.
   i. Company Daily Report (/company/report/daily): With reference to FIG. 132, provides a report that aggregates, by day, the company information. The report states: date; projects; users; transaction asset sum; transaction fund sum; transaction incoming sum; and transaction disbursement sum.
   ii. Company Summary Report (/company/report/summary): With reference to FIG. 133, provides a report of the select company metrics, such as: organization count; project count; project public count; project public needed average; project public donation average; project recent count; project recent update count; user count; user recent count; transaction asset sum; transaction fund sum; transaction incoming sum; transaction disbursement sum; transaction fee sum; and transaction balance sum.

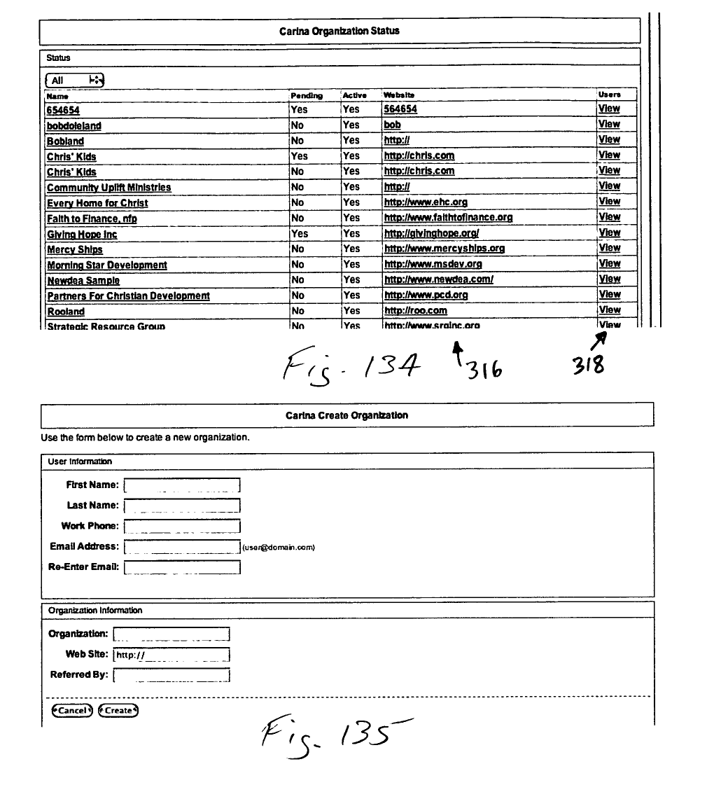

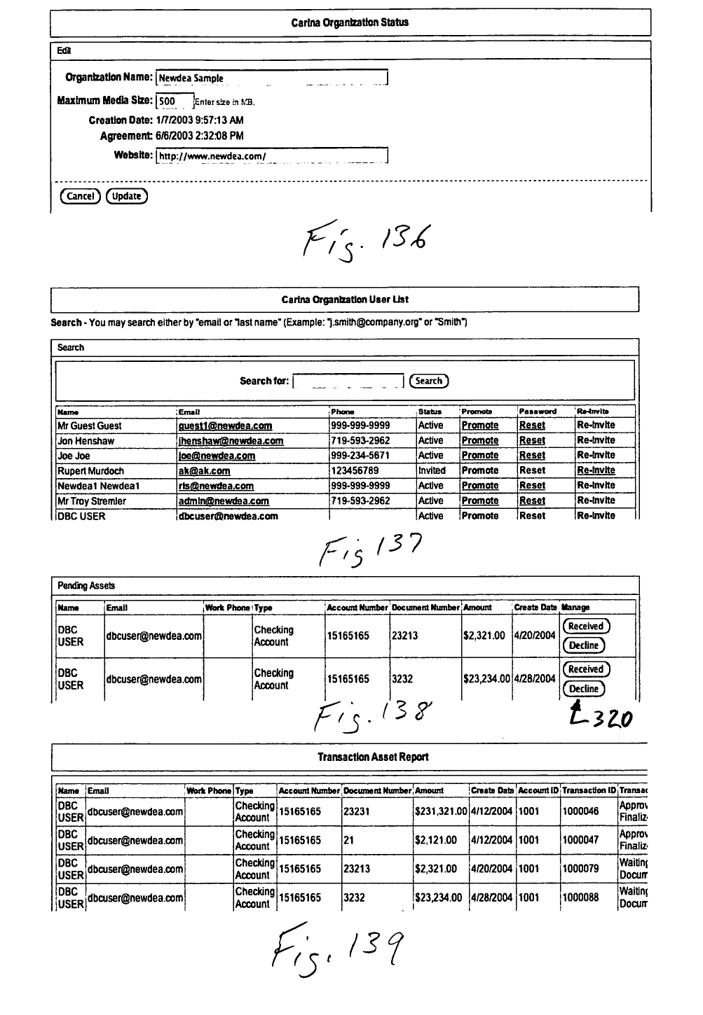

5. Organization (/organization): Provides a capacity to maintain organizations.
a. Organization List (/organization/list): With reference to FIG. 134, provides a page that lists all organizations and information about them. The page provides links to their edit 316 and user list pages0318.
b. Organization Create (/organization/create): With reference to FIG. 135, provides a page that allows company personnel to create a new organization. This page should also create the initial administrator as part of the same operation as a user invitation (emailed, previewed).
c. Organization Edit (/organization/edit): With reference to FIG. 136, provides the capability to edit organization information.
d. Organization User List (/organization/user/list): With reference to FIG. 137, provides a page that lists all users in an organization and their status information. The page provides operations allowing promotion to administrator (confirmed), password reset (confirmed, emailed, previewed), and re-invitation (confirmed).

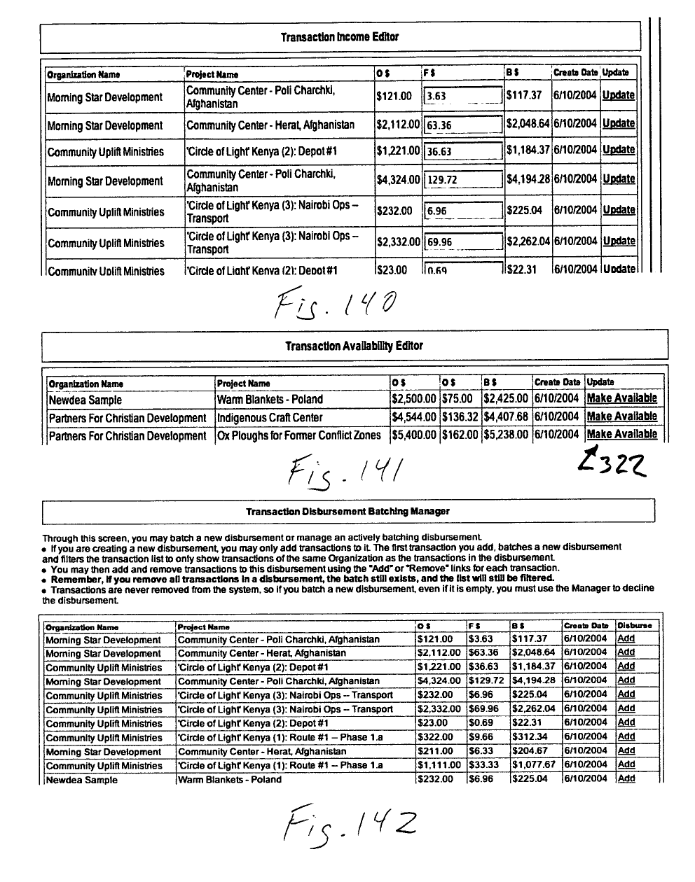

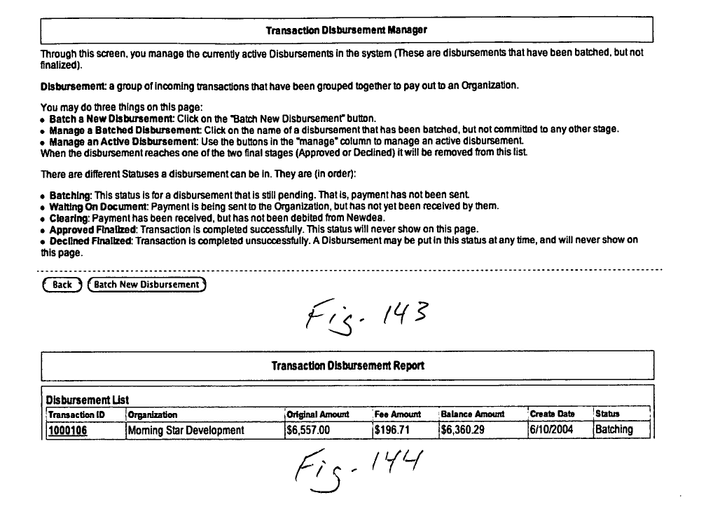

6. Transaction Maintenance (/transaction): Provides a capacity to manage transactions in the system.
a. Asset Transactions (/transaction/asset): Provides a capacity to handle asset transactions.
i. Asset Transaction List (/transaction/asset/list): With reference to FIG. 138, provides an interface to view all pending asset transfer transactions with information useful to processing the transactions. This page also provides a vehicle of moving each transaction through its various states to a finalization state (confirmed) 320. In the case of declination, the page provides an input for the reason for the decline (required).
ii. Asset Transaction Report (/transaction/asset/report): With reference to FIG. 139, provides a report that provides the following information about the asset transactions in the system: name; type; account number; document number; amount; create date; account ID; transaction ID; and transaction status.
b. Income Transactions (/transaction/income): Provides for conversion of suggested donations to actual donations and includes a capacity to edit these Transactions.
   i. Income Transaction Edit (/transaction/income/edit): With reference to FIG. 140, provides an interface to list and edit eligible system administrator or other income transactions. The fee (F$) may be edited, and the funding balance (B$) is automatically revised to reflect the change.
   ii. Income Transaction Availability Edit (/transaction/income/availability/edit): With reference to FIG. 141, provides an interface to promote an income transaction to immediate availability 322.
c. Disbursement Transactions (/transaction/disburse):
   i. Disbursement Transactions List (/transaction/disburs/list): With reference to FIG. 142, provides an interface to view all pending disbursement transactions and provides information useful to processing the transactions. This page also provides a vehicle (not shown) of moving each transaction through its various states to a finalization state (confirmed). For a declination, this page provides the reason for the declination (required). The page also provides a link (not shown) to create a new disbursement.
A. Disbursement Transactions Create (/transaction/disburse/create): With reference to FIG. 143, provides an interface for creating a disbursement batch. Doing so via this page involves listing eligible income transactions, providing a vehicle of: incorporating them into the disbursement, removing transactions from the disbursement, and committing the disbursement for finalization processing.
B. Disbursement Transaction Report (/transaction/disburse/report): With reference to FIG. 144, provides a report that provides following information for disbursement transactions in the system: organization name; original amount; fee amount; balance amount; create date; and transaction ID.

VII. System Usage Fees

The entity providing access to these systems may charge organizations licensing and use fees. This fee is based on various factors including: the size of the organization, the number of projects it plans to host in the application, the revenues of the organization, the system capacity the organization consumes, the degree to which the organization is involved with the company's ongoing product development, the features within the software that the organization uses, etc.

Transaction fees can also use for revenue generation. For, the system internally distinguishes four types of transactions, each with a possible fee: asset transactions (when donor users add money to the system from their external accounts), fund transactions (when donor users make a request to transfer funds from their system account to a project or organization), income transactions (when an organization or project receives funds into their system account from a donor user), and disbursement transactions (when organizations withdraw funds from the system to their external accounts). Each transaction can incur a system-processing fee in addition to fees charged based on the type of transaction:

1. Asset transactions can incur fees for the acquisition of the funds (credit card processing fees, for example).

2. Fund transactions may incur charges for the approval of the transfer (part of donor-advised versus donor-designated functionality).

3. Income transactions can incur fees for the donor-organization transfer.

4. Disbursement transactions can incur fees for the transfer of funds (wire transfer, etc).

The systems disclosed in detail above impose user charges for asset transactions and income transactions; but they may be readily adapted to charging other fees, such as for fund and disbursement transactions.

With regard to fees for asset transactions and income transactions, the system automatically computes the fee as the transaction is created. When the system generates the transaction, it provides the parameters about the type, amount, etc., for the transaction. This information is passed to a function in the OLTP database that computes a fee amount, which is stored in the FeeAmount field of the AccountTransaction table. This field is used in computing all transaction totals in the system.

It can thus be seen that the foregoing system may be used to provide donors or potential with expanded access to philanthropic projects and organizations, and vice versa. The system, which is novel nearly throughout particularly as applied to philanthropic activity, accordingly provides a virtually completely new method of providing such a service. The system also facilitates a variety of new business methods in which businesses may, if desired, earn revenue for performing services in conjunction with or through the system or aspects of it. The system also provides new techniques for marketing and promoting philanthropic activities and for implementing, planning, structuring, managing, and financing such activities, including the entities that operate projects or provide access or funding to them.

It is to be understood that the foregoing is a detailed description of preferred embodiments. Other embodiments will be apparent and yet fall within the scope of the invention. The scope of the invention is not to be limited thereby and is rather to be determined by the scope of the claims and equivalents.

1. A method of providing philanthropy services to a plurality of donors and a plurality of charitable organizations, the method of providing philanthropy services comprising:
allowing a plurality of donors to access a donor management system;
presenting the plurality of donors with information regarding a plurality of charitable organizations using the donor management system;
allowing the plurality of charitable organizations to provide information to the plurality of donors using the donor management system; and
enabling the plurality of donors to make a donation to at least one of the plurality of charitable organizations using the donor management system.

2. The method of claim 1, the step of presenting the plurality of donors with information regarding a plurality of charitable organizations comprising presenting the plurality of donors with an interactive brochure for at least one of the plurality of charitable organizations.

3. The method of claim 2, further comprising charging the at least one of the charitable organizations a fee for presenting the plurality of donors with the interactive brochure.

4. The method of claim 2, further comprising charging the at least one of the plurality of charitable organizations a fee for creating the interactive brochure.

5. The method of claim 2, wherein the interactive brochure comprises a webpage.

6. The method of claim 1, the step of presenting the plurality of donors with information regarding a plurality of charitable organizations comprising presenting the plurality of donors with at least one charitable endeavor of at least one of the plurality of charitable organizations.

7. The method of claim 6, the step of enabling the plurality of donors to make a donation to at least one of the plurality of charitable organizations using the donor management system comprising at least one of the plurality of donors making a donation to the at least one charitable endeavor.

8. The method of claim 1, further comprising charging a fee if at least one of the plurality of donors makes a donation to at least one of the plurality of charitable organizations.

9. The method of claim 8, wherein the fee comprises a portion of the donation.

10. The method of claim 1, the step of enabling the plurality of donors to make a donation to at least one of the plurality of charitable organizations using the donor management system comprising:
enabling at least one of the plurality of donors to make a payment to an intermediary;
the intermediary paying at least a portion of the payment to the at least one of the plurality of charitable organizations.

11. The method of claim 10, wherein the at least one of the plurality of charitable organizations does not learn the identity of the at least one of the plurality of donors.

12. The method of claim 1, further comprising making the donor management system available to the plurality of donors over a computer network.

13. The method of claim 12, further comprising presenting an entry portal to the plurality of donors over the computer network.

14. The method of claim 13, the entry portal comprising a website.

15. The method of claim 13, further comprising featuring at least one of the plurality of charitable organizations on the entry portal.

16. The method of claim 15, further comprising charging the featured charitable organization a fee for being featured on the entry portal.

17. The method of claim 1, further comprising:
storing funds from at least one of the plurality of donors in a donor account;
making the donor account available to the at least one of the plurality of donors using the donor management system.

18. The method of claim 17, further comprising charging the at least one of the plurality of donors a fee for storing funds in the donor account.

19. The method of claim 17, further comprising investing funds in the donor account.

20. The method of claim 1, further comprising:
for at least one of the plurality of donors, creating a donor profile;
searching for charitable organizations fitting the donor profile.

21. The method of claim 1, further comprising:
creating a donor profile for each of the plurality of donors;
searching for donors using at least one element of the donor profiles;
presenting matching donors to at least one of the plurality of charitable organizations.

22. The method of claim 1, further comprising creating a donor profile for at least one of the plurality of donors.

23. The method of claim 1, the step of presenting the plurality of donors with information regarding a plurality of charitable organizations using the donor management system comprising presenting financial data to the plurality of donors.

24. The method of claim 1, the step of presenting the plurality of donors with information regarding a plurality of charitable organizations using the donor management system comprising presenting at least one progress report to the plurality of donors.

25. The method of claim 1, further comprising charging each charitable organization a fee for providing information to the plurality of donors using the donor management system.

26. The method of claim 1, further comprising charging each of the plurality of donors a fee for accessing the donor management system.

27. The method of claim 1, further comprising a first donor of the plurality of donors inviting a second donor of the plurality of donors to access the donor management system.

28. The method of claim 1, further comprising a first donor of the plurality of donors inviting a second donor of the plurality of donors to make a donation to at least one of one of the plurality of charitable organizations.

29. The method of claim 1, further comprising at least one of the plurality of donors inviting a charitable organization to provide information to the plurality of donors using the donor management system.

30. The method of claim 1, further comprising creating a search space for each of the plurality of charitable organizations, the search space comprising a set of criteria.

31. The method of claim 30, further comprising allowing the plurality of donors to search the plurality of charitable organizations for charitable organizations containing a particular search space criterion.
